(19) United States
(12) Patent Application Publication
(10) Pub. No.: US 2024/0352260 A1
(43) Pub. Date: Oct. 24, 2024

(54) CORROSION INHIBITION COMPOSITIONS AND ASSOCIATED METHODS FOR INHIBITING CORROSION ON METALLIC SUBSTRATES

(71) Applicant: The Boeing Company, Arlington, VA (US)

(72) Inventors: Waynie M. Schuette, Troy, IL (US); Andrew M. Zweig, Akron, OH (US)

(73) Assignee: The Boeing Company, Arlington, VA (US)

(21) Appl. No.: 18/758,637

(22) Filed: Jun. 28, 2024

Related U.S. Application Data
(63) Continuation-in-part of application No. 17/366,242, filed on Jul. 2, 2021, now Pat. No. 12,031,058.

(51) Int. Cl. C09D 5/08; C08K 5/405; C09D 157/00; C09D 187/00

(52) U.S. Cl. CPC C09D 5/08; C09D 157/00; C09D 187/00; C08K 5/405

(57) ABSTRACT

A corrosion inhibition composition includes a carrier and a Schiff base in admixture with the carrier. The carrier includes at least one of water, a hydrocarbon solvent, and a binder.

### PRIORITY

This application is a continuation-in-part of Ser. No. 17/366,242 filed on Jul. 2, 2021, the entire contents of which are incorporated herein by reference.

### GOVERNMENT CONTRACT

This invention was made with Government support under contract number W912HQ-21-C-0067 awarded by SERDP, the Strategic Environmental Research and Development Program, Department of Defense. The government has certain rights in this invention.

### FIELD

The present disclosure generally relates to corrosion inhibition and, more particularly, to organic corrosion inhibition compositions for use on metallic substrates, such as aluminum and its alloys.

### BACKGROUND

Hexavalent chromium is an effective corrosion inhibitor for metals and alloys. However, hexavalent chromium is subject to many safety and compliance restrictions. Consequently, there is a need for alternative corrosion inhibitors that are environmentally friendly, safe, and effective.

Accordingly, those skilled in the art continue with research and development efforts in the field of organic corrosion inhibitors for metals and alloys.

### SUMMARY

Disclosed is a corrosion inhibition composition.

In one example, the corrosion inhibition composition includes a carrier and a Schiff base in admixture with the carrier, the carrier includes at least one of water, a hydrocarbon solvent, and a binder.

Also disclosed is a method for inhibiting corrosion on a metallic substrate.

In one example, the method includes applying to the metallic substrate a corrosion inhibition composition including a Schiff base.

Also disclosed is a coated metallic substrate.

In one example, the coated metallic substrate includes a metallic substrate and a coating comprising a Schiff base.

Other examples of the disclosed will become apparent from the following detailed description, the accompanying drawings, and the appended claims.

### BRIEF DESCRIPTION OF THE DRAWINGS

FIG. 1 is a flowchart of a method for inhibiting corrosion on a metallic substrate;

FIG. 2 is a block diagram of aircraft production and service methodology; and

FIG. 3 is a schematic illustration of an aircraft.

FIG. 4 is a FTIR spectrum of thiosemicarbazone of isophthalaldehyde.

FIG. 5 is a 1H NMR spectrum of thiosemicarbazone of isophthalaldehyde.

FIG. 6 is a 13 C NMR spectrum of thiosemicarbazone of isophthalaldehyde.

FIG. 7 is a FTIR spectrum of thiosemicarbazone of salicylaldehyde.

FIG. 8 is a 1H NMR spectrum of thiosemicarbazone of salicylaldehyde.

FIG. 9 is a 13C NMR spectrum of thiosemicarbazone of salicylaldehyde.

FIG. 10 is a FTIR spectrum of thiosemicarbazone of 2-pyridine carboxyaldehyde.

FIG. 11 is a 1H NMR spectrum of thiosemicarbazone of 2-pyridine carboxyaldehyde.

FIG. 12 is a 13C NMR spectrum of thiosemicarbazone of 2-pyridine carboxyaldehyde.

FIG. 13 is a FTIR spectrum of thiosemicarbazone of 8-hydroxyquinoline-2-carboxyaldehyde.

FIG. 14 is a 1H NMR spectrum of thiosemicarbazone of 8-hydroxyquinoline-2-carboxyaldehyde.

FIG. 15 is a 13C NMR spectrum of thiosemicarbazone of 8-hydroxyquinoline-2-carboxyaldehyde.

FIG. 16 is a FTIR spectrum of 4-phenyl-3-thiosemicarbazone of isophthalaldehyde.

FIG. 17 is a 1H NMR spectrum of 4-phenyl-3-thiosemicarbazone of isophthalaldehyde.

FIG. 18 is a 13C NMR spectrum of 4-phenyl-3-thiosemicarbazone of isophthalaldehyde.

FIG. 19 is a FTIR spectrum of 4-phenyl-3-thiosemicarbazone of pentan-2,4-dione.

FIG. 20 is a 1H NMR spectrum of 4-phenyl-3-thiosemicarbazone of pentan-2,4-dione.

FIG. 21 is a 13C NMR spectrum of 4-phenyl-3-thiosemicarbazone of pentan-2,4-dione.

FIG. 22 is a FTIR spectrum of thiosemicarbazone of mesityl oxide.

FIG. 23 is a 1H NMR spectrum of thiosemicarbazone of mesityl oxide.

FIG. 24 is a 13C NMR spectrum of thiosemicarbazone of mesityl oxide.

FIG. 25 is a FTIR spectrum of thiosemicarbazone of terephthalaldehyde.

FIG. 26 is a 1H NMR spectrum of thiosemicarbazone of terephthalaldehyde.

FIG. 27 is a 13C NMR spectrum of thiosemicarbazone of terephthalaldehyde.

FIG. 28 is a FTIR spectrum of 4-ethyl-3-thiosemicarbazone of isophthalaldehyde.

FIG. 29 is a 1H NMR spectrum of 4-ethyl-3-thiosemicarbazone of isophthalaldehyde.

FIG. 30 is a 13C NMR spectrum of 4-ethyl-3-thiosemicarbazone of isophthalaldehyde.

FIG. 31 is a FTIR spectrum of thiosemicarbazone of pentan-2,4-dione.

FIG. 32 is a 1H NMR spectrum of thiosemicarbazone of pentan-2,4-dione.

FIG. 33 is a 13C NMR spectrum of thiosemicarbazone of pentan-2,4-dione.

FIG. 34 is a FTIR spectrum of 4-methyl-thiosemicarbazone of salicylaldehyde.

FIG. 35 is a 1H NMR spectrum of 4-methyl-thiosemicarbazone of salicylaldehyde.

FIG. 36 is a 13C NMR spectrum of 4-methyl-thiosemicarbazone of salicylaldehyde.

FIG. 37 is a FTIR spectrum of 8-hydroxyquinoline-2-carboxyaldehyde of phenyl thiosemicarbazone.

FIG. 38 is a 1H NMR spectrum of 8-hydroxyquinoline-2-carboxyaldehyde of phenyl thiosemicarbazone.

FIG. 39 is a 13C NMR spectrum of 8-hydroxyquinoline-2-carboxyaldehyde of phenyl thiosemicarbazone.

FIG. 40 is a FTIR spectrum of thiocarbohydrazone of salicylaldehyde (1:1 mol ratio).

FIG. 41 is a 1H NMR spectrum of thiocarbohydrazone of salicylaldehyde (1:1 mol ratio).

FIG. 42 is a 13C NMR spectrum of thiocarbohydrazone of salicylaldehyde (1:1 mol ratio).

FIG. 43 is a FTIR spectrum of thiocarbohydrazone of salicylaldehyde (1:2 mol ratio).

FIG. 44 is a 1H NMR spectrum of thiocarbohydrazone of salicylaldehyde (1:2 mol ratio).

FIG. 45 is a 13C NMR spectrum of thiocarbohydrazone of salicylaldehyde (1:2 mol ratio).

FIG. 46 is a FTIR spectrum of bis-thiosemicarbazone of 2,6-diacetylpyridine.

FIG. 47 is a 1H NMR spectrum of bis-thiosemicarbazone of 2,6-diacetylpyridine.

FIG. 48 is a 13C NMR spectrum of bis-thiosemicarbazone of 2,6-diacetylpyridine.

FIG. 49 is a FTIR spectrum of 2-pyridinecarboxyaldehyde & thiocarbohydrazide.

FIG. 50 is a 1H NMR spectrum of 2-pyridinecarboxyaldehyde & thiocarbohydrazide.

FIG. 51 is a 13C NMR spectrum of 2-pyridinecarboxyaldehyde & thiocarbohydrazide.

FIG. 52 is a FTIR Spectrum of 4-phenyl 3-thiosemicarbazone of Terephthalaldehyde.

FIG. 53 is a 1H NMR Spectrum of 4-phenyl 3-thiosemicarbazone of Terephthalaldehyde.

FIG. 54 is a 13C NMR Spectrum of 4-phenyl 3-thiosemicarbazone of Terephthalaldehyde.

FIG. 55 is a FTIR Spectrum of 4-methylthiosemicarbazone of Terephthalaldehyde.

FIG. 56 is a 1H NMR Spectrum of 4-methylthiosemicarbazone of Terephthalaldehyde.

FIG. 57 is a 13C NMR Spectrum of 4-methylthiosemicarbazone of Terephthalaldehyde.

FIG. 58 is a FTIR Spectrum of 4-phenyl 3-thiosemicarbazone of 2,6-diacetylpyridine.

FIG. 59 is a 1H NMR Spectrum of 4-phenyl 3-thiosemicarbazone of 2,6-diacetylpyridine.

FIG. 60 is a 13C NMR Spectrum of 4-phenyl 3-thiosemicarbazone of 2,6-diacetylpyridine.

FIG. 61 is a FTIR Spectrum of 4-methylthiosemicarbazone of 2,6-diacetylpyridine.

FIG. 62 is a 1H NMR Spectrum of 4-methylthiosemicarbazone of 2,6-diacetylpyridine.

FIG. 63 is a 13C NMR Spectrum of 4-methylthiosemicarbazone of 2,6-diacetylpyridine.

FIG. 64 shows Open Circuit Potential (OCP) Measurements for Al 2024 in 0.9 M NaCl Solution with CI1.

FIG. 65 shows OCP Measurements for Al 2024 in 0.9 M NaCl Solution with CI2.

FIG. 66 shows OCP Measurements for Al 2024 in 0.9 M NaCl Solution with CI3.

FIG. 67 shows OCP Measurements for Al 2024 in 0.9 M NaCl Solution with CI4.

FIG. 68 shows OCP Measurements for Al 2024 in 0.9 M NaCl Solution with CI5.

FIG. 69 shows OCP Measurements for Al 2024 in 0.9 M NaCl Solution with CI6.

FIG. 70 shows OCP Measurements for Al 2024 in 0.9 M NaCl Solution with CI7.

FIG. 71 shows OCP Measurements for Al 2024 in 0.9 M NaCl Solution with CI8.

FIG. 72 shows final OCP Values for Inhibitors CI1-CI8 in Al 2024.

FIG. 73 shows OCP Measurements for LHE ZnNi-Coated Steel in 0.9 M NaCl Solution with CI1, CI2, CI4, CI6, CI9, CI10, and CI11.

FIG. 74 shows the final OCP values for LHE ZnNi-coated steel in a 0.9 M NaCl solution with various inhibitors, indicating the electrochemical potential at different inhibitor levels.

FIG. 75 is an Evans diagram illustrating the impact of cathodic corrosion inhibitors on the corrosion potential and current density of a metal.

FIG. 76 shows corrosion rates of Al 2024 with various inhibitor types and concentrations.

FIG. 77 shows inhibitor efficiencies of different corrosion inhibitors at various concentrations, highlighting their performance in reducing corrosion rates for aluminum alloy 2024.

FIG. 78 displays the corrosion rates of LHE ZnNi-coated steel in a 0.9 M NaCl solution with different corrosion inhibitors, showing the impact of each inhibitor type.

FIG. 79 shows the efficiencies of different corrosion inhibitors for LHE ZnNi-coated steel, indicating their effectiveness in reducing corrosion rates.

FIG. 80 presents the Rp response results for the thiosemicarbazide base with different aldehyde levels, showing the effect on polarization resistance.

FIG. 81 displays the initial EIS Rp response results for the thiosemicarbazide base with various aldehyde levels.

FIG. 82 shows the final EIS Rp response results for the thiosemicarbazide base with different aldehyde levels.

FIG. 83 presents the corrosion rate results for the thiosemicarbazide base with varying aldehyde levels.

FIG. 84 displays the corrosion rate in mils per year (MPY) for the thiosemicarbazide base with different aldehyde levels.

FIG. 85 provides the Rp response results for thiosemicarbazide and phenyl thiosemicarbazide with various aldehydes.

FIG. 86 shows the initial EIS Rp response results for thiosemicarbazide and phenyl thiosemicarbazide with different aldehydes.

FIG. 87 presents the final EIS Rp response results for thiosemicarbazide and phenyl thiosemicarbazide with various aldehydes.

FIG. 88 displays the corrosion rate results for thiosemicarbazide and phenyl thiosemicarbazide with different aldehydes.

FIG. 89 shows the corrosion rate in mils per year (MPY) for thiosemicarbazide and phenyl thiosemicarbazide with various aldehydes.

FIG. 90 presents the Rp response results for thiosemicarbazide and phenyl thiosemicarbazide with different aldehydes for combinations conducted in the US.

FIG. 91 compares the Rp response results for thiosemicarbazide and phenyl thiosemicarbazide with various aldehydes between experiments conducted in India.

### DETAILED DESCRIPTION

Organic corrosion inhibitors are desirable because of their environmentally-friendly material properties and for the safety of those exposed. Further, organic corrosion inhibitors are relatively easy to synthesize thus are advantageous for processing. Dispersion of organic corrosion inhibitors in a polymer/coating composition enhances the corrosion inhibition of metals and alloys, such as aluminum and aluminum alloys. The compositions can be applied easily using existing methods, including immersion, spray, brushing, and the like.

High strength aluminum alloys, such as those used in the aerospace industry, are prone to corrosion due to the intermetallics present. Therefore, the primary purpose of coating aluminum alloys with coatings containing corrosion inhibitors is for corrosion protection. Coating aluminum and aluminum alloys with organic corrosion inhibitors is ideal for manufacturing because it is relatively low cost, lightweight, and utilizes environmentally benign materials. Curing may be achieved by air drying or thermal curing.

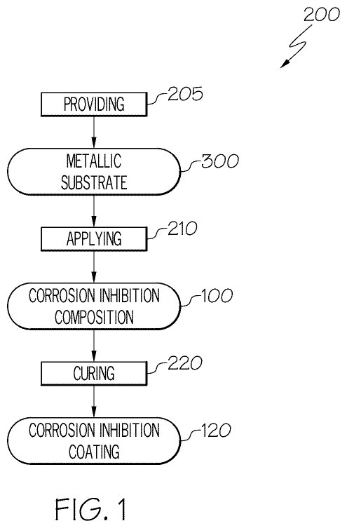

Referring to FIG. 1, in one or more examples, the disclosed corrosion inhibition composition 100 includes a carrier. The carrier may be (or may include) water, a hydrocarbon solvent, and/or a binder.

The corrosion inhibition composition 100 further includes a Schiff base in admixture with the carrier.

In one expression, the Schiff base of the disclosed corrosion inhibition composition 100 is (or includes) a thiosemicarbazone.

In one expression, the Schiff base of the disclosed corrosion inhibition composition 100 is (or includes) a member selected from the group consisting of thiosemicarbazone of isophthalaldehyde, thiosemicarbazone of terephthalaldehyde, thiosemicarbazone of salicylaldehyde, thiosemicarbazone of pyridine carboxyaldehyde, thiosemicarbazone of 2,6-diacetylpyridine, thiosemicarbazone of 5-hydroxymethyl-2-furaldehyde, thiosemicarbazone of 8-hydroxyquinoline-2-carboxyaldehyde, thiosemicarbazone of pentanedione, thiosemicarbazone of acetonylacetone, thiosemicarbazone of pyruvic aldehyde dimethyl acetal, thiosemicarbazone of mesityl oxide, and mixtures thereof.

In one expression, the Schiff base of the disclosed corrosion inhibition composition 100 is (or includes) an ethyl thiosemicarbazone.

In one expression, the Schiff base of the disclosed corrosion inhibition composition 100 is (or includes) a member selected from the group consisting of ethyl thiosemicarbazone of isophthalaldehyde, ethyl thiosemicarbazone of terephthalaldehyde, ethyl thiosemicarbazone of salicylaldehyde, ethyl thiosemicarbazone of pyridine carboxyaldehyde, ethyl thiosemicarbazone of 2,6-diacetylpyridine, ethyl thiosemicarbazone of 5-hydroxymethyl-2-furaldehyde, ethyl thiosemicarbazone of 8-hydroxyquinoline-2-carboxyaldehyde, ethyl thiosemicarbazone of pentanedione, ethyl thiosemicarbazone of acetonylacetone, ethyl thiosemicarbazone of pyruvic aldehyde dimethyl acetal, ethyl thiosemicarbazone of mesityl oxide, and mixtures thereof.

In one expression, the Schiff base of the disclosed corrosion inhibition composition 100 is (or includes) a methyl thiosemicarbazone.

In one expression, the Schiff base of the disclosed corrosion inhibition composition 100 is (or includes) a member selected from the group consisting of methyl thiosemicarbazone of isophthalaldehyde, methyl thiosemicarbazone of terephthalaldehyde, methyl thiosemicarbazone of salicylaldehyde, methyl thiosemicarbazone of pyridine carboxyaldehyde, methyl thiosemicarbazone of 2,6-diacetylpyridine, methyl thiosemicarbazone of 5-hydroxymethyl-2-furaldehyde, methyl thiosemicarbazone of 8-hydroxyquinoline-2-carboxyaldehyde, methyl thiosemicarbazone of pentanedione, methyl thiosemicarbazone of acetonylacetone, methyl thiosemicarbazone of pyruvic aldehyde dimethyl acetal, methyl thiosemicarbazone of mesityl oxide, and mixtures thereof.

In one expression, the Schiff base of the disclosed corrosion inhibition composition 100 is (or includes) a phenyl thiosemicarbazone.

In one expression, the Schiff base of the disclosed corrosion inhibition composition 100 is (or includes) a member selected from the group consisting of phenyl thiosemicarbazone of isophthalaldehyde, phenyl thiosemicarbazone of terephthalaldehyde, phenyl thiosemicarbazone of salicylaldehyde, phenyl thiosemicarbazone of pyridine carboxyaldehyde, phenyl thiosemicarbazone of 2,6-diacetylpyridine, phenyl thiosemicarbazone of 5-hydroxymethyl-2-furaldehyde, phenyl thiosemicarbazone of 8-hydroxyquinoline-2-carboxyaldehyde, phenyl thiosemicarbazone of pentanedione, phenyl thiosemicarbazone of acetonylacetone, phenyl thiosemicarbazone of pyruvic aldehyde dimethyl acetal, phenyl thiosemicarbazone of mesityl oxide, and mixtures thereof.

In yet another expression, the Schiff base of the disclosed corrosion inhibition composition 100 is (or includes) a thiocarbohydrazone.

In yet another expression, the Schiff base of the disclosed corrosion inhibition composition 100 is (or includes) a member selected from the group consisting of thiocarbohydrazone of isophthalaldehyde, thiocarbohydrazone of terephthalaldehyde, thiocarbohydrazone of salicylaldehyde, thiocarbohydrazone of pyridine carboxyaldehyde, thiocarbohydrazone of 2,6-diacetylpyridine, thiocarbohydrazone of 5-hydroxymethyl-2-furaldehyde, thiocarbohydrazone of 8-hydroxyquinoline-2-carboxyaldehyde, thiocarbohydrazone of pentanedione, thiocarbohydrazone of acetonylacetone, thiocarbohydrazone of pyruvic aldehyde dimethyl acetal, thiocarbohydrazone of mesityl oxide, and mixtures thereof.

In another expression, the Schiff base of the disclosed corrosion inhibition composition 100 is (or includes) a member selected from the group consisting of (E)-N-methyl-2-((5-methylfuran-2-yl)methylene)hydrazine-1-carbothioamide, (E)-2-((5-methylfuran-2-yl)methylene)hydrazine-1-carbothioamide, (2E)-N-methyl-2-(3-phenylallylidene)hydrazine-1-carbothioamide, (E)-2-(4-isopropylbenzylidene)-N-methylhydrazine-1-carbothioamide, (E)-2-(4-isopropylbenzylidene)hydrazine-1-carbothioamide, (2E)-2-(3-phenylallylidene)hydrazine-1-carbothioamide, and mixtures thereof.

In another expression, the Schiff base of the disclosed corrosion inhibition composition 100 is (or includes) a member selected from the group consisting of (E)-1-(5-methylfuran-2-yl)-N-(4H-1,2,4-triazol-4-yl)methanimine, (E)-4-Hydroxy-N′-((5-methylfuran-2-yl)methylene)benzohydrazide, (E)-N′-((5-methylfuran-2-yl)methylene)benzohydrazide, (E)-2-((5-methylfuran-2-yl)methylene)hydrazine-1-carboxamide, (E)-1-phenyl-N-(4H-1,2,4-triazol-4-yl)methanimine, 4-Hydroxy-N′-[(E)-phenylmethylidene]benzohydrazide, (E)-N′-benzylidenebenzohydrazide, 4-hydroxy-N′-((1E)-3-phenylallylidene)benzohydrazide, N′-((1E)-3-phenylallylidene)benzohydrazide, (E)-1-(4-Ethylphenyl)-N-(4H-1,2,4-triazol-4-yl)methanimine, (E)-N′-(4-ethylbenzylidene)-4-hydroxybenzohydrazide, E (E)-N′-(4-ethylbenzylidene)benzohydrazide, (E)-1-[4-(propan-2-yl)phenyl]-N-(4H-1,2,4-triazol-4-yl)methanimine, 4-Hydroxy-N′-[(E)-[4-(propan-2-yl)phenyl]methylidene]benzohydrazide, N′-[(E)-[4-(propan-2-yl)phenyl]methylidene]benzohydrazide, (E)-2-(4-isopropylbenzylidene)hydrazine-1-carboxamide, (E)-1-(4-isopropylbenzylidene) urea, and mixtures thereof.

In yet another expression, the Schiff base of the corrosion inhibition composition 100 has the following structure:

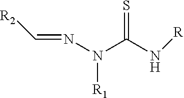

The R₂ of the above-referenced structure is one of an alkyl, an aryl/substituted aryl, and a heterocyclic/substituted heterocyclic group. The R is one of a hydrogen, an aryl/substituted aryl, and an alkyl group. Further, the R₁ is one of a hydrogen, an aryl/substituted aryl, and an alkyl group.

The Schiff base of the corrosion inhibition composition 100 may be present in the corrosion inhibition composition 100 at a concentration of approximately 0.1 mmol to approximately 25 mmol. In one particular example, the Schiff base of the corrosion inhibition composition 100 is at a concentration of approximately 1 mmol to approximately 10 mmol.

The carrier of the corrosion inhibition composition 100 may be (or may include) a polymeric binder. In one example, the polymeric binder is (or includes) a sol gel-based polymer. The sol gel-based polymer is a film forming sol-gel based polymer such that the corrosion inhibition composition 100 includes the Schiff base in admixture with the carrier and, upon curing, forms a corrosion inhibition coating 120. In another example, the carrier is commercially available sol-gel based carrier Ultracorr ACX-W from M/s Harind Chemicals & Pharmaceuticals Pvt. Ltd., India.

Referring to FIG. 1, disclosed is a method 200 for inhibiting corrosion on a metallic substrate 300. The method 200 includes providing 205 a metallic substrate 300. The method 200 further includes applying 210 to the metallic substrate 300 a corrosion inhibition composition 100 that includes a Schiff base. The applying 210 is performed by immersing the metallic substrate 300 in the corrosion inhibition composition 100, spraying the corrosion inhibition composition 100 onto the metallic substrate 300, brushing the corrosion inhibition composition 100 onto the metallic substrate 300, dipping the corrosion inhibition composition 100, or any other suitable means.

The step of applying 210 to the metallic substrate 300 a corrosion inhibition composition 100 that includes a Schiff base may further include applying 210 to the metallic substrate 300 a corrosion inhibition composition 100 that includes a Schiff base and a carrier. The carrier may be, for example, water, a hydrocarbon solvent, and/or a binder. In one example, the binder includes a polymeric binder. In another example, the polymeric binder includes a sol gel-based polymer. The sol gel-based polymer is a film forming sol-gel based polymer such that the corrosion inhibition composition 100 includes the Schiff base in admixture with the carrier and, upon curing, forms a corrosion inhibition coating 120.

Various metallic substrates 300 may be used. In an example, the metallic substrate 300 of the method 200 may be steel, such as carbon steel. In another example, the metallic substrate 300 of the method 200 may be selected from the group consisting of aluminum alloy, a zinc alloy, and a nickel alloy. In one specific, non-limiting example, the metallic substrate 300 is aluminum or an aluminum alloy. In another specific, non-limiting example, the metallic substrate 300 is 2024 aluminum alloy. In yet another specific, non-limiting example, the metallic substrate 300 is a 7XXX series aluminum alloy.

Referring to FIG. 1, the method 200 may further include curing 220 the corrosion inhibition composition 100 to yield a corrosion inhibition coating 120. The curing 220 is performed by air drying, subjecting the corrosion inhibition composition 100 to thermal treatment, or any other suitable means of curing the corrosion inhibition composition 100 to yield a corrosion inhibition coating 120.

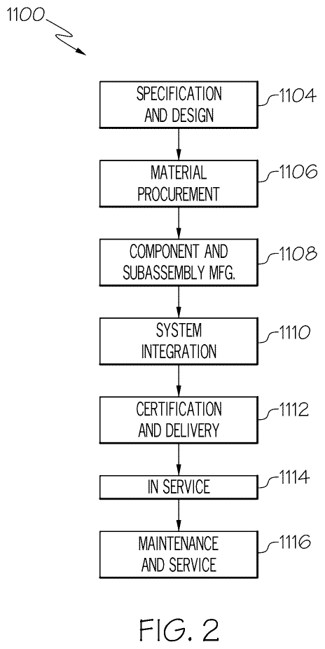

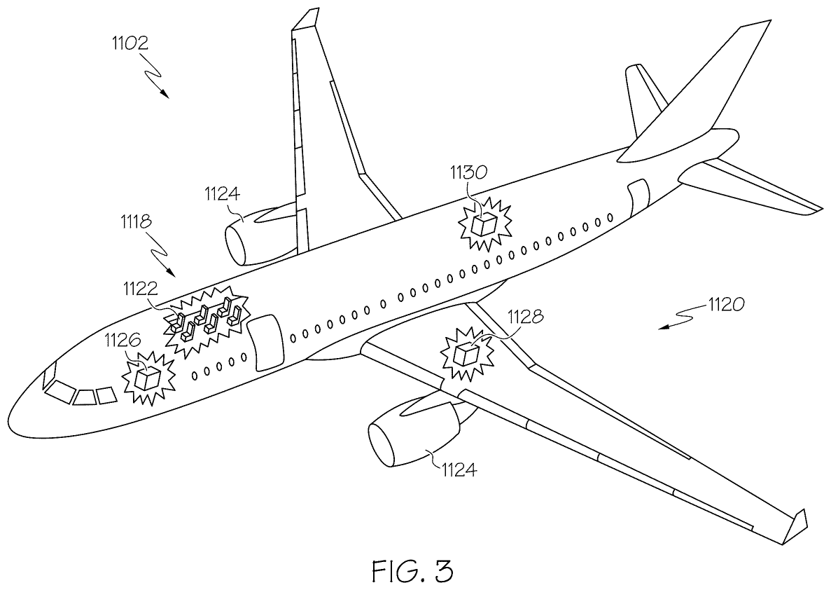

Examples of the subject matter disclosed herein may be described in the context of aircraft manufacturing and service method 1100 as shown in FIG. 2 and aircraft 1102 as shown in FIG. 3. During pre-production, illustrative method 1100 may include specification and design (block 1104) of aircraft 1102 and material procurement (block 1106). During production, component and subassembly manufacturing (block 1108) and system integration (block 1110) of aircraft 1102 may take place. Thereafter, aircraft 1102 may go through certification and delivery (block 1112) to be placed in service (block 1114). While in service, aircraft 1102 may be scheduled for routine maintenance and service (block 1116). Routine maintenance and service may include modification, reconfiguration, refurbishment, etc. of one or more systems of aircraft 1102.

Each of the processes of illustrative method 1100 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

As shown in FIG. 3, aircraft 1102 produced by illustrative method 1100 may include airframe 1118 with a plurality of high-level systems 1120 and interior 1122. Examples of high-level systems 1120 include one or more of propulsion system 1124, electrical system 1126, hydraulic system 1128, and environmental system 1130. Any number of other systems may be included. Although an aerospace example is shown, the principles disclosed herein may be applied to other industries, such as the automotive industry. Accordingly, in addition to aircraft 1102, the principles disclosed herein may apply to other vehicles, e.g., land vehicles, marine vehicles, space vehicles, etc.

Apparatus(es) and method(s) shown or described herein may be employed during any one or more of the stages of the manufacturing and service method 1100. For example, components or subassemblies corresponding to component and subassembly manufacturing (block 1108) may be fabricated or manufactured in a manner similar to components or subassemblies produced while aircraft 1102 is in service (block 1114). Also, one or more examples of the apparatus(es), method(s), or combination thereof may be utilized during production stages (block 1108 and block 1110), for example, by substantially expediting assembly of or reducing the cost of aircraft 1102. Similarly, one or more examples of the apparatus or method realizations, or a combination thereof, may be utilized, for example and without limitation, while aircraft 1102 is in service (block 1114) and/or during maintenance and service (block 1116).

Different examples of the apparatus(es) and method(s) disclosed herein include a variety of components, features, and functionalities. It should be understood that the various examples of the apparatus(es) and method(s), disclosed herein, may include any of the components, features, and functionalities of any of the other examples of the apparatus(es) and method(s) disclosed herein in any combination.

Many modifications of examples, set forth herein, will come to mind of one skilled in the art, having the benefit of the teachings, presented in the foregoing descriptions and the associated drawings. Therefore, it is to be understood that the subject matter disclosed herein is not to be limited to the specific examples illustrated and that modifications and other examples are intended to be included within the scope of the appended claims. Moreover, although the foregoing description and the associated drawings describe examples of the subject matter, disclosed herein, in the context of certain illustrative combinations of elements and/or functions, it should be appreciated that different combinations of elements and/or functions may be provided by alternative implementations without departing from the scope of the appended claims.

### First Experimental Results

Examples of the disclosed corrosion inhibition composition 100 and method 200 of inhibiting corrosion on metallic substrates are provided herein. The metallic substrate 300 used in the following examples is Al 2024. The carrier used in the following examples is a sol-gel based polymeric binder.

For synthesis of the Schiff base inhibitor, equimolar mixtures of aldehyde and primary amine were taken in a round bottomed flask, dissolved in ethanol, and a few drops of glacial Acetic acid were added to the mixture. The reaction mixture was refluxed for 2-3 hrs. The completion of reaction was monitored by TLC (mobile phase used is Ethyl acetate:Pet Ether at 5:1 ratio). After completion of reaction, the reaction mixture was cooled to room temperature and remaining solvent evaporated. Precipitate was obtained after solvent evaporation was filtered, washed with cold water, and dried. The compound was recrystallized from absolute ethanol. Recrystallized compound was characterized using Fourier-transform infrared spectroscopy (FTIR), Nuclear magnetic resonance spectroscopy (NMR) for structure confirmation.

Electrochemical analysis was used to measure corrosion inhibition efficiency of synthesized the corrosion inhibition compositions 100 having a Schiff base on the Al 2024 alloys. The corrosion inhibition compositions 100 were utilized in a 5% NaCl solution to test inhibition properties when exposed to a corrosive environment. After the corrosion inhibition compositions 100 were cured, they were tested with electrochemical analysis.

Table 1 illustrates the Schiff base inhibitors used in the examples disclosed herein.

TABLE 1

| | | | | Molecular | Molecular |
|---|---|---|---|---|---|
| Sr No. | Inhibitor | IUPAC Name | Structure | Formula | weight |
| 1 | 5MF- 4ATri | (E)-1-(5- methylfuran-2- yl)-N-(4H-1,2,4- triazol-4- yl)methanimine | 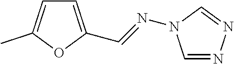 | C8H8N4O | 176.18 |
| 2 | 5MF- 4HBH | (E)-4-hydroxy- N′-((5- methylfuran-2- yl)methylene) benzohydrazide | 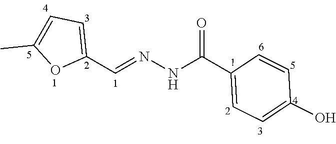 [SMILES: Cc1ccc(/C=N/NC(=O)c2ccc(O)cc2)o1] | C13H12N2O3 | 244.25 |
| 3 | 5MF- 4M3TSC | (E)-N-methyl-2- ((5-methylfuran- 2- yl)methylene) hydrazine-1- carbothioamide | 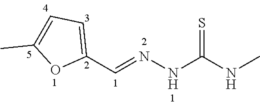 | C8H11N3OS | 197.26 |
| 4 | 5MF-BH | (E)-N′-((5- methylfuran-2- yl)methylene) benzohydrazide | 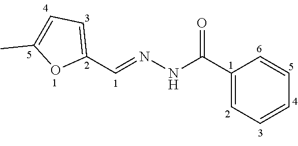 [SMILES: Cc1ccc(/C=N/NC(=O)c2ccccc2)o1] | C13H12N2O2 | 228.25 |
| 5 | 5MF-SC | (E)-2-((5- methylfuran-2- yl)methylene) hydrazine-1- carboxamide | 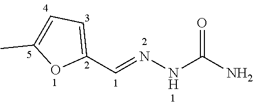 | C7H9N3O2 | 167.17 |
| 6 | 5MF- TSC | (E)-2-((5- methylfuran-2- yl)methylene) hydrazine-1- carbothioamide | 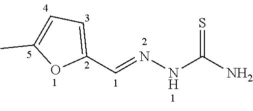 | C7H9N3OS | 183.23 |
| 7 | B-4ATri | (E)-1-phenyl- N-(4H-1,2,4- triazol-4- yl)methanimine | 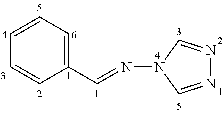 [SMILES: C(=N\n1cnnc1)/c1ccccc1] | C9H8N4 | 172.19 |
| 8 | B-4HBH | 4-Hydroxy-N′- [(E)- phenylmethylidene] benzohydrazide | 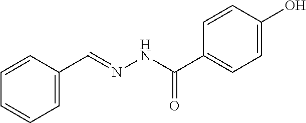 [SMILES: O=C(N/N=C/c1ccccc1)c1ccc(O)cc1] | C14H12N2O2 | 240.26 |
| 9 | B-BH | (E)-N′- benzylidenebenzo- hydrazide | 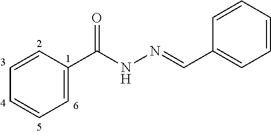 [SMILES: O=C(N/N=C/c1ccccc1)c1ccccc1] | C14H12N2O | 224.26 |
| 10 | C-4HBH | 4-hydroxy-N′- ((1E)-3- phenylallylidene) benzohydrazide | 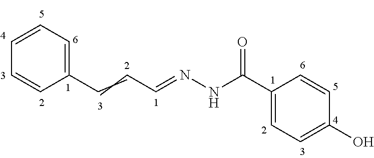 [SMILES: O=C(N/N=C/C=Cc1ccccc1)c1ccc(O)cc1] | C16H14N2O2 | 266.30 |
| 11 | C- 4M3TSC | (2E)-N-methyl- 2-(3- phenylallylidene) hydrazine-1- carbothioamide | 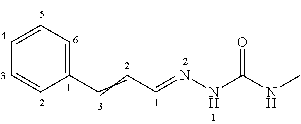 | C11H13N3S | 219.31 |
| 12 | C-BH | N′-((1E)-3- phenylallylidene) benzohydrazide | 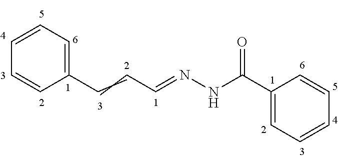 [SMILES: O=C(N/N=C/C=Cc1ccccc1)c1ccccc1] | C16H14N2O | 250.30 |
| 13 | C-TSC | (2E)-2-(3- phenylallylidene) hydrazine-1 - carbothioamide | 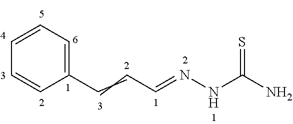 [SMILES: NC(=S)N/N=C/C=Cc1ccccc1] | C10H11N3S | 205.28 |
| 14 | EB- 4ATri | (E)-1-(4- Ethylphenyl)-N- (4H-1,2,4- triazol-4- yl)methanimine | 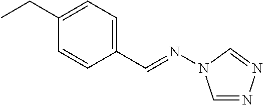 | C11H12N4 | 200.25 |
| 15 | EB- 4HBH | (E)-N′-(4- ethylbenzylidene)- 4- hydroxybenzo- hydrazide | 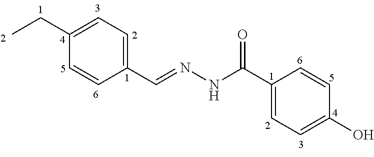 [SMILES: CCc1ccc(/C=N/NC(=O)c2ccc(O)cc2)cc1] | C16H16N2O2 | 268.32 |
| 16 | EB-BH | E (E)-N′-(4- ethylbenzylidene) benzohydrazide | 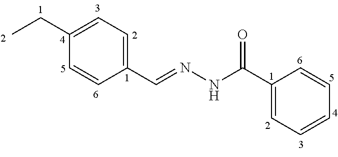 [SMILES: CCc1ccc(/C=N/NC(=O)c2ccccc2)cc1] | C16H16N2O | 252.32 |
| 17 | IPB- 4ATri | (E)-1-[4- (propan-2- yl)phenyl]-N- (4H-1,2,4- triazol-4- yl)methanimine | 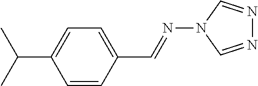 [SMILES: CC(C)c1ccc(/C=N/n2cnnc2)cc1] | C12H14N4 | 214.27 |
| 18 | IPB- 4HBH | 4-Hydroxy-N′- [(E)-[4-(propan- 2- yl)phenyl]methyl- idene]benzohy- drazide | 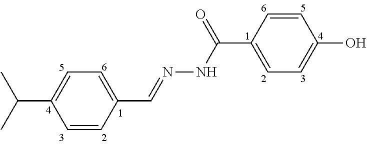 [SMILES: CC(C)c1ccc(/C=N/NC(=O)c2ccc(O)cc2)cc1] | C17H18N2O2 | 282.34 |
| 19 | IPB- 4M3TSC | (E)-2-(4- isopropylbenzyl- idene)-N- methylhydrazine- 1- carbothioamide | 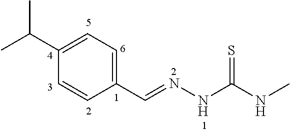 [SMILES: CNC(=S)N/N=C/c1ccc(C(C)C)cc1] | C12H17N3S | 235.35 |
| 20 | IPB-BH | N′-[(E)-[4- (propan-2- yl)phenyl]methyl- idene]benzo- hydrazide | 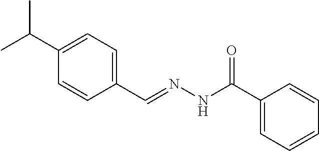 [SMILES: CC(C)c1ccc(/C=N/NC(=O)c2ccccc2)cc1] | C17H18N2O | 266.34 |
| 21 | IPB-SC | (E)-2-(4- isopropylbenzyl- idene)hydrazine- 1-carboxamide | 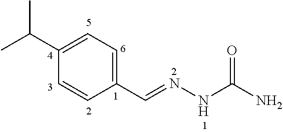 | C11H15N3O | 205.26 |
| 22 | IPB-TSC | (E)-2-(4- isopropylbenzyl- idene)hydrazine- 1- carbothioamide | 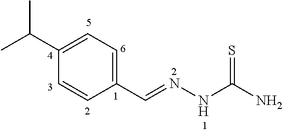 | C11H15N3S | 221.32 |
| 23 | IPBU | (E)-1-(4- isopropylbenzyl- idene)urea | 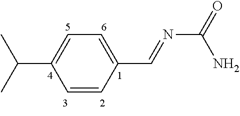 | C11H14N2O | 190.25 |

Table 2 illustrates the aldehydes and primary amines used for synthesis of Schiff base inhibitors in the examples disclosed herein.

TABLE 2

| Aldehyde | Primary Amine |
|---|---|
| Benzaldehyde (B) | 4-Amino triazole (4ATri) |
| 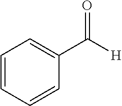 | 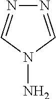 |
| 4-Isopropylbenzaldehyde (IPB) | Benzohydrazide (BH) |
| 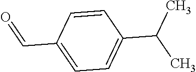 | 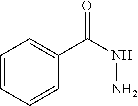 |
| 5-Methyl Furfural (5MF) | 4-Hydroxyl benzohydrazide (4HBH) |
| 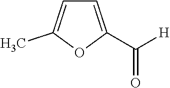 | 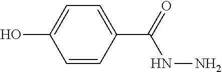 [SMILES: NNC(=O)c1ccc(O)cc1] |
| Cinnamaldehyde (C) | Urea (U) |
| 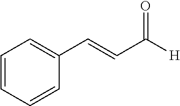 | 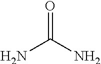 |
| 4-Ethylbenzaldehyde (EB) | Thiosemicarbazide (TSC) |
| 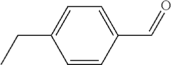 | 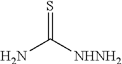 |
| | 4-Methyl-3 Thiosemicarbazide |
| | (4M3TSC) |
| | 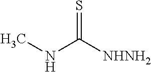 |
| | Semicarbazide (SC) |
| | 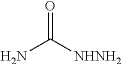 |

Corrosion inhibition efficiency of synthesized Schiff base inhibitors was measured using electrochemical method of analysis. Linear polarization resistance (LPR) of Al 2024 measured in 5% NaCl and inhibitor solution mixture as electrolyte.

The technique involved monitoring the current response when a small potential typically of the order of ±10 mV, relative to its Open Circuit Potential (OCP) is applied to the working electrode (A1 2024 in this case). As the potential of the material (working electrode) is changed, a current will be induced to flow between the working and counter electrodes, and the material's resistance to polarization can be found by taking the slope of the potential versus current curve. This polarization resistance is proportional to the corrosion rate. As inhibitors bind to the surface of Al 2024 and passivates the surface, the calculated polarization resistance of the Al 2024 panel is expected to increase. Inhibition efficiency for inhibitor is calculated using following equation:

$$\% Inhibition Efficiency = \frac{{Rp}_{inh} - {Rp}_{0}}{{Rp}_{inh}} \times 100$$

In the above-referenced calculation, Rₚᵢₙₕ and Rₚ₀ represent LPR with and without inhibitor, respectively.

LPR measurements were carried out using CH Instrument's electrochemical workstation model CHI 600E. The electrochemical cell consists of three electrode flat cell with platinum as counter electrode, saturated calomel electrode (SCE) as reference electrode and Al 2024 as working electrode. Pre-cleaned Al 2024 panels were exposed to electrolyte solution for different increments of time. Experimental parameters began with panel preparation, as detailed below.

Panel preparation included: 1) an acetone wipe to degrease panels; 2) dip in 10% NaOH solution for 4 min; 3) rinse in DI water (2 time); 4) dip in 50% HNO3 for 1 min; 5) rinse in DI water (2 time); and 6) air dry the panels.

Electrolyte preparation included: 1) preparation of phosphate buffer saline (PBS) solution (pH 7.4); 2) preparation of 5% NaCl Solution in PBS solution; 3) adding 300 ml of 5% NaCl solution prepared in PBS solution to a beaker and add 0.5 gm of inhibitor; 4) subject to a bath-sonicator for 15 min; 5) filtration through Whatmann filter paper no. 1; and 6) using the filtrate as electrolyte.

A potentiostat was used for electroanalytical data collection. Experimental parameters include: 1) measuring open circuit potential (OCP) for 15 min; 2) running potential sweep at +10 mV of OCP with scan rate of 0.1667 mV/S; 3) calculating linear polarization resistance LPR within a range of ±10 mV of OCP; 4) measuring LPR after 1 hr, 3 hr and 5 hrs of exposure by following step 1-3:5) plotting Rp vs time for each inhibitor; and 6) calculating corrosion efficiency for inhibitor with LPR measured post 5 hours of exposure.

Table 3 illustrates the percent of corrosion inhibition efficiency for each corrosion inhibitor tested on an Al 2024 metallic substrate 300.

TABLE 3

| | | LPR after 5 hrs | % Corrosion |
|---|---|---|---|
| Sr no. | Inhibitor | exposure (K Ohm) | Inhibition Efficiency |
| 1 | Blank | 7.31 | |
| 2 | Dichromate | 217.2 | 96.6 |
| 3 | 5MF-4ATri | 19.58 | 62.7 |
| 4 | 5MF-4HBH | 19.12 | 61.8 |
| 5 | 5MF-4M3TSC | 107.9 | 93.2 |
| 6 | 5MF-BH | 10.45 | 30.0 |
| 7 | 5MF-SC | 14.23 | 48.6 |
| 8 | 5MF-TSC | 340.7 | 97.9 |
| 9 | B-4ATri | 27.01 | 72.9 |
| 10 | B-4HBH | 34.01 | 78.5 |
| 12 | C-4HBH | 15.94 | 54.1 |
| 13 | C-4M3TSC | 237.5 | 96.9 |
| 14 | C-BH | 16.97 | 56.9 |
| 15 | C-TSC | 71.34 | 89.8 |
| 16 | EB-4ATri | 17.38 | 57.9 |
| 17 | EB-4HBH | 19.64 | 62.8 |
| 18 | EB-BH | 9.72 | 24.8 |
| 19 | IPB-4ATri | 18.01 | 59.4 |
| 20 | IPB-4HBH | 25.36 | 71.2 |
| 21 | IPB-4M3TSC | 247.5 | 97.0 |
| 22 | IPB-BH | 18.1 | 59.6 |
| 24 | IPB-TSC | 78.29 | 90.7 |
| 25 | IPBU | 7.39 | 1.1 |

As shown in Table 3 above, the Schiff base inhibitors synthesized using Thiosemicarbazide (Thiosemicarbazone) exhibited the highest percentage of corrosion inhibition efficiency.

Another variable tested during experimentation includes the concentration of Schiff base inhibitor dispersed into the carrier. The carrier used in the examples is commercially available sol-gel based carrier Ultracorr ACX-W from M/s Harind Chemicals & Pharmaceuticals Pvt. Ltd., India. The Thiosemicarbazones were dispersed into the sol-gel based polymer at three different concentrations as per the details mentioned in Table 4 below.

Table 4 illustrates inhibitor quantity used for preparation of different concentrations.

TABLE 4

| Sr. | | Molecular | 1 mM in | 5 mM in | 10 mM in |
|---|---|---|---|---|---|
| No | Inhibitor | Weight | 300 ml | 300 ml | 300 ml |
| 1 | 5MF-4M3TSC | 197.26 | 0.059 | 0.296 | 0.592 |
| 2 | 5MF-TSC | 183.23 | 0.055 | 0.275 | 0.550 |
| 3 | C-4M3TSC | 219.31 | 0.066 | 0.329 | 0.658 |
| 4 | C-TSC | 205.28 | 0.062 | 0.308 | 0.616 |
| 5 | IPB-4M3TSC | 235.35 | 0.071 | 0.353 | 0.706 |
| 6 | IPB-TSC | 221.32 | 0.066 | 0.332 | 0.664 |

Synthesis and application of coating done as per following steps: 1) inhibitor as per required concentration was dissolved in minimum amount of Ethanol; 2) Inhibitor solution prepared in step 1 was added to 300 ml of sol-gel based polymer under stirring. Mixture was stirred for 2 hours on magnetic stirrer at 600 RPM; 3) Above coating composition applied on pre-cleaned Al 2024 (as per process described previously) substrate using dip application. Coating cured for 7 days at RT.; and 4) Corrosion inhibition efficiency of coating was measured using electrochemical analysis (Potentiodynamic polarization). Analysis was performed in 5% salt solution prepared in PBS buffer solution. Inhibition efficiency for coating calculated using following equation:

$$\% Inhibition Efficiency = \frac{{i}_{corr ( uninhibited )} - {i}_{corr ( inhibitor )}}{{i}_{Corr ( uninhibited )}} \times 100$$

The coating compositions were evaluated by potentiodynamic polarization. Results shown in Table 5 below indicate a decrease in corrosion current density (I corr) and corrosion rate of Al 2024 with addition of inhibitor. This in turn reveals the corrosion inhibiting nature of the coating.

TABLE 5

| | Inhibitor | | | Corrosion | % Corrosion |
|---|---|---|---|---|---|
| | Concentration | | | Rate | Inhibition |
| Inhibitor | (mM) | E_{corr} (V) | I_{Corr} (A) | (mil/year) | Efficiency |
| 5MF- | 0 | −0.686 | 10.61 × 10⁻⁹ | 4.421 × 10⁻³ | |
| 4M3TSC | 1 | −0.667 | 10.38 × 10⁻⁹ | 4.323 × 10⁻³ | 2.17 |
| | 5 | −0.685 | 9.780 × 10⁻⁹ | 4.074 × 10⁻³ | 7.82 |
| | 10 | −0.61 | 8.451 × 10⁻⁹ | 3.521 × 10⁻³ | 20.35 |
| 5MF-TSC | 0 | −0.702 | 17.72 × 10⁻⁹ | 7.384 × 10⁻³ | |
| | 1 | −0.654 | 8.778 × 10⁻⁹ | 3.657 × 10⁻³ | 50.5 |
| | 5 | −0.575 | 10.04 × 10⁻⁹ | 4.184 × 10⁻³ | 43.3 |
| | 10 | −0.608 | 7.407 × 10⁻⁹ | 3.086 × 10⁻³ | 58.2 |
| IPB-4M3TSC | 0 | −0.68 | 34.74 × 10⁻⁹ | 14.47 × 10⁻³ | |
| | 1 | −0.612 | 16.31 × 10⁻⁹ | 6.797 × 10⁻³ | 53.1 |
| | 5 | −0.548 | 7.078 × 10⁻⁹ | 2.949 × 10⁻³ | 79.6 |
| | 10 | −0.615 | 5.601 × 10⁻⁹ | 2.333 × 10⁻³ | 83.9 |
| IPB-TSC | 0 | −0.652 | 42.82 × 10⁻⁹ | 17.84 × 10⁻³ | |
| | 1 | −0.379 | 11.19 × 10⁻⁹ | 4.662 × 10⁻³ | 67.8 |
| | 5 | −0.414 | 10.26 × 10⁻⁹ | 4.274 × 10⁻³ | 70.5 |
| | 10 | −0.466 | 8.769 × 10⁻⁹ | 3.653 × 10⁻³ | 74.8 |
| C-4M3TSC | 0 | −0.593 | 22.27 × 10⁻⁹ | 9.279 × 10⁻³ | |
| | 1 | −0.621 | 17.48 × 10⁻⁹ | 7.283 × 10⁻³ | 7.3 |
| | 5 | −0.653 | 17.07 × 10⁻⁹ | 7.112 × 10⁻³ | 9.4 |
| | 10 | −0.549 | 14.14 × 10⁻⁹ | 5.892 × 10⁻³ | 25.0 |
| C-TSC | 0 | −0.643 | 78.80 × 10⁻⁹ | 32.83 × 10⁻³ | |
| | 1 | −0.623 | 12.97 × 10⁻⁹ | 5.402 × 10⁻³ | 83.5 |
| | 5 | −0.631 | 18.89 × 10⁻⁹ | 7.870 × 10⁻³ | 76.0 |
| | 10 | −0.601 | 11.56 × 10⁻⁹ | 4.814 × 10⁻³ | 85.3 |

### Second Experimental Results

To further illustrate the synthesis and analysis of various Schiff bases, additional examples are provided. These include thiosemicarbazone, ethyl thiosemicarbazone, methyl thiosemicarbazone, phenyl thiosemicarbazone, and thiocarbohydrazone. Each synthesis example is followed by spectroscopic analyses to confirm the formation of the synthesized compounds. The examples also present data on the corrosion inhibition performance of the synthesized Schiff bases, evaluated through electrochemical measurements. The following sections detail exemplary synthesis protocols and analytical results for these Schiff bases, providing an understanding of their chemical behaviors and applications in corrosion inhibition.

### Synthesis of Thiosemicarbazone of Isophthalaldehyde

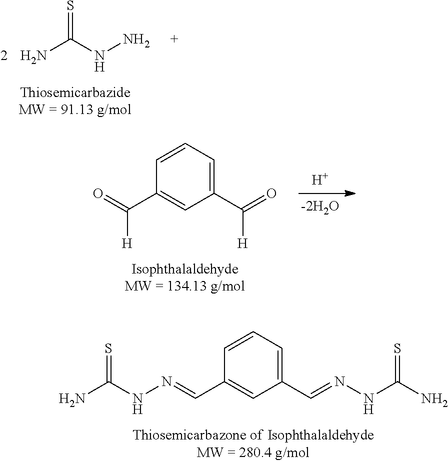

TABLE 6

| | | | Molecular | Number | Actual mass |
|---|---|---|---|---|---|
| Chemical | CAS # | Supplier (Lot #) | weight (g/mol) | of moles | or volume |
| Isophthalaldehyde | 626-19-7 | Thermofisher | 134.13 | 0.1 | 13.440 g |
| | | Scientific | | | |
| | | (5003J16S) | | | |
| Thiosemicarbazide | 79-19-6 | Alfa Aesar | 91.13 | 0.2 | 18.291 g |
| | | (S09D016) | | | |
| 35% HCl | 7647-01-0 | Thermofisher | 36.45 | 0.02 | 2.154 mL |
| | | Scientific | | | |
| | | (A4119120) | | | |

A solution of thiosemicarbazide in 270 mL of di-water was refluxed with stirring at 149° F. until the thiosemicarbazide was completed dissolved. A solution of 2.15 mL of HCl in 30 mL of water was then added drop wise. Next a solution of isophthalaldehyde in 220 mL of ethanol was slowly added to the flask over a period of 30 minutes and the solution temperature was raised to 172.4° F. The addition of isophthalaldehyde caused precipitation of the white thiosemicarbazone. The solution was refluxed with stirring at 172.4° F. for 3 hr and left stirring overnight without heating. The white thiosemicarbazone precipitate was then washed with 2000 mL of di-water and dried overnight in an oven at 60° C. Yield=93.89%

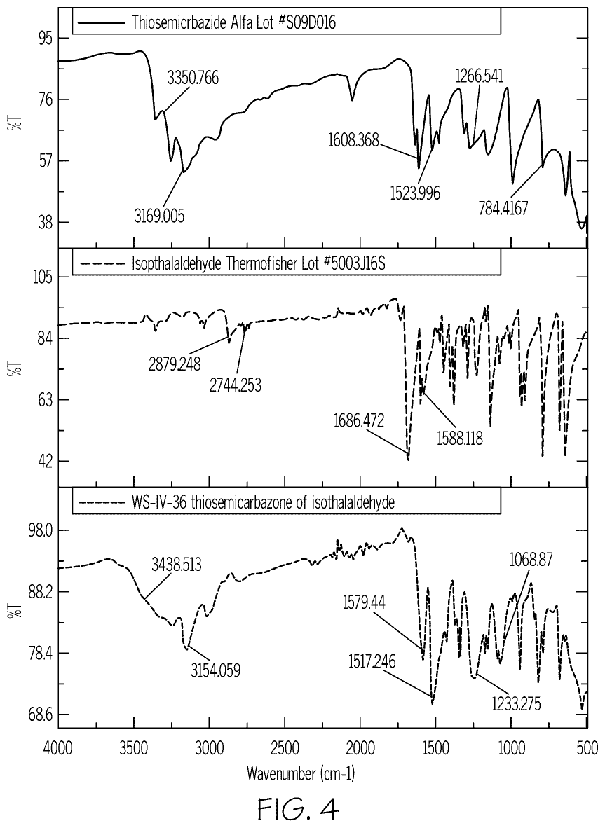

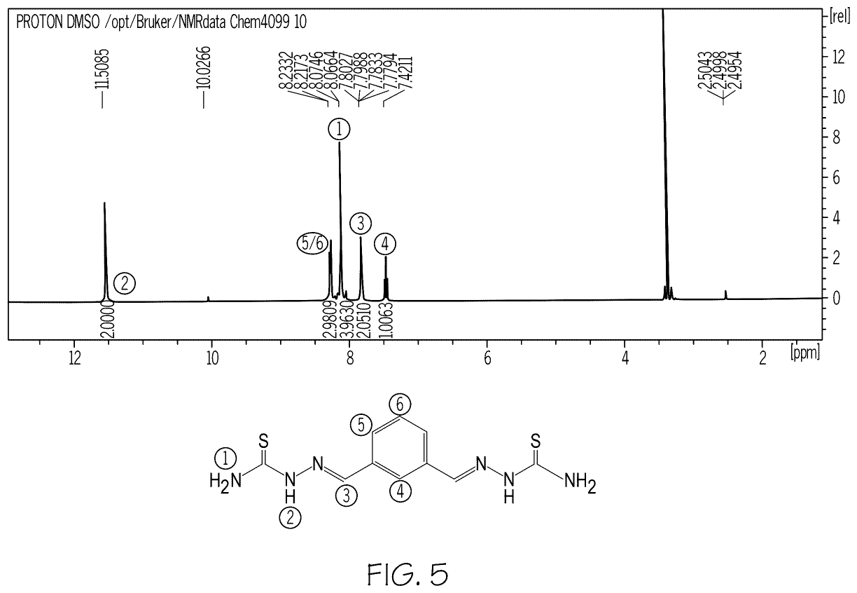

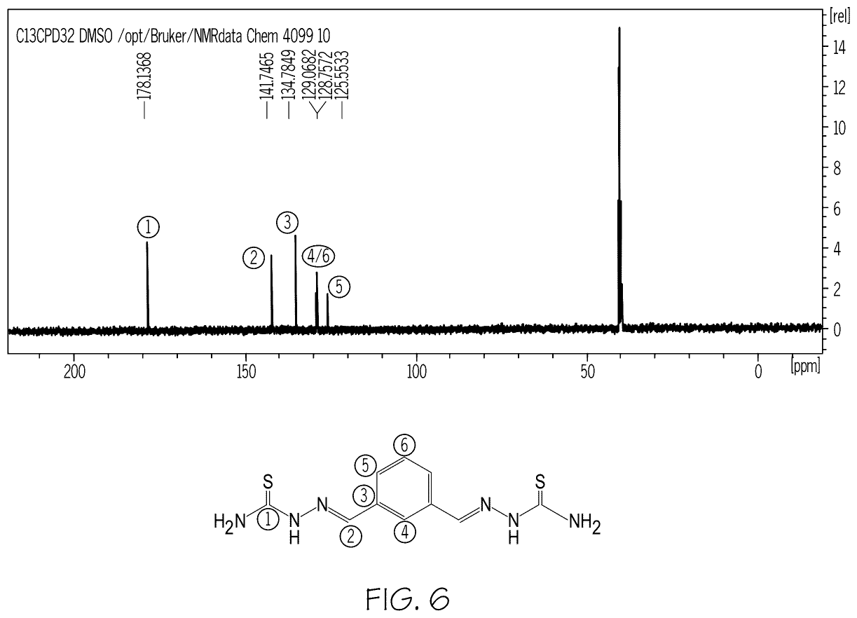

From FIG. 4, the broad bands observed in the ranges of 3100-3450 cm₋₁ were assigned to the v(NH₂) and v(NH) vibrations and absorption from hydroxyls (water). The strong and medium absorption bands at 1580-1610 cm₋₁ were attributed to the v(C═N) stretching vibrations of the imine group. It indicates that free —NH₂ group of Thiosemicarbazide was converted to azomethine group. The medium bands which are in 1080-1100 cm₋₁ range were ascribed to v(C═S) stretching vibrations, indicating that the studied compounds are present in the thione form. The presence of aromatic rings has been identified by their characteristic ring vibrations at 1500-1400, 1100-1050 and 900-700 cm₋₁ region. The absence of bands characteristic of aldehyde v(C═O), v(C—H) and presence of band v(C═N) characteristic of imine confirms the formation of the proposed Schiff base framework. The 1H NMR is shown on FIG. 5 and the 13C NMR on FIG. 6. Both NMR spectra has expected absorption bands as confirmed by modeling software. Spectra suggested a reasonably pure product. Both 1H and 13C NMR showed excess water, with peaks at ˜3 ppm.

### Synthesis of Thiosemicarbazone of Salicylaldehyde

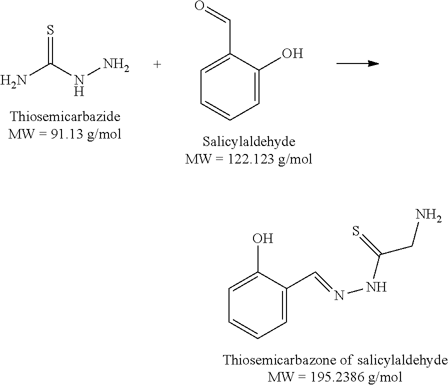 [SMILES: NNC(N)=S ; O=Cc1ccccc1O ; NCC(=S)N/N=C/c1ccccc1O]

TABLE 7

| | | | Molecular | Number of | Actual mass |
|---|---|---|---|---|---|
| Chemical | CAS # | Supplier (Lot #) | weight (g/mol) | moles | or volume |
| Salicylaldehyde | 90.02-8 | Acros Organics | 122.12 | 0.2 | 24.424 g |
| | | (A042293949) | | | |
| Thiosemicarbazide | 79-19-6 | Alfa Aesar | 91.13 | 0.2 | 18.226 g |
| | | (S09D016) | | | |
| 35% HCl | 7647-01-0 | Thermofisher | 36.45 | .02 | 2.154 mL |
| | | Scientific | | | |
| | | (A4119120) | | | |

A solution of thiosemicarbazide in 270 mL of DI-water was refluxed with stirring at 149° F. until the thiosemicarbazide was completed dissolved. A solution of 2.15 mL of HCl in 30 mL of water was then added drop wise. Next a solution of salicylaldehyde in 220 mL of ethanol was slowly added to the flask over a period of 30 minutes and the solution temperature was raised to 172.4° F. The addition of isophthalaldehyde caused precipitation of the cream colored thiosemicarbazone. The solution was refluxed at 172.4° F. for 3 hr and left stirring overnight without heating. The cream colored thiosemicarbazone precipitate was then washed with 2000 mL of di-water and dried overnight in an oven at 60° C. Yield=84.5%.

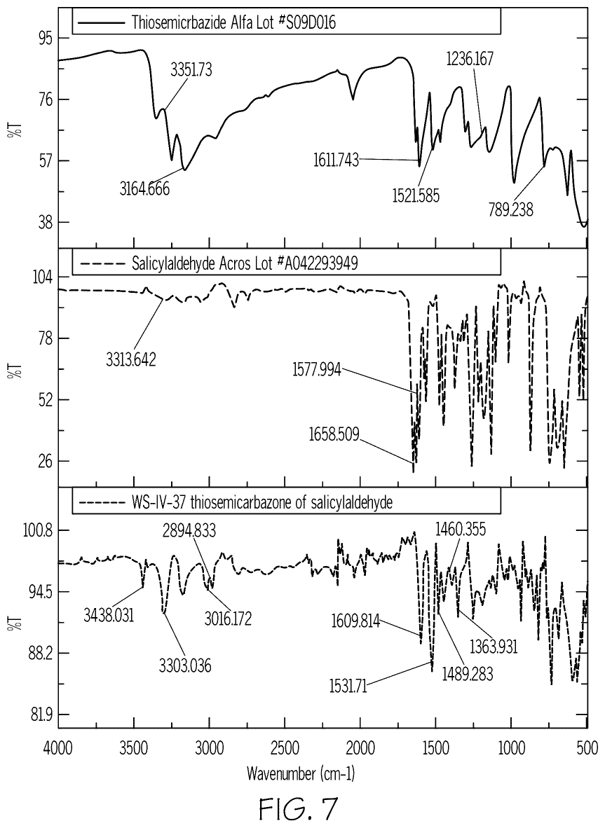

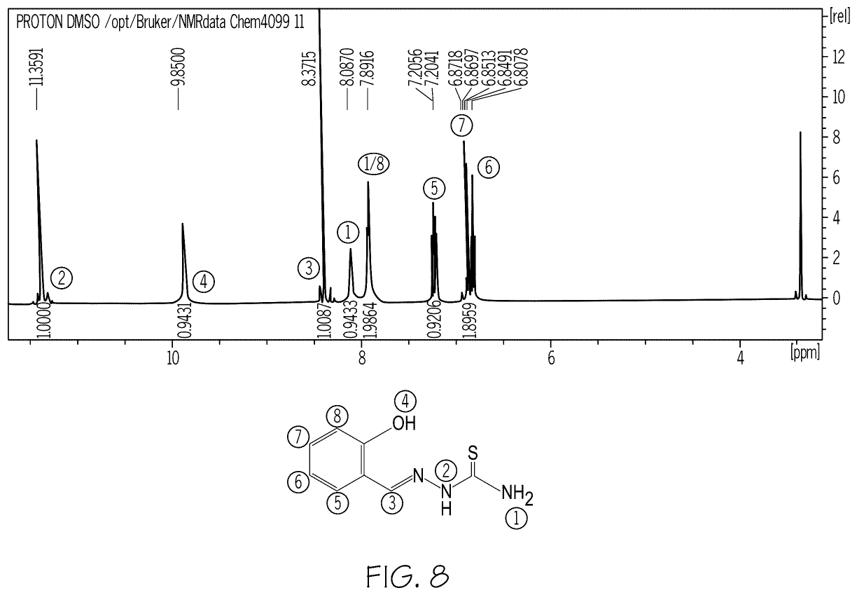

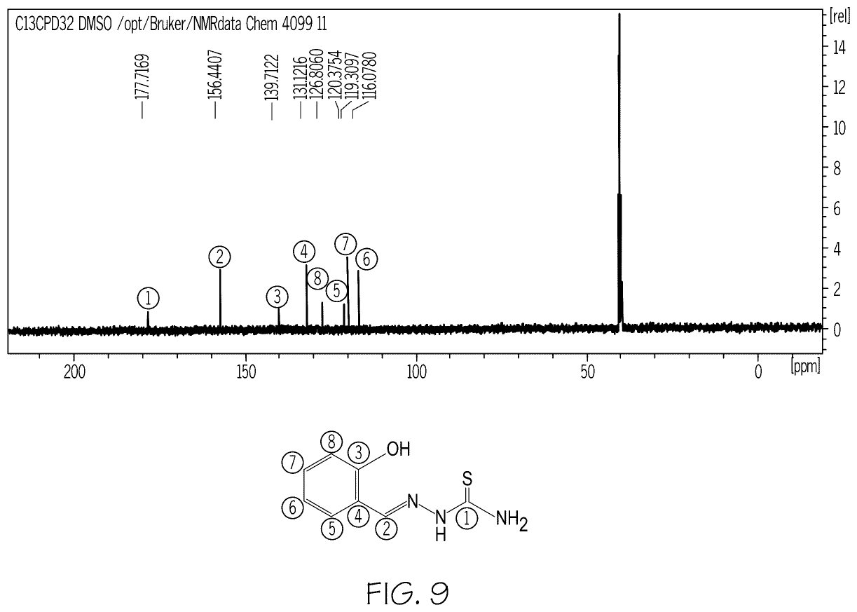

From FIG. 7, once again the absence of the aldehyde v(C—O) at 1658 cm₋₁ and the appearance of the absorption bands at 1580-1610 cm₋₁ were attributed to the v(C═N) stretching vibrations from the imine group confirmed the formation of the proposed Schiff base. The absorption in the ranges of 3000-3450 cm₋₁ were assigned to the v(NH₂) and v(NH) vibrations. The 1H NMR is shown on FIG. 8 and the 13C NMR on FIG. 9. Both NMR spectra has expected absorption bands as confirmed by modeling software. Spectra suggested a pure product.

### Synthesis of Thiosemicarbazone of 2-Pyridine Carboxyaldehyde

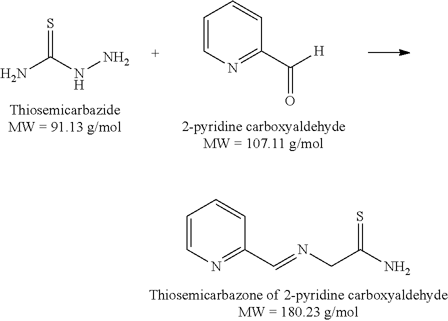 [SMILES: NNC(N)=S ; O=Cc1ccccn1 ; NC(=S)C/N=C/c1ccccn1]

TABLE 8

| | | | Molecular | Number | Actual mass |
|---|---|---|---|---|---|
| Chemical | CAS # | Supplier (Lot#) | weight (g/mol) | of moles | or volume |
| 2-pyridine | 1121-60-4 | Thermofisher | 107.11 | 0.2 | 21.422 g |
| carboxyaldehyde | | Scientific | | | |
| | | (A0436189) | | | |
| Thiosemicarbazide | 79-19-6 | Alfa Aesar | 91.13 | 0.2 | 18.226 g |
| | | (S09D016) | | | |
| 35% HCl | 7647-01-0 | Thermofisher | 36.45 | .02 | 2.154 mL |
| | | Scientific | | | |
| | | (A4119120) | | | |

A solution of thiosemicarbazide in 270 mL of DI-water was refluxed with stirring at 149° F. until the thiosemicarbazide was completed dissolved. A solution of 2.15 mL of HCl in 30 mL of water was then added drop wise. Next a solution of 2-pyridine carboxyaldehyde in 265 mL of ethanol was slowly added to the flask over a period of 30 minutes and the solution temperature was raised to 172.4° F. The addition of 2-pyridine carboxyaldehyde caused precipitation of the yellow colored thiosemicarbazone. The solution was refluxed at 172.4° F. for 3 hr and left stirring overnight without heating. The yellow thiosemicarbazone precipitate was then washed with 2000 mL of di-water and dried overnight in an oven at 60° C. Yield=98.4%.

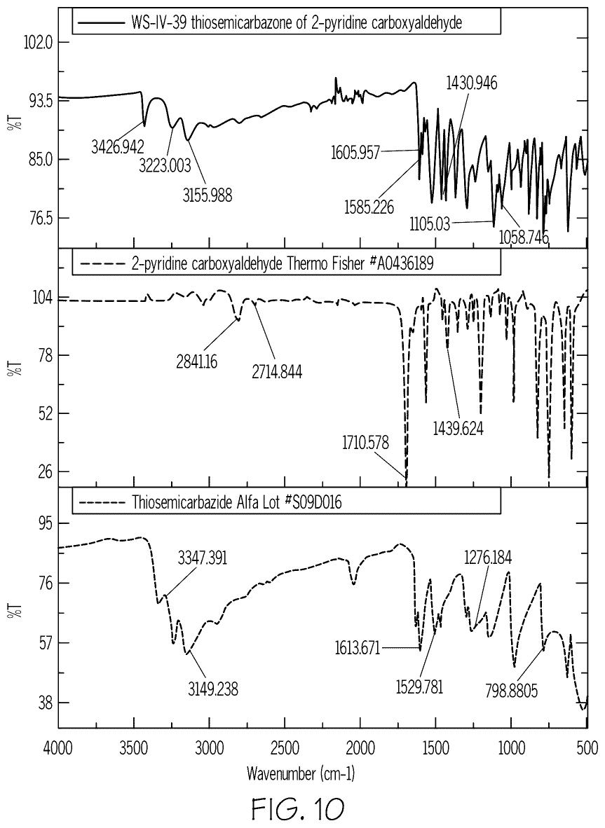

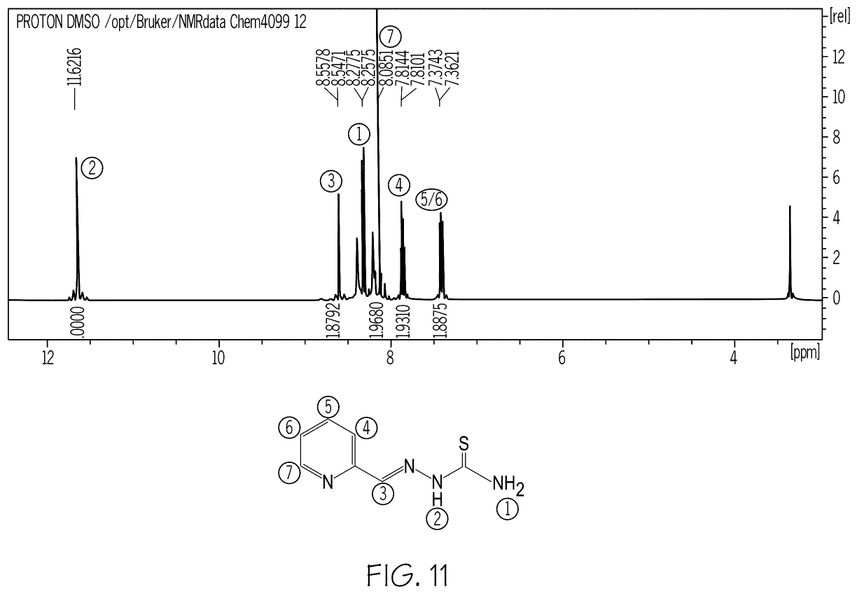

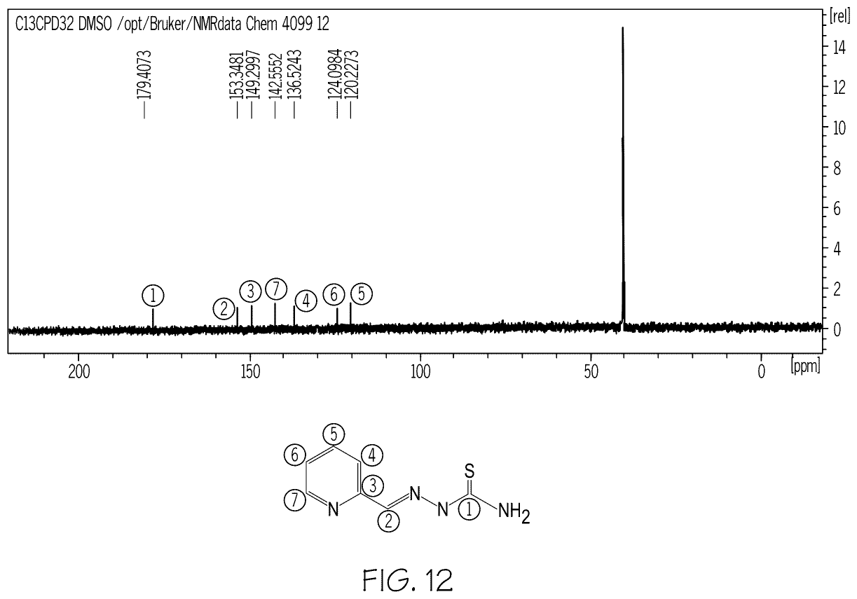

From FIG. 10, the absence of the aldehyde v(C═O) at 1710 cm₋₁ and the appearance of the absorption bands at 1580-1610 cm₋₁ were attributed to the v(C═N) stretching vibrations from the imine group confirmed the formation of the proposed Schiff base. The absorption in the ranges of 3000-3450 cm₋₁ were assigned to the v(NH₂) and v(NH) vibrations. The 1H NMR is shown on FIG. 11 and the 13C NMR on FIG. 12. Both NMR spectra has expected absorption bands as confirmed by modeling software. Spectra suggested a pure product.

### Synthesis of Thiosemicarbazone of 8-hydroxyquinoline-2-carboxyaldehyde

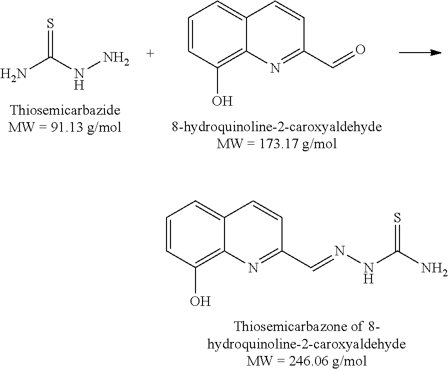 [SMILES: NNC(N)=S ; O=Cc1ccc2cccc(O)c2n1 ; NC(=S)N/N=C/c1ccc2cccc(O)c2n1]

TABLE 9

| | | | Molecular | Number | Actual mass |
|---|---|---|---|---|---|
| Chemical | CAS # | Supplier (Lot#) | weight (g/mol) | of moles | or volume |
| 8-hydroxyquinoline- | 14510-06-6 | Acros Organics | 173.17 | 0.058 | 10.0 g |
| 2- carboxyaldehyde | | (A0428171) | | | |
| Thiosemicarbazide | 79-19-6 | Alfa Aesar | 91.13 | 0.058 | 5.285 g |
| | | (S09D016) | | | |
| 35% HCl | 7647-01-0 | Thermofisher | 36.45 | 0.0058 | 0.504 mL |
| | | Scientific | | | |
| | | (A4119120) | | | |

A solution of thiosemicarbazide in 200 mL of DI-water was refluxed with stirring at 149° F. until the thiosemicarbazide was completed dissolved. A solution of 0.504 mL of HCl in 9 mL of water was then added drop wise. Next a solution of salicylaldehyde in 155 mL of ethanol was slowly added to the flask over a period of 30 minutes and the solution temperature was raised to 172.4° F. The addition of 8hydroxyquinoline-2-carboxyaldehyde caused precipitation of the white thiosemicarbazone. The solution was refluxed at 172.4° F. for 3 hr and left stirring overnight without heating. The white thiosemicarbazone precipitate was then washed with 2000 mL of di-water and dried overnight in an oven at 60° C. Yield=96.4%.

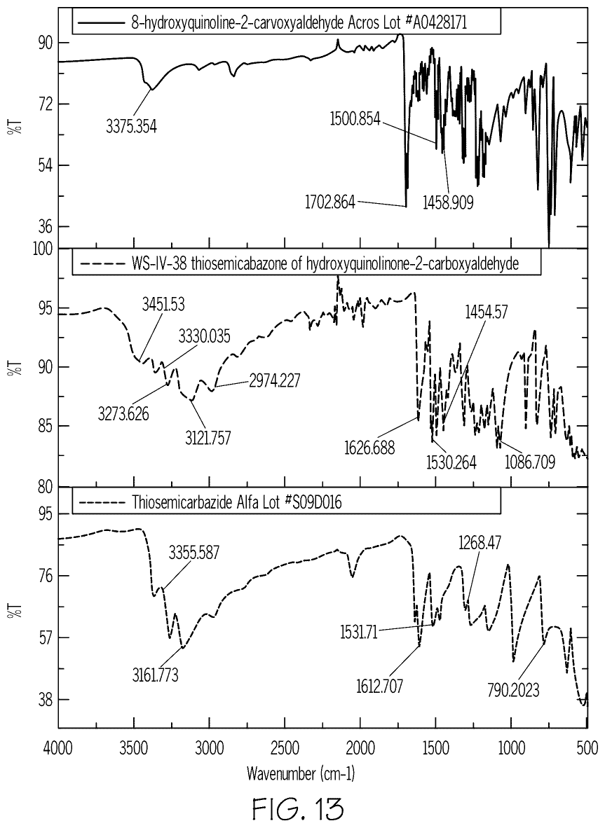

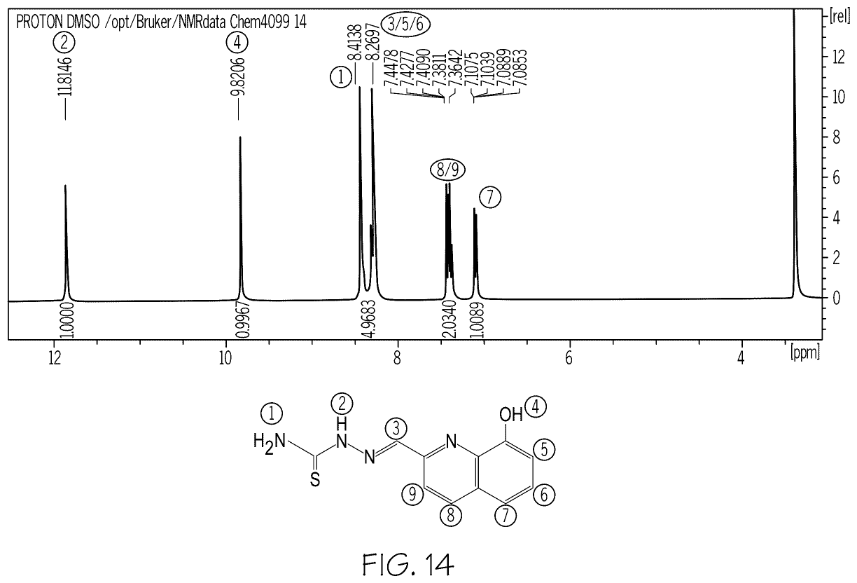

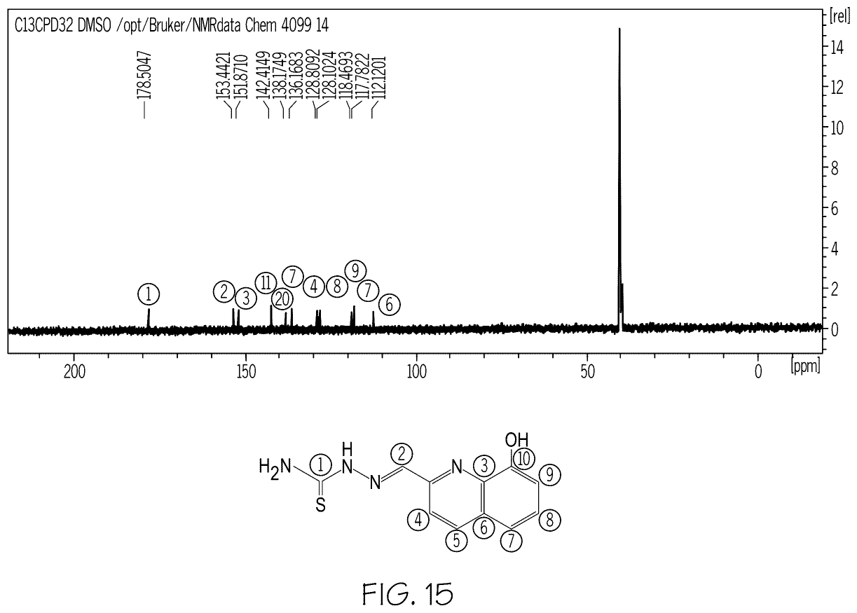

From FIG. 13, the absence of the aldehyde v(C═O) at 1702 cm₋₁ and the appearance of the absorption bands at 1628 cm₋₁ were attributed to the v(C═N) stretching vibrations from the imine group confirmed the formation of the proposed Schiff base. The absorption in the ranges of 3000-3450 cm₋₁ were assigned to the v(NH₂) and v(NH) vibrations. The 1H NMR is shown on FIG. 14 and the 13C NMR on FIG. 15. Both NMR spectra has expected absorption bands as confirmed by modeling software. Spectra suggested a pure product.

### Synthesis of 4-phenyl 3-Thiosemicarbazone of Isophthalaldehyde

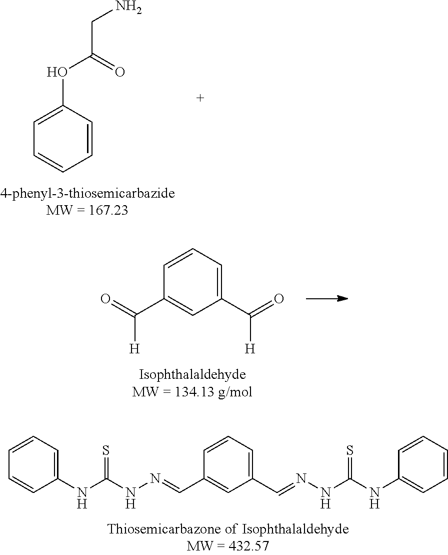 [SMILES: NCC(=O)Oc1ccccc1 ; O=Cc1cccc(C=O)c1 ; S=C(N/N=C/c1cccc(/C=N/NC(=S)Nc2ccccc2)c1)Nc1ccccc1]

TABLE 10

| | | | Molecular | Number | Actual mass |
|---|---|---|---|---|---|
| Chemical | CAS # | Supplier (Lot#) | weight (g/mol) | of moles | or volume |
| Isophthalaldehyde | 626-19-7 | Thermofisher | 134.13 | 0.1 | 13.413 g |
| | | Scientific | | | |
| | | (5003J16S) | | | |
| 4-phenyl-3- | 5351-69-9 | TCI America | 167.23 | 0.2 | 33.505 g |
| Thiosemicarbazide | | (FCX01-PTDT) | | | |
| 35% HCl | 7647-01-0 | Thermofisher | 36.45 | 0.02 | 2.154 mL |
| | | Scientific | | | |
| | | (A4119120) | | | |

A solution of 4-phenyl-3-thiosemicarbazide in 500 mL of ethanol was refluxed with stirring at 172° F. until the 4-phenyl-3-thiosemicarbazide was completed dissolved. A solution of 2.15 mL of HCl in 30 mL of water was then added drop wise. Next a solution of isophthalaldehyde in 270 mL of ethanol was slowly added to the flask over a period of 30 min. The addition of isophthalaldehyde caused precipitation of the light green colored thiosemicarbazone. The solution was refluxed at 172.4° F. for 3 hr and left stirring overnight without heating. The light green colored thiosemicarbazone precipitate was then washed with 2000 mL of ethanol and dried overnight in an oven at 60° C. Yield=98.3%.

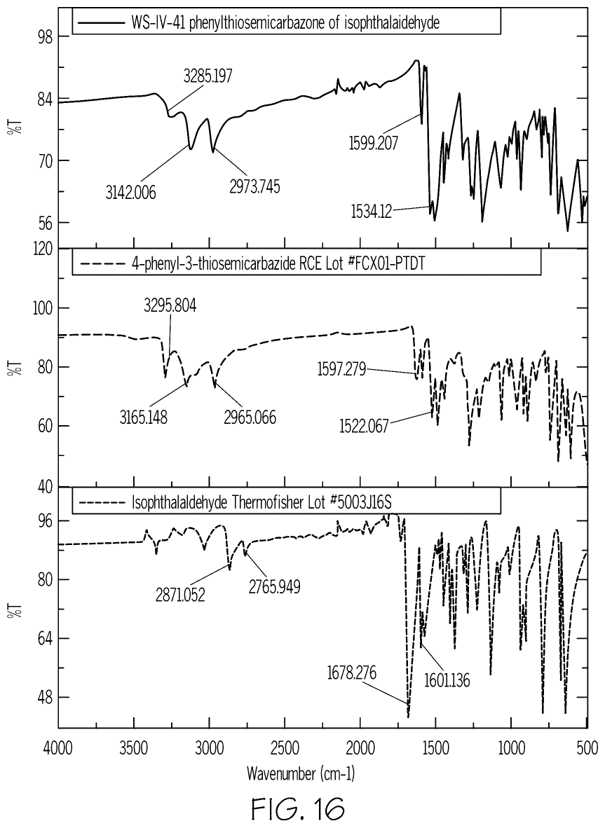

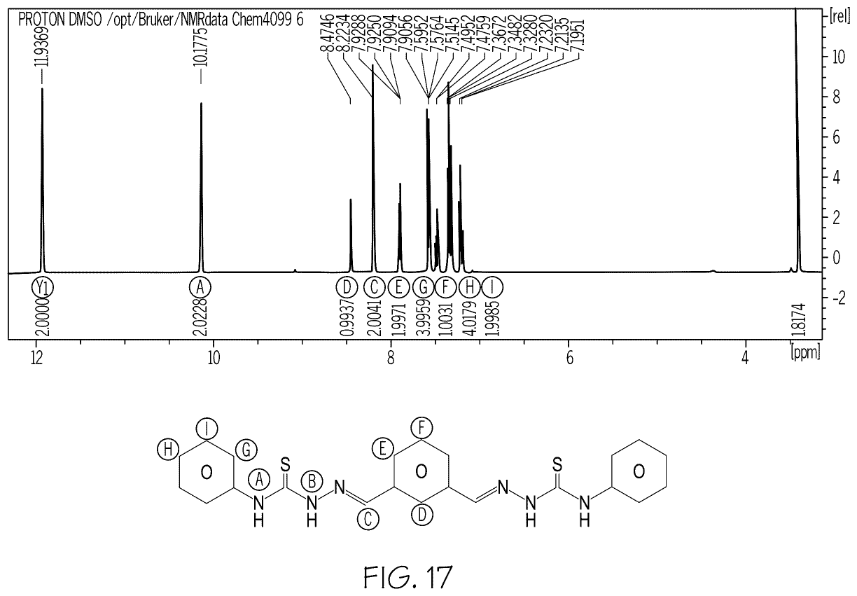

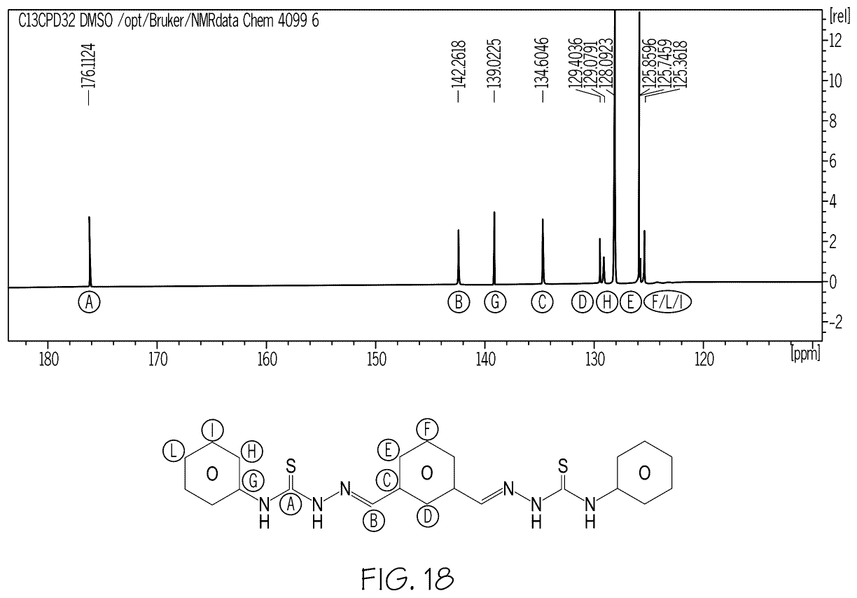

From FIG. 16, the absence of the aldehyde v(C═O) at 1678 cm₋₁ and the appearance of the absorption bands from 1500-1600 cm₋₁ were attributed to the v(C═N) stretching vibrations from the imine group confirmed the formation of the proposed Schiff base. The absorption in the ranges of 3000-3450 cm₋₁ were assigned to the v(NH₂) and v(NH) vibrations. The 1H NMR is shown on FIG. 17 and the 13C NMR on FIG. 18. Both NMR spectra has expected absorption bands as confirmed by modeling software. Spectra suggested a pure product.

### Synthesis of 4-Phenyl-3-Thiosemicarbazone of Pentan-2,4-dione

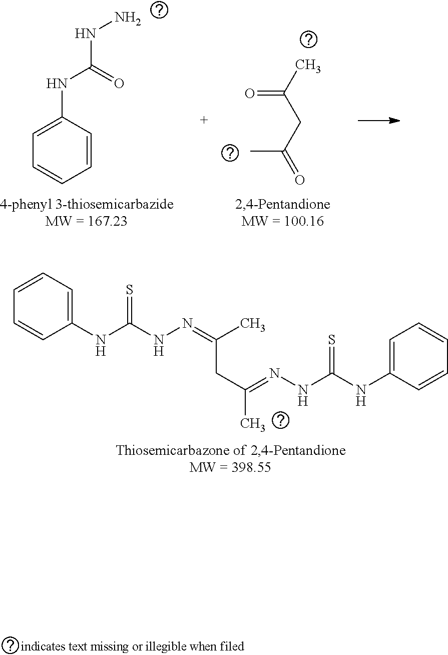

TABLE 11

| | | | Molecular | Number | Actual mass |
|---|---|---|---|---|---|
| Chemical | CAS # | Supplier (Lot#) | weight (g/mol) | of moles | or volume |
| Pentane-2,4-dione | 123-54-6 | Alfa Aesar | 100.17 | 0.1 | 10.016 g |
| | | (U07G032) | | | |
| 4-phenyl-3- | 5351-69-9 | TCI America | 167.23 | 0.2 | 33.970 g |
| Thiosemicarbazide | | (FCX01PTDT) | | | |
| 35% HCl | 7647-01-0 | Thermofisher | 36.45 | .02 | 2.154 mL |
| | | Scientific | | | |
| | | (A4119120) | | | |

A solution of 4-phenyl-3-thiosemicarbazide in 400 mL of ethanol was refluxed with stirring at 172° F. until the 4-phenyl-3-thiosemicarbazide was completed dissolved. A solution of 2.15 mL of HCl in 30 mL of water was then added drop wise. Next a solution of pentane-2,4-dione in 200 mL of ethanol was slowly added to the flask over a period of 30 min. The addition of pentane-2,4-dione caused precipitation of the white thiosemicarbazone. The solution was refluxed at 172.4° F. for 3 hr and left stirring overnight without heating. The white thiosemicarbazone precipitate was then washed with 2000 mL of ethanol and dried overnight in an oven at 60° C. Yield=68.1%.

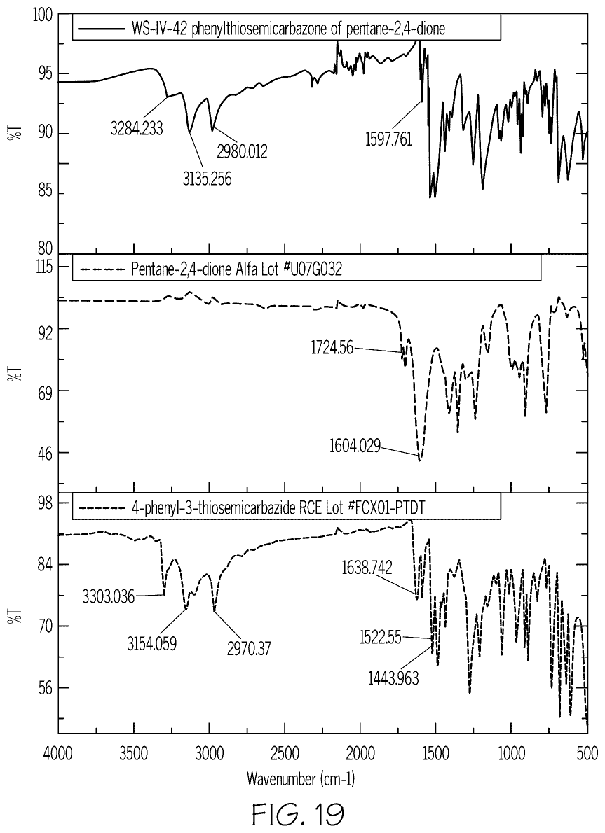

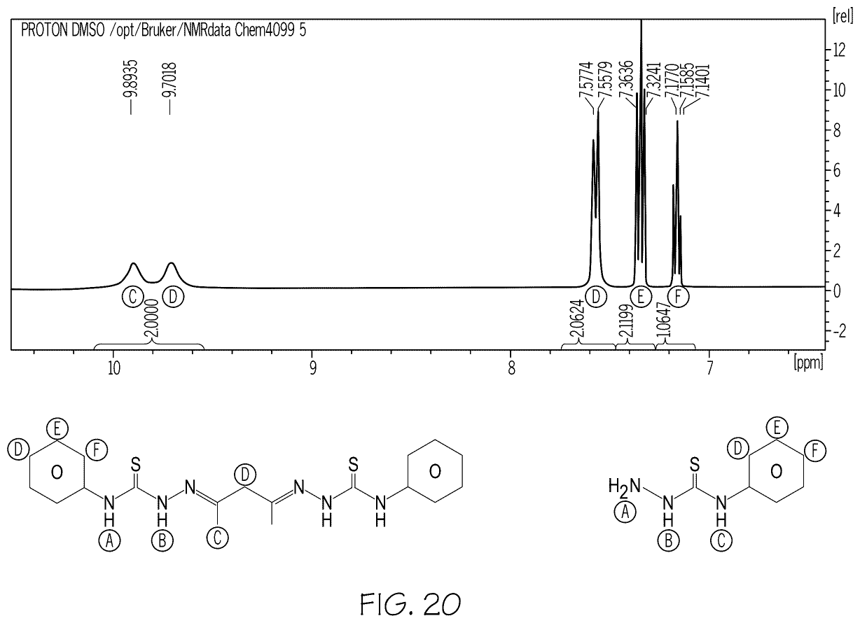

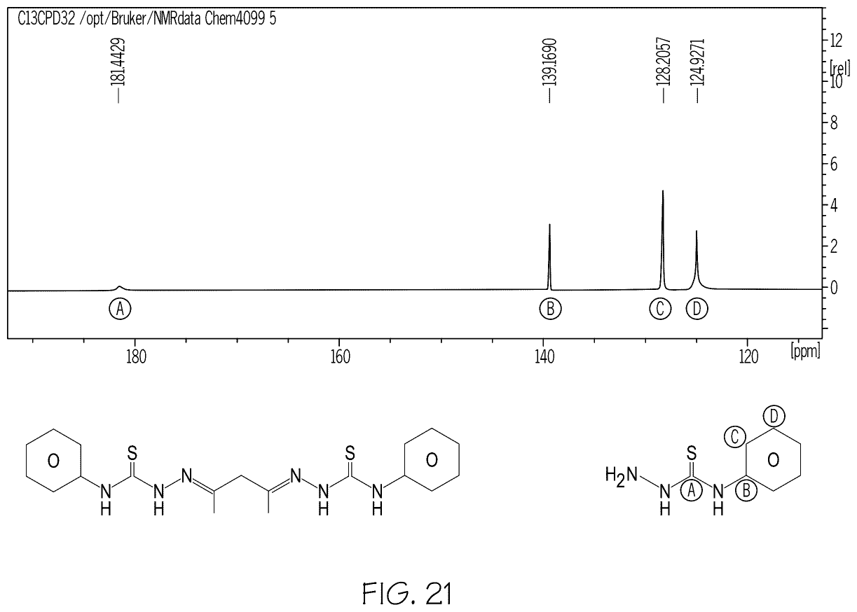

From FIG. 19, the absence of the aldehyde v(C═O) at 1604 cm₋₁ and the appearance of the absorption bands from 1597 cm₋₁ were attributed to the v(C═N) stretching vibrations from the imine group suggested the formation of the proposed Schiff base. The absorption in the ranges of 3000-3450 cm₋₁ were assigned to the v(NH₂) and v(NH) vibrations. FTIR also suggest incomplete reaction with reaction product consisted of a combination of SB and unreacted reactants. The 1H NMR is shown on FIG. 20 and the 13C NMR on FIG. 21. NMR analysis suggested that the expected reaction product did not form and the product included unreacted 4phenyl thiosemicarbazide.

### Synthesis of Thiosemicarbazone of Mesityl Oxide

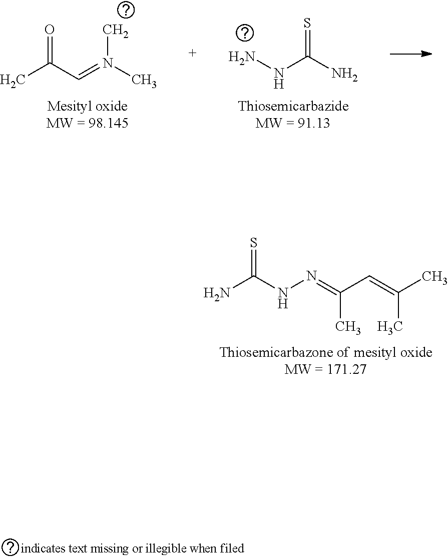

TABLE 12

| | | | Molecular | Number | Actual mass |
|---|---|---|---|---|---|
| Chemical | CAS # | Supplier (Lot#) | weight (g/mol) | of moles | or volume |
| Mesityl oxide | 141-79-7 | Acros Organics | 98.145 | 0.2 | 21.185 |
| | | (A0427844) | | | |
| Thiosemicarbazide | 79-19-6 | Alfa Aesar | 91.13 | 0.2 | 19.664 |
| | | (S09D016) | | | |
| 35% HCl | 7647-01-0 | Thermofisher | 36.45 | 0.02 | 2.17 mL |
| | | Scientific | | | |
| | | (A4119120) | | | |

A solution of thiosemicarbazide in 250 mL of MilliQ water was refluxed with stirring at 172° F. until the thiosemicarbazide was completed dissolved. A solution of 2.17 mL of HCl in 30 mL of water was then added drop wise. Next a solution of mesityl oxide in 160 mL of water was slowly added to the flask over a period of 30 min. The addition of mesityl oxide caused resulted in a clear light yellow colored solution. The solution was refluxed at 172.4° F. for 3 hr and left stirring overnight without heating. The next day, there was still no precipitate in the reaction flask, as a result, the solution mixture was rotovaped to isolate a sticky honey like thick mixture. This mixture was dried overnight in an oven at 90° C. Yield=94.2%.

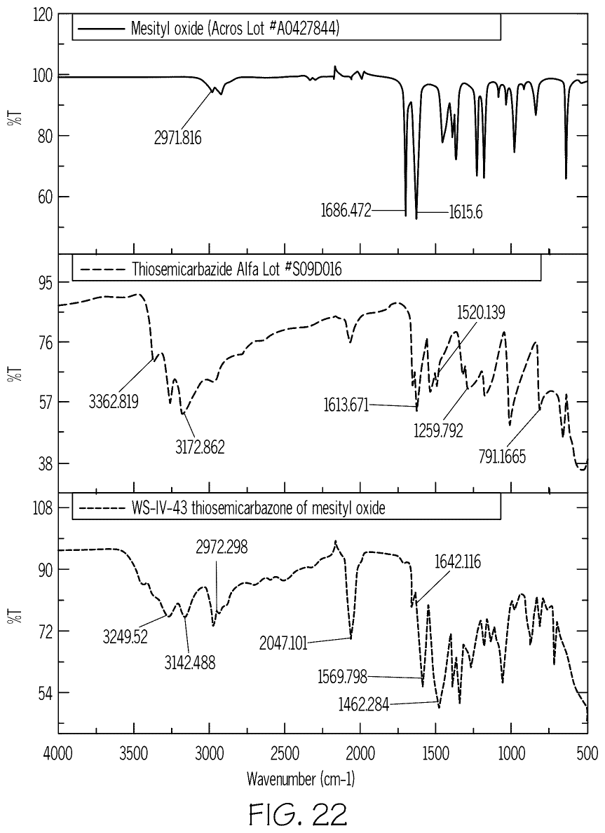

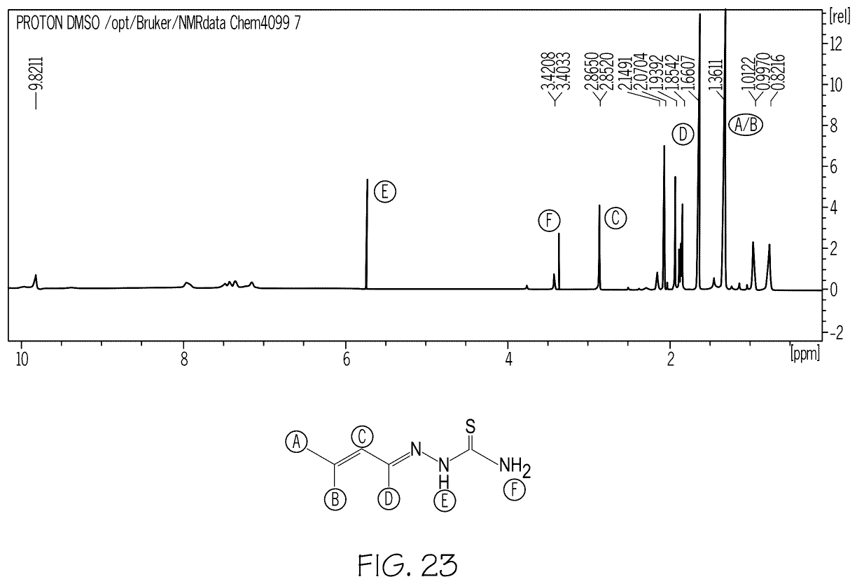

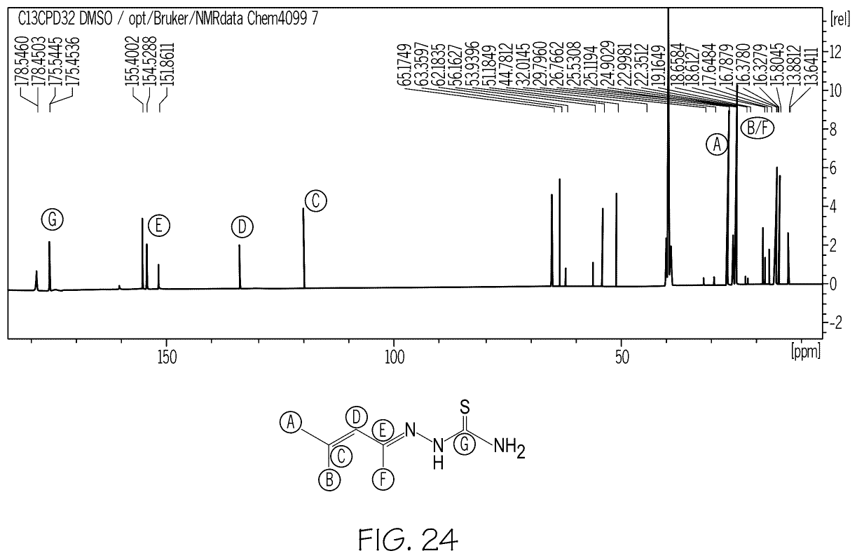

From FIG. 22 the absence of the aldehyde v(C═O) at 1686 cm₋₁ and the appearance of the strong absorption bands at 1569 cm₋₁ were attributed to the v(C═N) stretching vibrations from the imine group confirmed the formation of the proposed Schiff base. The absorption in the ranges of 3000-3450 cm₋₁ were assigned to the v(NH₂) and v(NH) vibrations. The 1H NMR is shown on FIG. 23 and the 13C NMR on FIG. 24. NMR analysis showed that the expected reaction product did not form, instead the reaction product consisted of a combination of unreacted reactants, leftover solvent and other impurities. The peaks of the desired products were inserted and labelled as missing.

### Synthesis of Thiosemicarbazone of Terephthalaldehyde

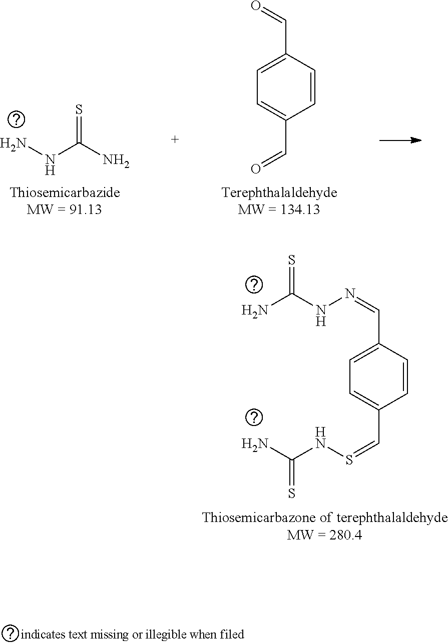

TABLE 13

| | | | Molecular | Number | Actual mass |
|---|---|---|---|---|---|
| Chemical | CAS # | Supplier (Lot#) | weight (g/mol) | of moles | or volume |
| Terephthalaldehyde | 623-27-8 | Alfa Aesar | 134.13 | 0.1 | 13.489 g |
| | | (10222547) | | | |
| Thiosemicarbazide | 79-19-6 | Alfa Aesar | 91.13 | 0.2 | 18.227 g |
| | | (S09D016) | | | |
| 35% HCl | 7647-01-0 | Thermofisher | 36.45 | .02 | 2.154 mL |
| | | Scientific | | | |
| | | (A4119120) | | | |

A solution of thiosemicarbazide in 270 mL of water was refluxed with stirring at 172° F. until it was completed dissolved. A solution of 2.15 mL of HCl in 30 mL of water was then added drop wise. Next a solution of terephthalaldehyde in 200 mL of ethanol was slowly added to the flask over a period of 30 min. The addition of terephthalaldehyde caused precipitation of the pale yellow colored thiosemicarbazone. The solution was refluxed at 172.4° F. for 3 hr and left stirring overnight without heating. The cream colored thiosemicarbazone precipitate was then washed with 2000 mL of ethanol and dried overnight in an oven at 90° C. Yield=93.2%.

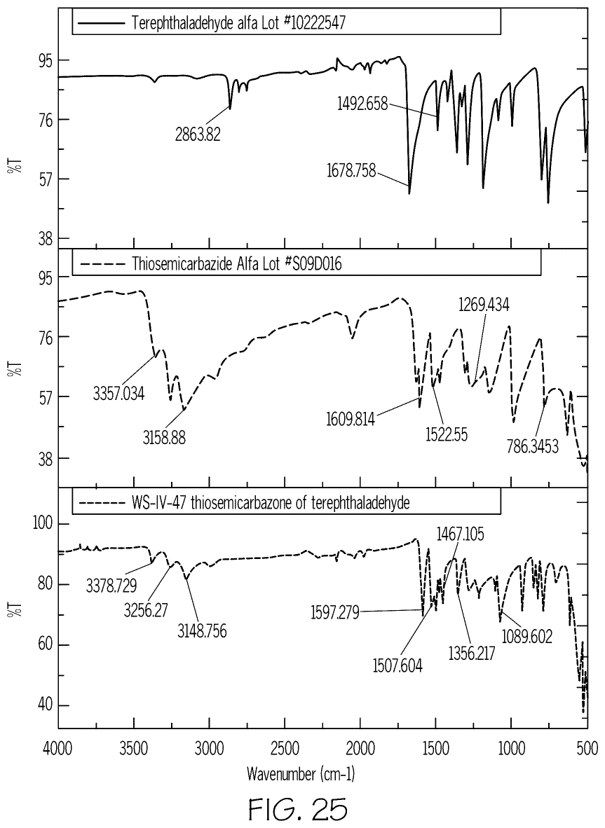

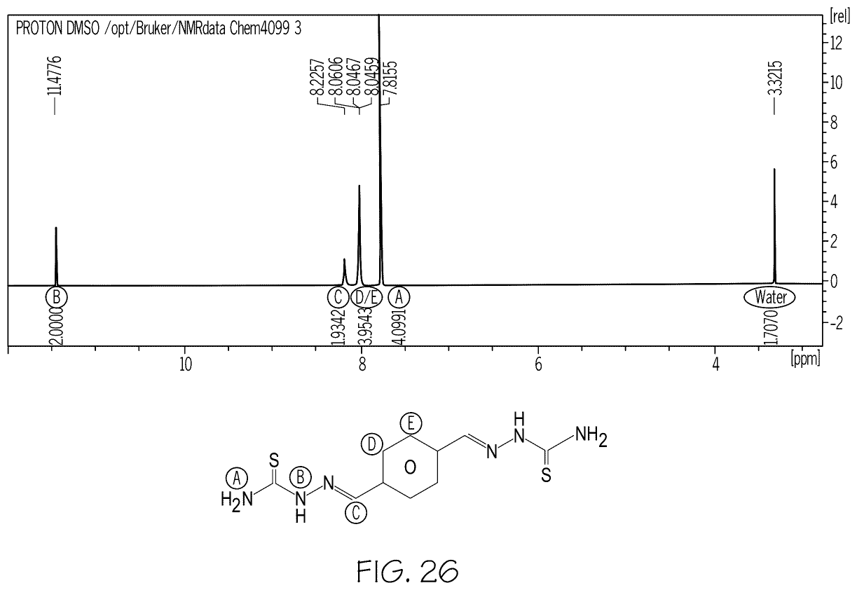

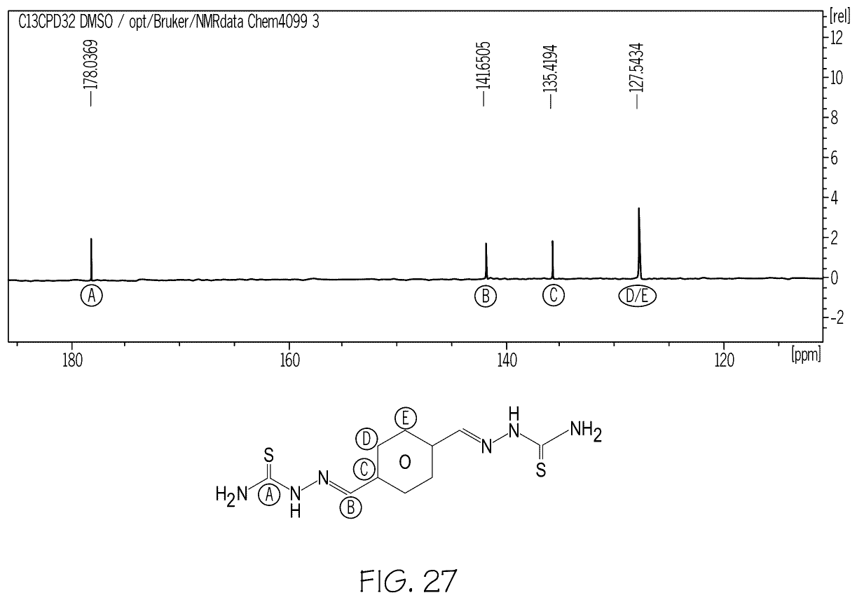

From FIG. 25, the absence of the aldehyde v(C═O) at 1678 cm₋₁ and the appearance of the absorption bands from 1597 cm₋₁ were attributed to the v(C═N) stretching vibrations from the imine group confirmed the formation of the proposed Schiff base. The absorption in the ranges of 3000-3450 cm₋₁ were assigned to the v(NH₂) and v(NH) vibrations. The 1H NMR is shown on FIG. 26 and the 13C NMR on FIG. 27. Both NMR spectra has expected absorption bands as confirmed by modeling software. Spectra suggested a pure product.

### Synthesis of 4-Ethyl-3-Thiosemicarbazone of Isophthalaldehyde

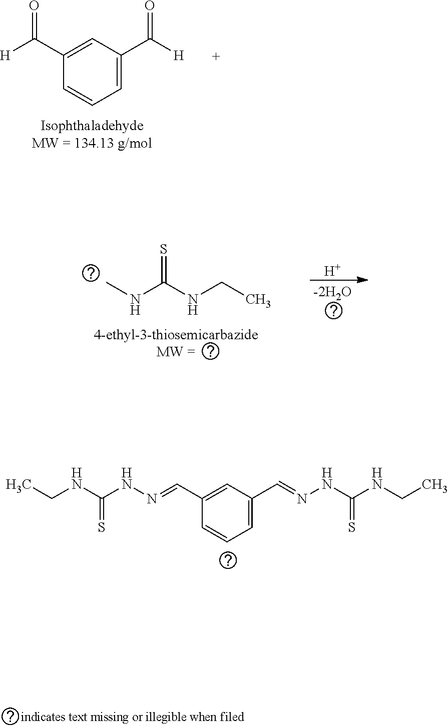

TABLE 14

| | | | Molecular | Number | Actual mass |
|---|---|---|---|---|---|
| Chemical | CAS # | Supplier (Lot#) | weight (g/mol) | of moles | or volume |
| Isophthalaldehyde | 626-19-7 | Thermofisher | 134.13 | 0.1 | 11.955 g |
| | | Scientific | | | |
| | | (5003J16S) | | | |
| 4-ethyl-3- | 13431-34-0 | Alfa Aesar | 91.13 | 0.178 | 21.243 g |
| Thiosemicarbazide | | (S09D016) | | | |
| 35% HCl | 7647-01-0 | Thermofisher | 36.45 | .02 | 2.154 mL |
| | | Scientific | | | |
| | | (A4119120) | | | |

A solution of 4-ethyl-3-thiosemicarbazide in 310 mL of ethanol was refluxed with stirring at 172° F. until it was completed dissolved. A solution of 2.15 mL of HCl in 30 mL of water was then added drop wise. Next a solution of isophthalaldehyde in 200 mL of ethanol was slowly added to the flask over a period of 30. The addition of isophthalaldehyde caused precipitation of the white thiosemicarbazone. The solution was refluxed at 172.4° F. for 3 hr and left stirring overnight without heating. The white thiosemicarbazone precipitate was then washed with 2000 mL of ethanol and dried overnight in an oven at 90° C. Yield=92.4%.

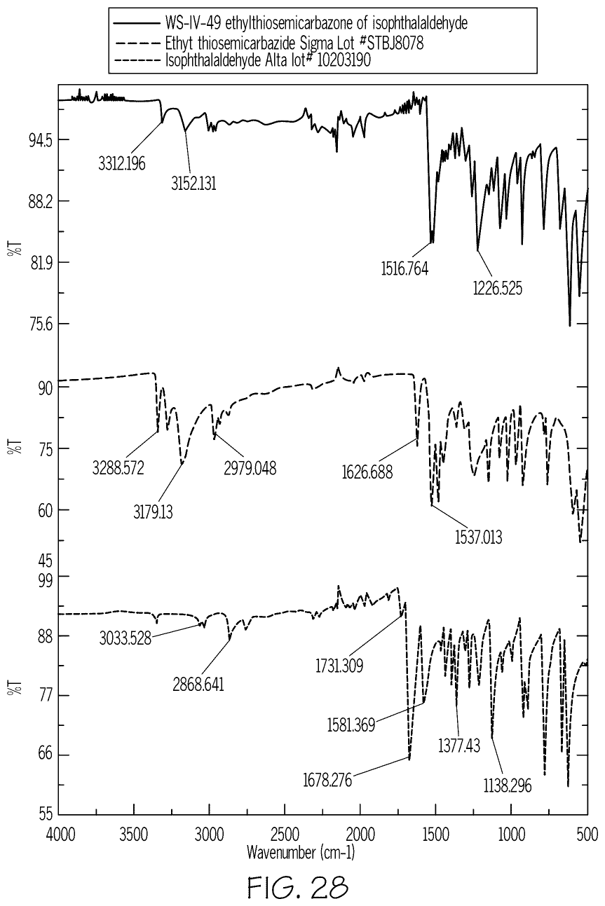

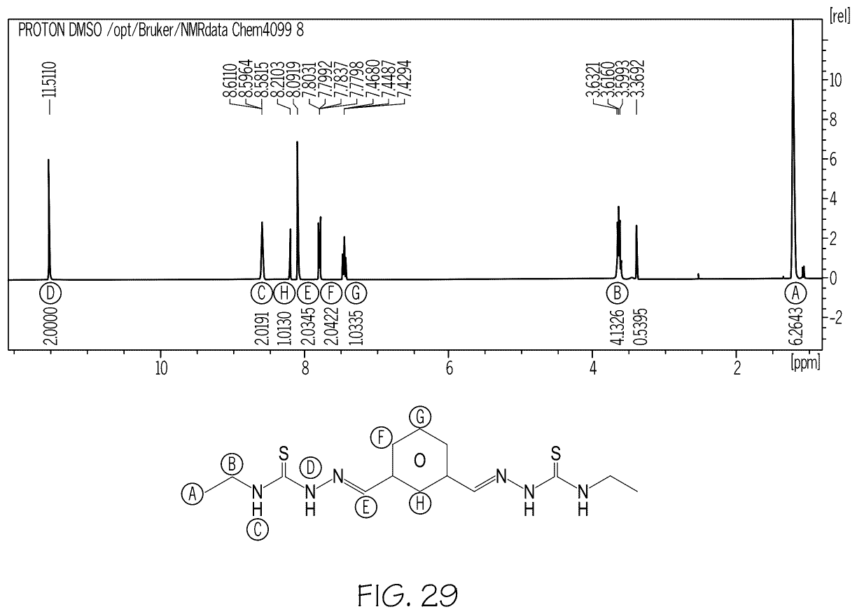

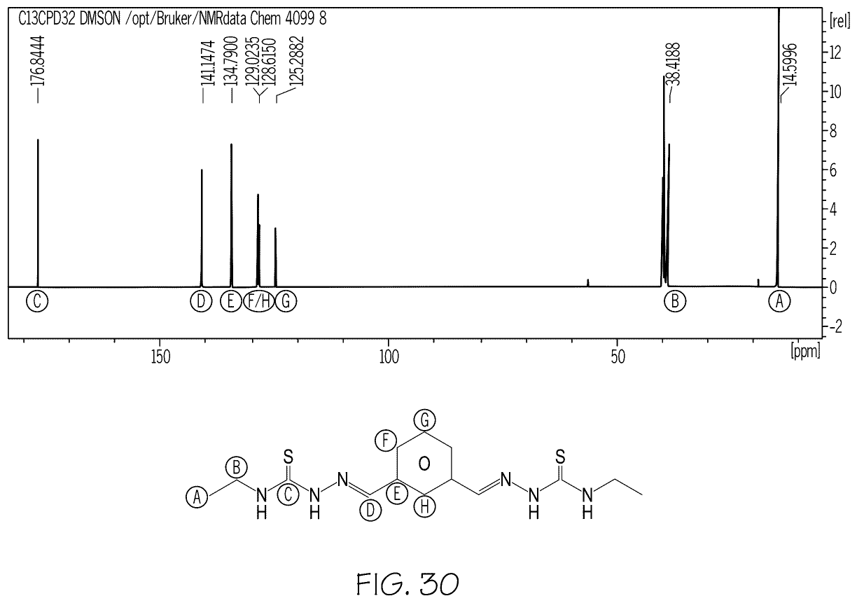

From FIG. 28, the absence of the aldehyde v(C—O) at 1678 cm−1 and the appearance of the absorption bands from 1516 cm₋₁ were attributed to the v(C═N) stretching vibrations from the imine group confirmed the formation of the proposed Schiff base. The absorption in the ranges of 3000-3450 cm₋₁ were assigned to the v(NH₂) and v(NH) vibrations. v(C—H) stretching observed between 29003000 cm−1. The 1H NMR is shown on FIG. 29 and the 13C NMR on FIG. 30. Both NMR spectra has expected absorption bands as confirmed by modeling software. Spectra suggested a pure product.

### Synthesis of Thiosemicarbazone of Pentan-2,4-dione

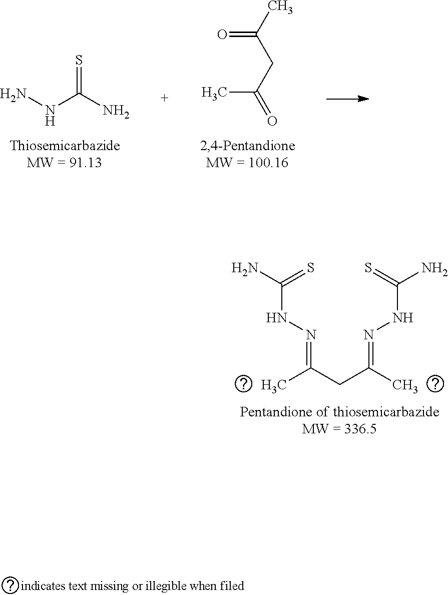

TABLE 15

| | | | Molecular | Number | Actual mass |
|---|---|---|---|---|---|
| Chemical | CAS # | Supplier (Lot#) | weight (g/mol) | of moles | or volume |
| Pentane-2,4-dione | 123-54-6 | Alfa Aesar Lot | 100.17 | 0.1 | 10.016 g |
| | | #U07G032 | | | |
| Thiosemicarbazide | 79-19-6 | Alfa Aesar | 91.13 | 0.2 | 18.227 g |
| | | (S09D016) | | | |
| 35% HCl | 7647-01-0 | Thermofisher | 36.45 | .02 | 2.154 mL |
| | | Scientific | | | |
| | | (A4119120) | | | |

A solution of thiosemicarbazide in 350 ml of water and 100 mL of isopropyl alcohol was refluxed with stirring at 172° F. until the it was completed dissolved. A solution of 2.15 mL of HCl in 30 mL of water was then added drop wise. Next a solution of pentane-2,4-dione in 100 mL of isopropyl alcohol was slowly added to the flask over a period of 30 min. The addition of pentane-2,4-dione caused solution to turn to a yellow color clear mixture. The solution was refluxed at 172.4° F. for 3 hr and left stirring overnight without heating. The mixture was then rotovaped to isolate the yellow thiosemicarbazone precipitate which was then dried overnight in an oven at 90° C. Yield=54.2%.

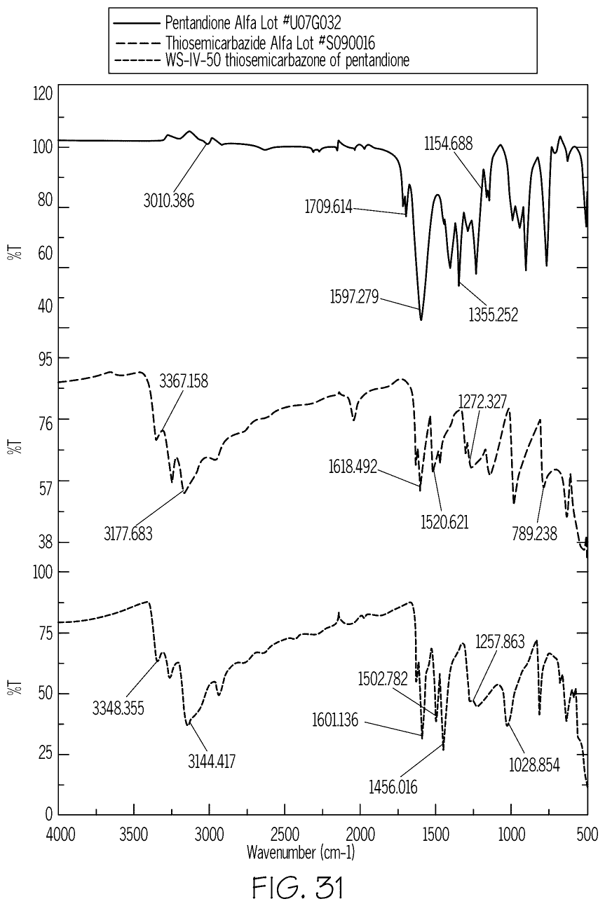

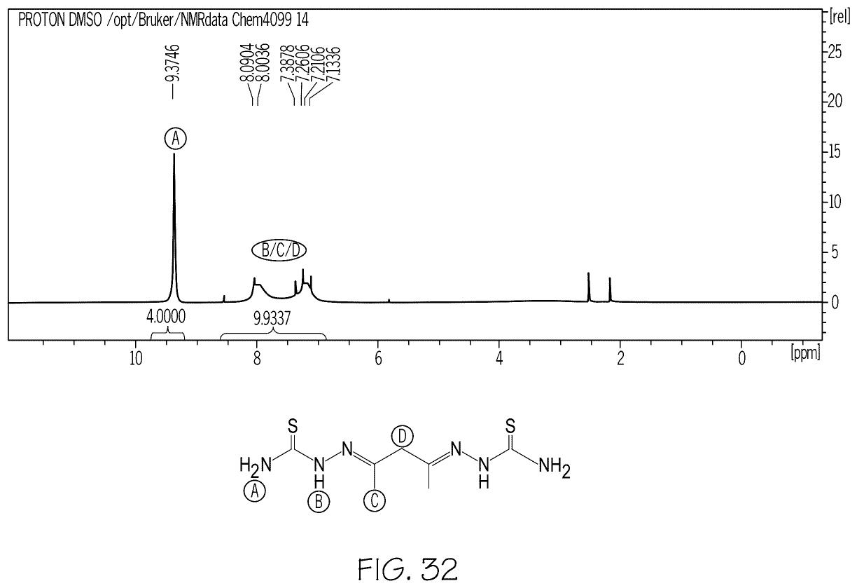

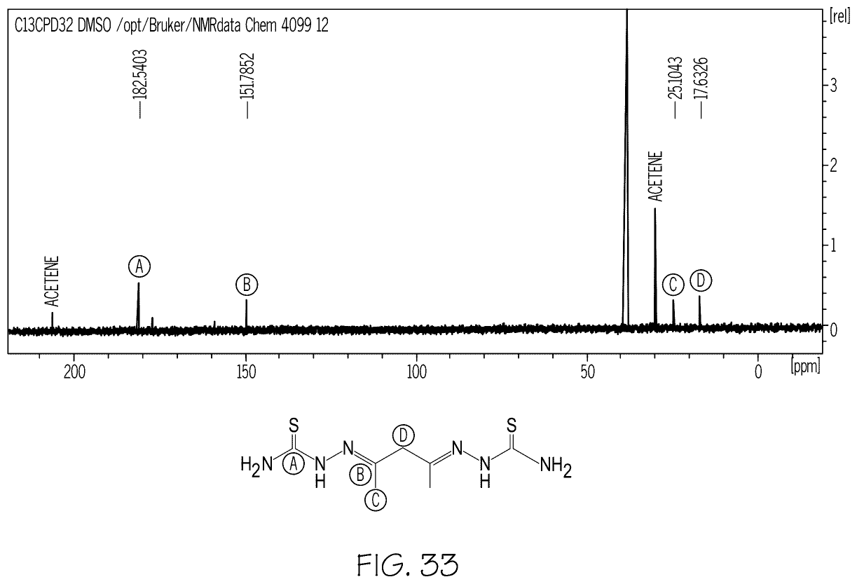

From FIG. 31, the absence of the aldehyde v(C═O) at 1709 cm₋₁ and the appearance of the absorption bands from 1601 cm₋₁ were attributed to the v(C═N) stretching vibrations from the imine group confirmed the formation of the proposed Schiff base. The absorption in the ranges of 3000-3450 cm₋₁ were assigned to the v(NH₂) and v(NH) vibrations. FTIR also suggest reaction product consisted of a combination of SB and unreacted reactants. The 1H NMR is shown on FIG. 32 and the 13C NMR on FIG. 33. 1H NMR analysis showed presence of extra bands, B, B′, D, D′ and 13 NMR showed extra bands, A, A′, B, B′ and D, D′. This suggested the product consisted of unreacted reactants and residual solvents.

### Synthesis of 4-methyl-Thiosemicarbazone of salicylaldehyde

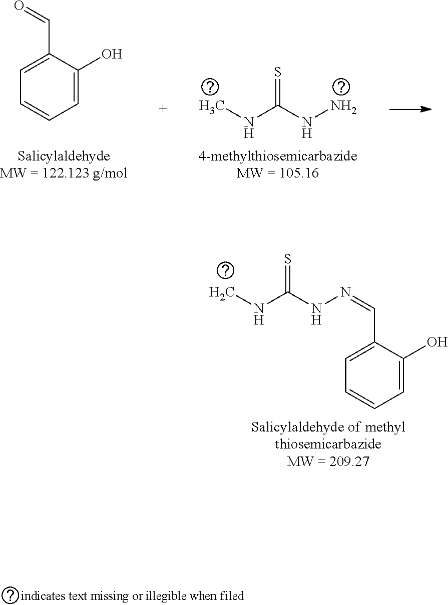

TABLE 16

| | | | Molecular | Number | Actual mass |
|---|---|---|---|---|---|
| Chemical | CAS # | Supplier (Lot#) | weight (g/mol) | of moles | or volume |
| Salicylaldehyde | 90.02-8 | Acros Organics | 122.12 | 0.1 | 12.277 g |
| | | (A042293949) | | | |
| 4-methyl | 6938-68-7 | TCI (MSF5F-HN) | 105.16 | 0.1 | 10.551 |
| thiosemicarbazide | | | | | |
| 35% HCl | 7647-01-0 | Thermofisher | 36.45 | .01 | 0.86 mL |
| | | Scientific | | | |
| | | (A4119120) | | | |

A solution of 4-methylthiosemicarbazide in 250 mL of ethanol and 50 ml of water was refluxed with stirring at 172° F. until the it was completed dissolved. A solution of 0.86 mL of HCl in 30 mL of ethanol was then added drop wise. Next a solution of salicylaldehyde in 250 mL of ethanol was slowly added to the flask over a period of 30 min. The addition of salicylaldehyde caused the solution to turn to a light green color, no precipitate was observed upon addition of the salicylaldehyde. The solution was refluxed at 172.4° F. for 3 hr and left stirring overnight without heating. The cream colored thiosemicarbazone precipitate isolated the next day which was then dried overnight in an oven at 90° C. Yield=68.8%.

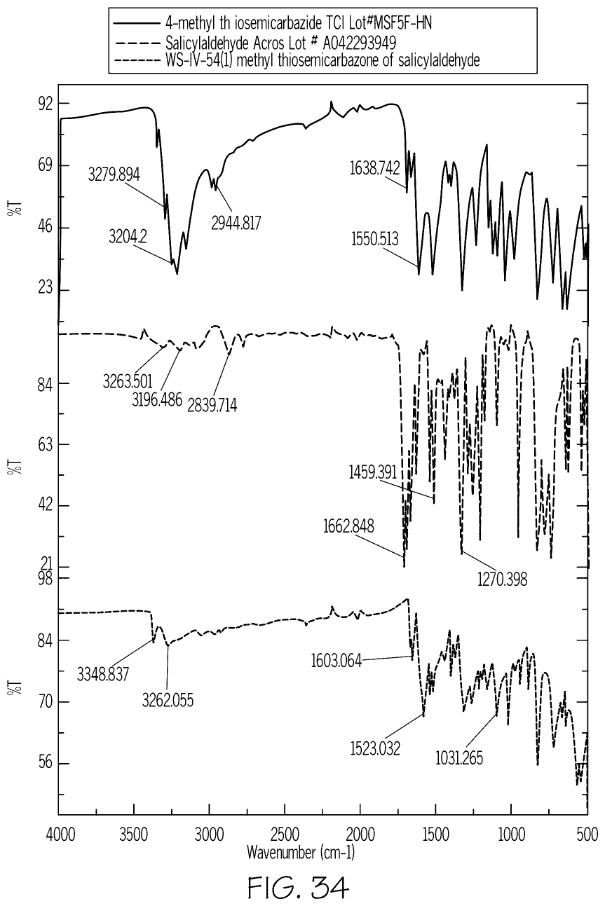

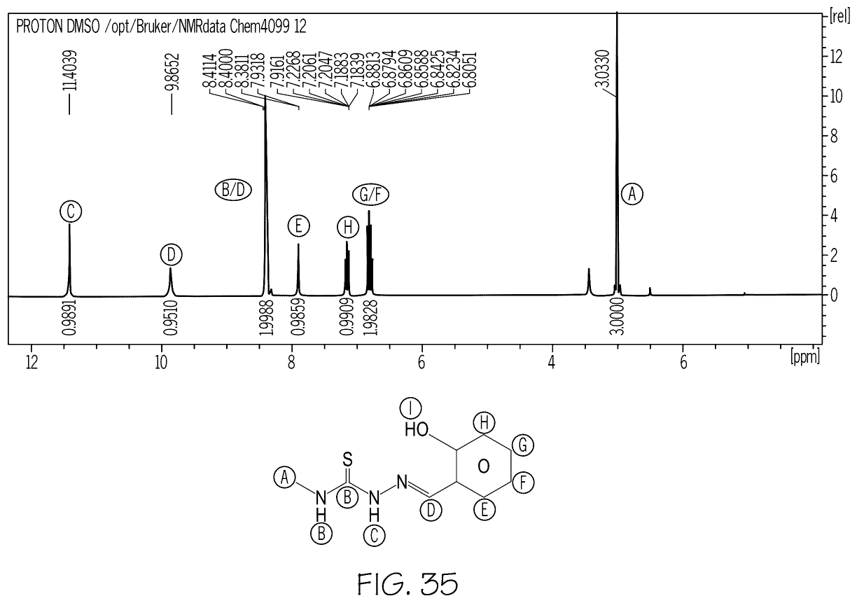

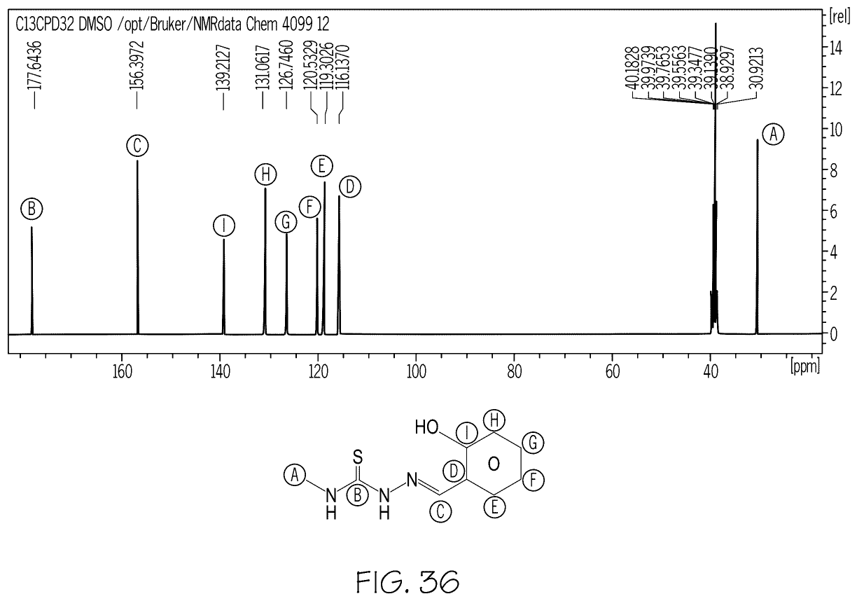

From FIG. 34, the absence of the aldehyde v(C═O) at 1662 cm₋₁ and the appearance of the absorption bands from 1523 cm₋₁ were attributed to the v(C═N) stretching vibrations from the imine group confirmed the formation of the proposed Schiff base. The absorption in the ranges of 3000-3450 cm₋₁ were assigned to the v(NH₂) and v(NH) vibrations. The 1H NMR is shown on FIG. 35 and the 13C NMR on FIG. 36. Both NMR spectra has expected absorption bands as confirmed by modeling software. Spectra suggested a pure product.

### Synthesis of 8-hydroxyquinoline-2-carboxyaldehyde of phenyl thiosemicarbazone

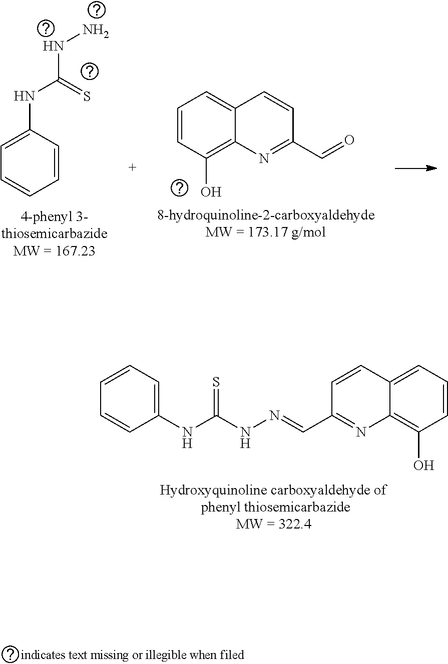 [SMILES: NNC(=S)Nc1ccccc1 ; O=Cc1ccc2cccc(O)c2n1 ; Oc1cccc2ccc(/C=N/NC(=S)Nc3ccccc3)nc12]

TABLE 17

| | | | Molecular | Number | Actual mass |
|---|---|---|---|---|---|
| Chemical | CAS # | Supplier (Lot#) | weight (g/mol) | of moles | or volume |
| 8hydroxyquinoline2- | 14510-06-6 | Acros Organics | 173.17 | 0.027 | 4.792 g |
| carboxyaldehyde | | (A0428171) | | | |
| 4-phenyl-3- | 5351-69-9 | TCI America | 167.23 | 0.027 | 4.668 g |
| Thiosemicarbazide | | (FCX01PTDT) | | | |
| 35% HCl | 7647-01-0 | Thermofisher | 36.45 | 0.0027 | 0.24 mL |
| | | Scientific | | | |
| | | (A4119120) | | | |

A solution of 4-phenyl-3-thiosemicarbazide in 250 mL of ethanol and 100 mL of water was refluxed with stirring at 172° F. until it was completed dissolved. A solution of HCl in 30 mL of ethanol was then added drop wise. Next a solution of hydroxyquinoline carboxyaldehyde in 100 mL of ethanol was slowly added to the flask over a period of 30 min. The addition of hydroxyquinoline carboxyaldehyde caused the solution to turn to a bright orange clear mixture. The solution was refluxed at 172.4° F. for 3 hr and left stirring overnight without heating. The light yellow colored thiosemicarbazone precipitate was isolated the next day and dried overnight in an oven at 60° C. Yield=69.3%.

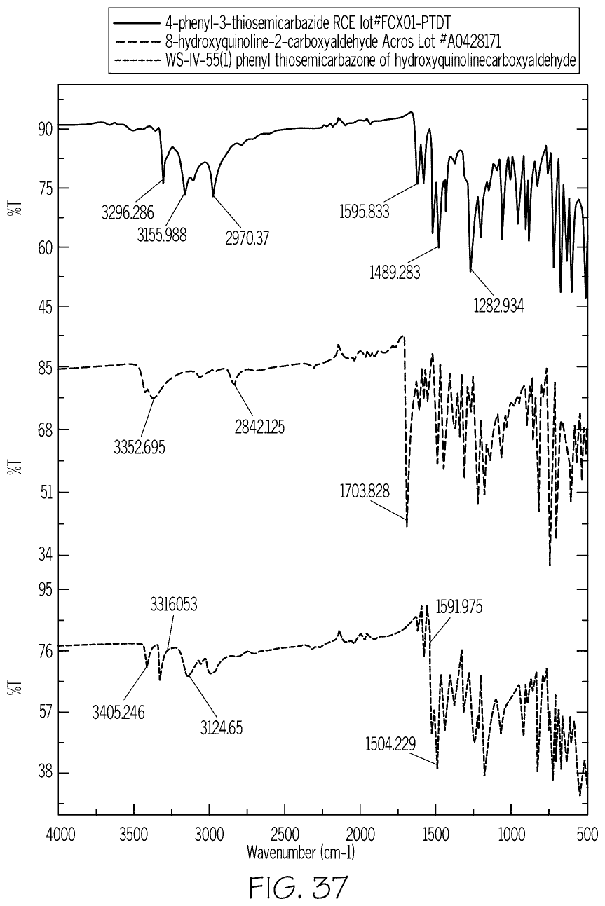

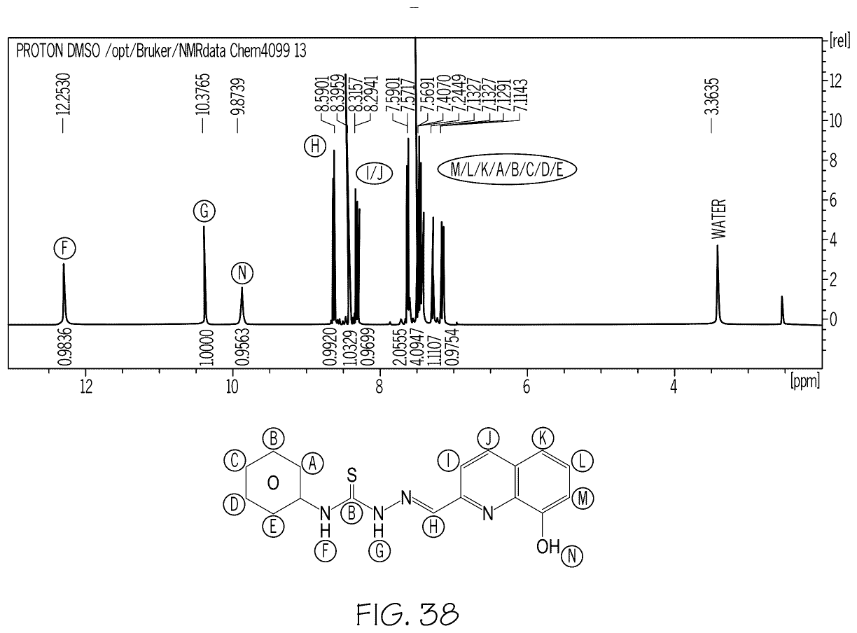

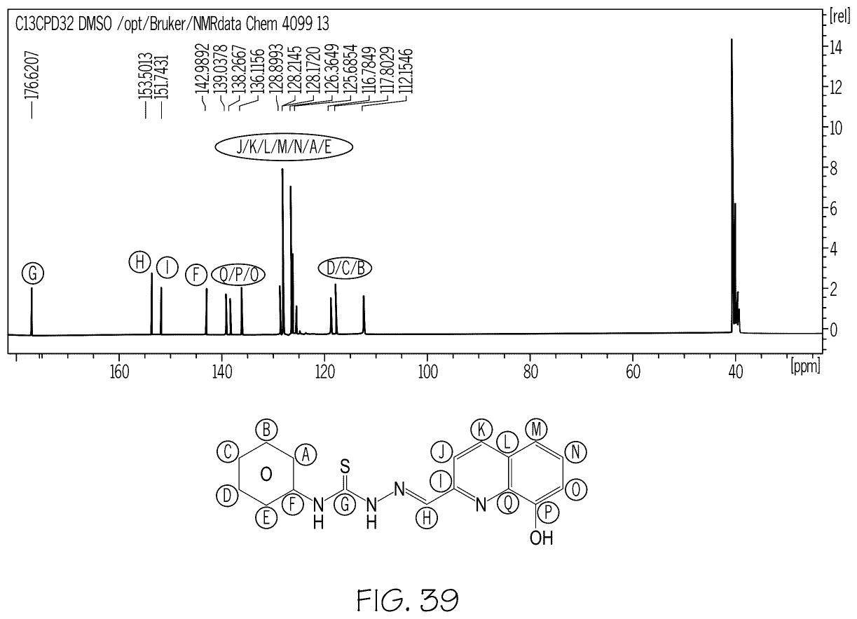

From FIG. 37, the absence of bands characteristic of the aldehyde v(C—O) at 1703 cm−1 v(C—H) at 2842 cm−1 and the appearance of the absorption bands from 1504 cm−1 were attributed to the v(C═N) stretching vibrations from the imine group confirmed the formation of the proposed Schiff base. The absorption in the ranges of 3000-3450 cm−1 were assigned to the v(NH₂) and v(NH) vibrations. The 1H NMR is shown on FIG. 38 and the 13C NMR on FIG. 39. Both NMR spectra has expected absorption bands as confirmed by modeling software. The spectra appeared to be complex in the aromatic region, however as noted all the expected absorption bands were present. Spectra suggested a pure product.

### Synthesis of Thiocarbohydrazone of Salicylaldehyde (1:1 Mol Ratio)

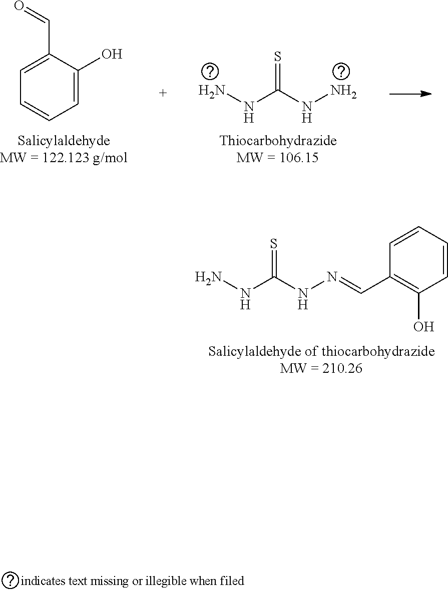 [SMILES: O=Cc1ccccc1O ; NNC(=S)NN ; NNC(=S)N/N=C/c1ccccc1O]

TABLE 18

| | | | Molecular | Number | Actual mass |
|---|---|---|---|---|---|
| Chemical | CAS # | Supplier (Lot#) | weight (g/mol) | of moles | or volume |
| Salicylaldehyde | 90.02-8 | Acros Organics | 122.12 | 0.1 | 12.277 g |
| | | (A042293949) | | | |
| Thiocarbohydrazone | 2231-57-4 | Acros Organics | 106.15 | 0.1 | 10.615 g |
| | | (A0405116) | | | |
| 35% HCl | 7647-01-0 | Thermofisher | 36.45 | 0.01 | 0.86 mL |
| | | Scientific | | | |
| | | (A4119120) | | | |

A solution of thiocarbahydrazide in 250 mL of ethanol and 100 ml of water was refluxed with stirring at 172° F. until it was completed dissolved. A solution of HCl in 30 mL of ethanol was then added drop wise. Next a solution of salicylaldehyde in 60 mL of ethanol was slowly added to the flask over a period of 30. The addition of salicylaldehyde caused the solution to turn to a bright yellow colored clear mixture. The solution was refluxed at 172.4° F. for 3 hr and left stirring overnight without heating. The yellow thiosemicarbazone precipitate was isolated then dried overnight in an oven at 60° C. Yield=91.38%.

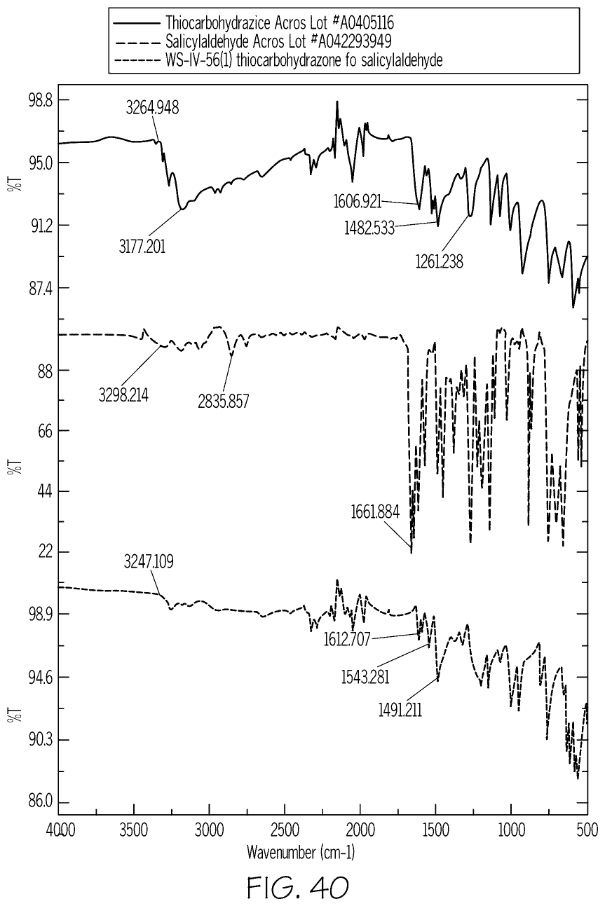

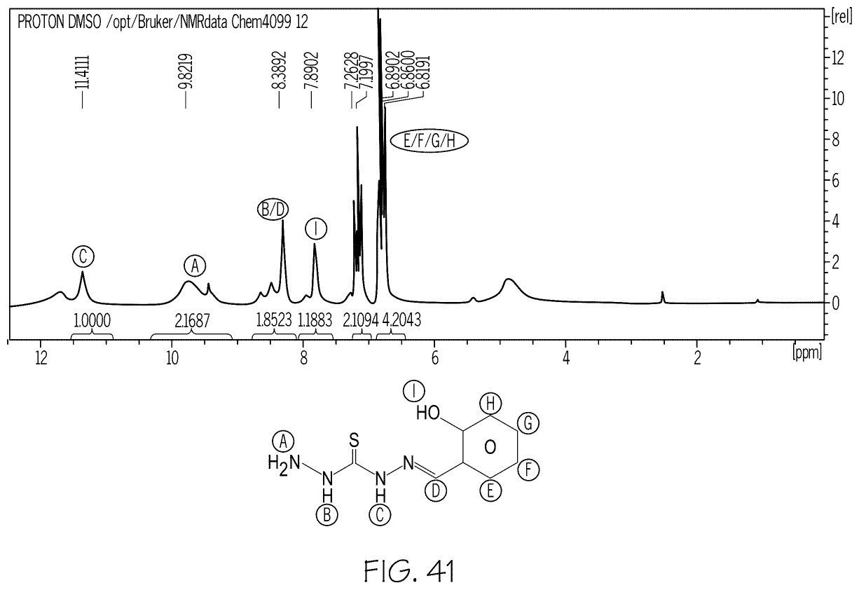

From FIG. 40, the absence of bands characteristic of aldehyde v(C—O) at 1661 cm⁻¹, v(C—H) stretch between 2830-2695 cm−1 and presence of band v(C═N) at 1543 cm⁻¹ characteristic of imine suggest the formation of the proposed Schiff base framework. The absorption in the ranges of 3000-3450 cm₋₁ were assigned to the v(NH₂) and v(NH) vibrations. FTIR also suggest reaction product consisted of a combination of SB and unreacted reactants. The 1H NMR is shown on FIG. 41 and the 13C NMR on FIG. 42. 1H NMR spectra analysis showed extra bands, A, A′, B, B′, I, I′ and 13C NMR spectral analysis showed extra bands A, A′, A″, B, B′, and G, G′. This suggested unreacted reactants present as impurity in the product.

### Synthesis of Thiocarbohydrazone of Salicylaldehyde (1:2 Mol Ratio)

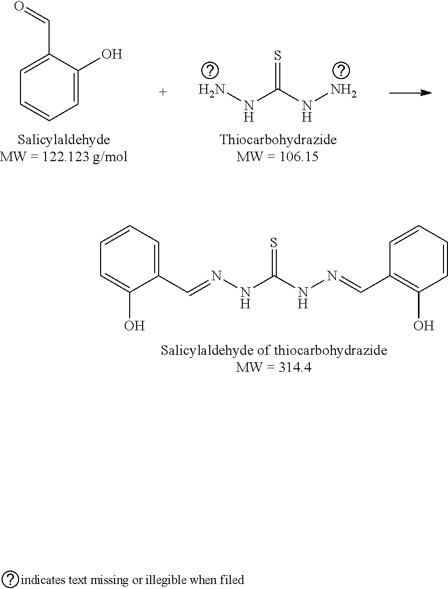 [SMILES: O=Cc1ccccc1O ; NNC(=S)NN ; Oc1ccccc1/C=N/NC(=S)N/N=C/c1ccccc1O]

TABLE 19

| | | | Molecular | Number | Actual mass |
|---|---|---|---|---|---|
| Chemical | CAS # | Supplier (Lot#) | weight (g/mol) | of moles | or volume |
| Salicylaldehyde | 90.02-8 | Acros Organics | 122.12 | 0.2 | 24.495 g |
| | | (A042293949) | | | |
| Thiocarbohydrazone | 2231-57-4 | Acros Organics | 106.15 | 0.1 | 10.615 g |
| | | (A0405116) | | | |
| 35% HCl | 7647-01-0 | Thermofisher | 36.45 | 0.01 | 0.86 mL |
| | | Scientific | | | |
| | | (A4119120) | | | |

A solution of thiocarbahydrazide in 250 mL of ethanol and 100 ml of water was refluxed with stirring at 172° F. until it was completed dissolved. A solution of HCl in 30 mL of ethanol was then added drop wise. Next a solution of salicylaldehyde in 60 mL of ethanol was slowly added to the flask over a period of 30 minutes. The addition of salicylaldehyde caused the solution to turn to a bright yellow colored clear mixture. The solution was refluxed at 172.4° F. for 3 hr and left stirring overnight without heating. The yellow thiosemicarbazone precipitate was isolated then dried overnight in an oven at 60° C. Yield=86.4%.

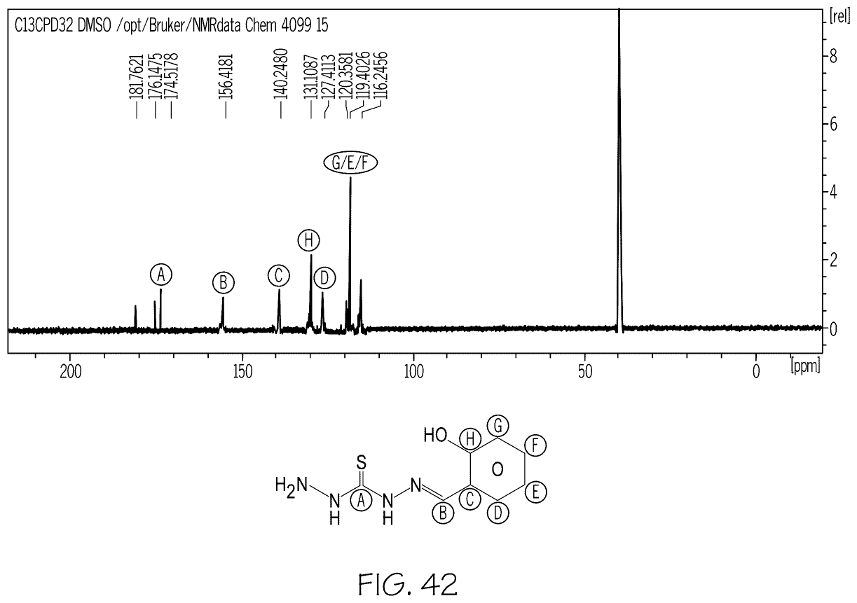

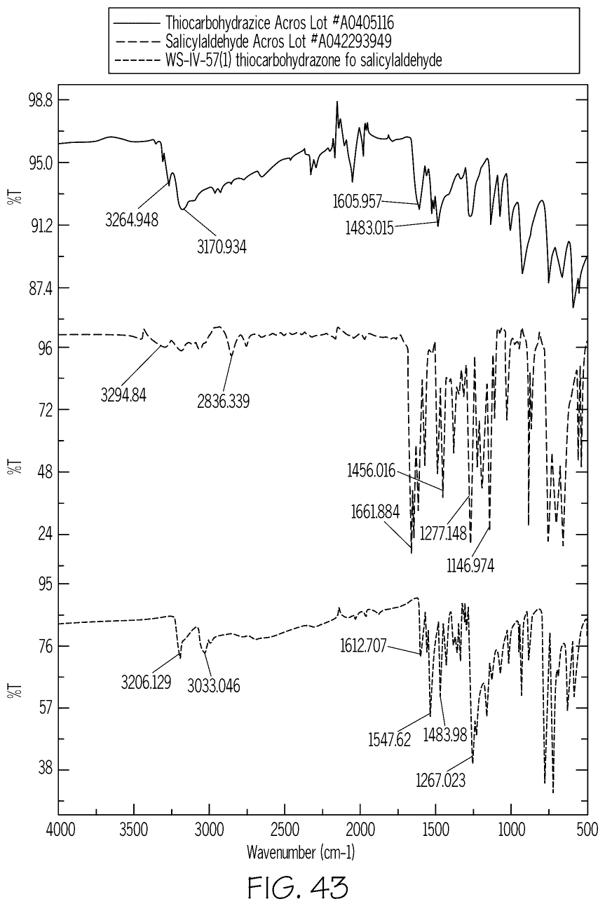

From FIG. 43, the absence of bands characteristic of aldehyde v(C—O) at 1661 cm⁻¹, v(C—H) stretch between 2830-2695 cm−1 and presence of band v(C═N) at 1547 cm⁻¹ characteristic of imine suggest the formation of the proposed Schiff base framework. The absorption in the ranges of 3000-3450 cm−1 were assigned to the v(NH₂) and v(NH) vibrations.

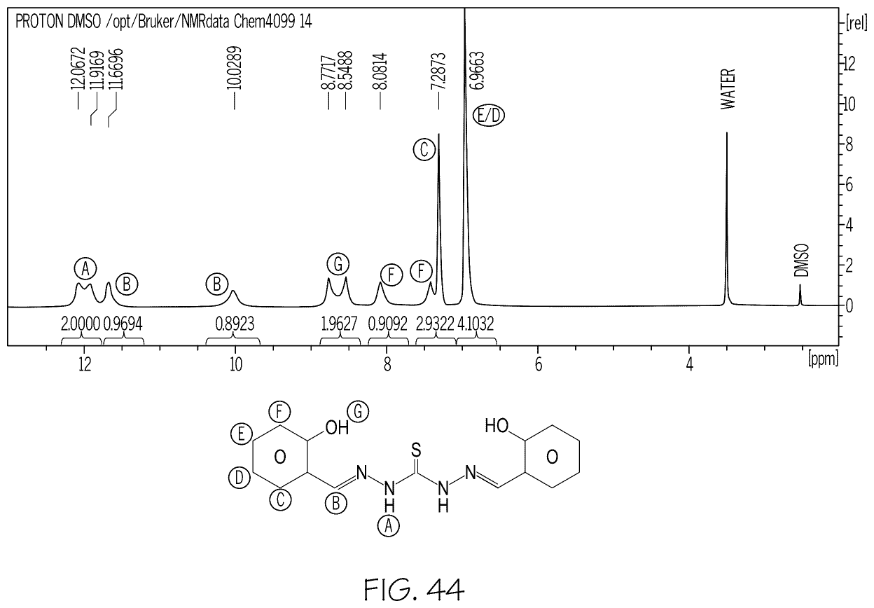

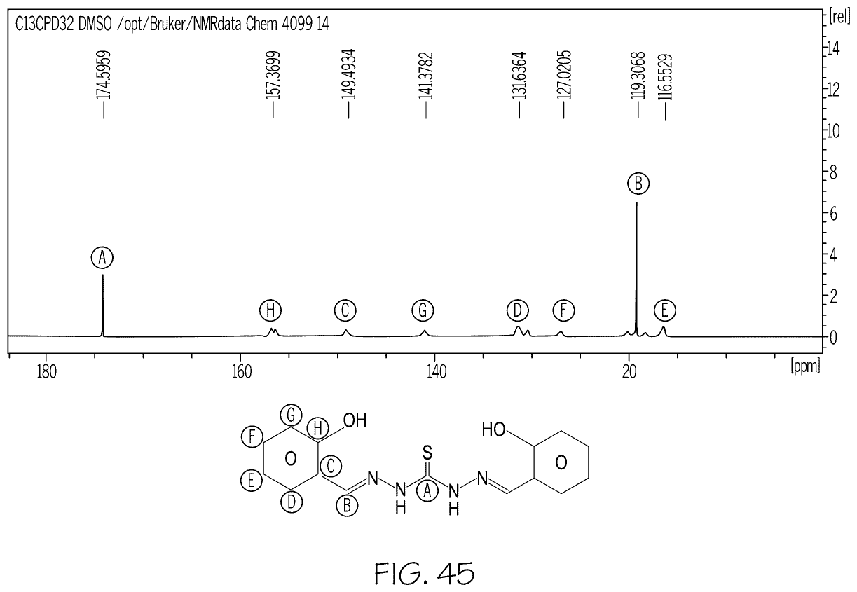

FTIR also suggest reaction product consisted of a combination of SB and unreacted reactants. The 1H NMR is shown on FIG. 44 and the 13C NMR on FIG. 45. 1H NMR spectra analysis showed extra bands, F, F′, B, B′, and 13C NMR spectral analysis showed extra bands H, H′, D, D′, and E, E′. This suggested unreacted reactants present as impurity in the product.

### Synthesis of bis-thiosemicarbazone and 2,6-Diacetylpyridine

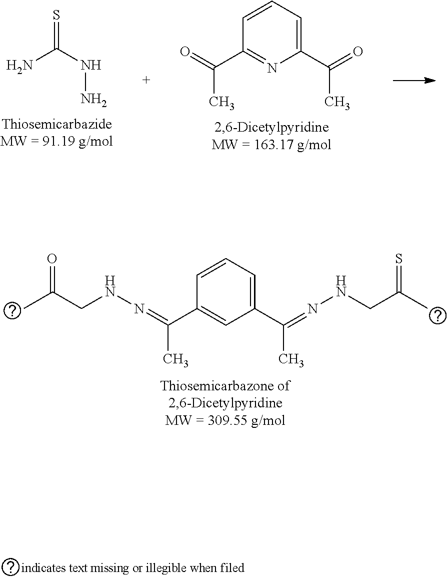 [SMILES: NNC(N)=S ; CC(=O)c1cccc(C(C)=O)n1 ; CC(=O)CNN=C(C)c1cccc(C(C)=NNCC(C)=S)c1]

TABLE 20

| | | Supplier | Molecular | Number | Actual mass | |
|---|---|---|---|---|---|---|
| Chemical | CAS # | (Lot #) | weight (g/mol) | of moles | or volume | |
| Thiosemicarbazide | 79-16-6 | Sigma Aldrich | 91.13 | 0.2 | 18.236 | g |
| | | (STBJ5791) | | | | |
| 2,6-Dicetylpyridine | 1129-30-2 | Thermo Fisher | 163.17 | 0.1 | 16.317 | g |
| | | Scientific | | | | |
| | | (A0414452) | | | | |
| 35% HCl | 7647-01-0 | Thermofisher | 36.45 | 0.02 | 2.154 | mL |
| | | Scientific | | | | |
| | | (A4119120) | | | | |

In a 1000 mL flask, thiosemicarbazide was added to 250 mL of ethanol to dissolve under reflux with heating. 75 mL of di-water was added initially to aid in dissolving the thiosemicarbazide. Solution became a clear, yellow color after 30 minutes. Then, a solution of 2.15 mL of HCl in 30 mL of water is then added drop wise. Next, 2,6-diacetylpyridine is dissolved in 100 mL of ethanol with stirring and light heating to completely dissolve the crystalline solid. Due to the crystalline nature of the 2,6-diacetylpyridine, the solid began to crystallize upon entry to the addition funnel, which clogged the funnel. The solution was then added manually with a pipet dropwise over 30 minutes to prevent clumping. Addition of the 2,6-dicetylpyridine/ethanol caused the solution to become opaque and yellow colored, as the precipitate formed. The product (% yield=86.22%) was vacuum filtered, rinsed with 1 pint of ethanol and placed in an oven to dry.

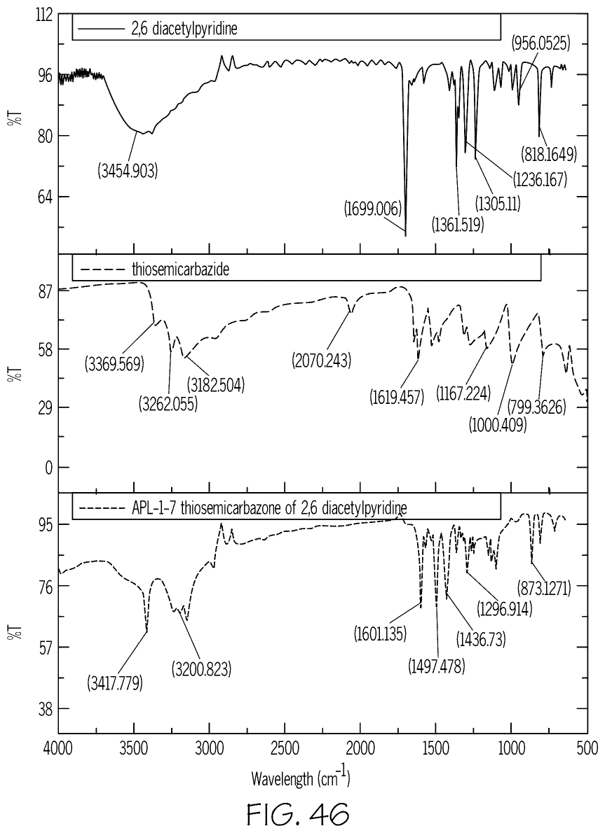

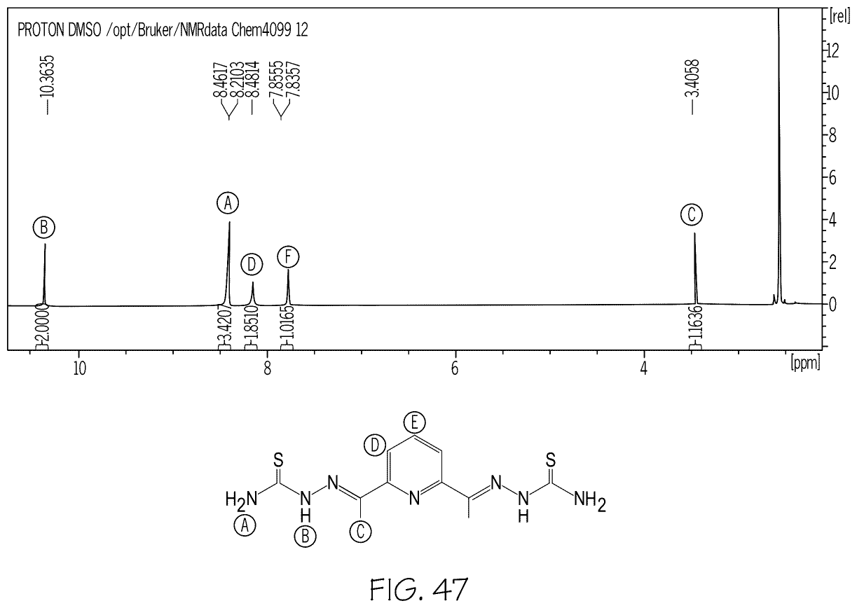

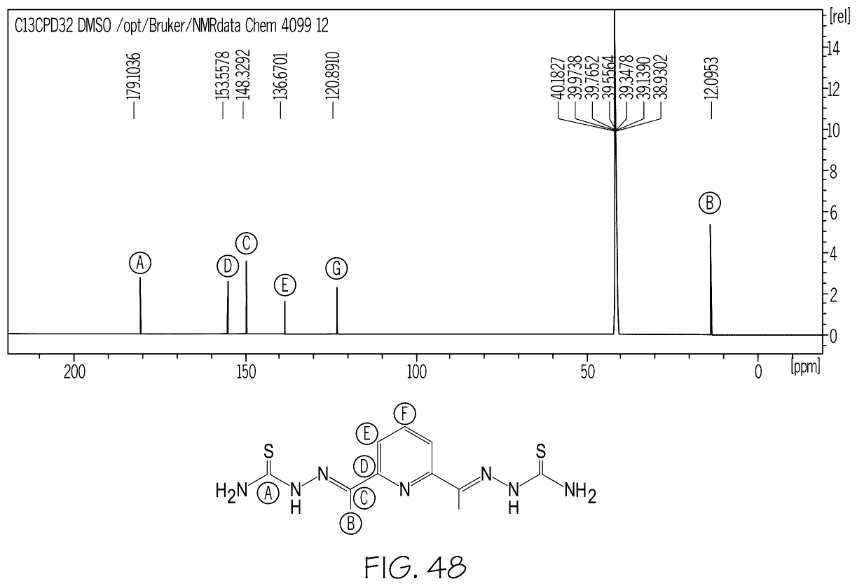

From FIG. 46, the broad bands observed in the ranges of 3450-3100 cm⁻¹ were assigned to the v(NH₂) and v(NH) vibrations. The strong and medium absorption bands at 1580-1610 cm⁻¹ were attributed to the v(C═N) stretching vibrations of the imine group. It indicates that free —NH₂ group of Thiosemicarbazide was converted to azomethine group. The presence of aromatic rings has been identified by their characteristic ring vibrations at 1500-1400, 1100-1050 and 900-700 cm⁻¹ region. The absence of v(C═O) and presence of band v(C═N) characteristic of imine suggests the formation of the proposed Schiff base framework. The 1H NMR is shown on FIG. 47 and the 13C NMR on FIG. 48. Both NMR spectra have the expected absorption bands as confirmed by modeling software. Spectra suggested a pure product.

### Synthesis of 2-pyridinecarboxyaldehyde & thiocarbohydrazide

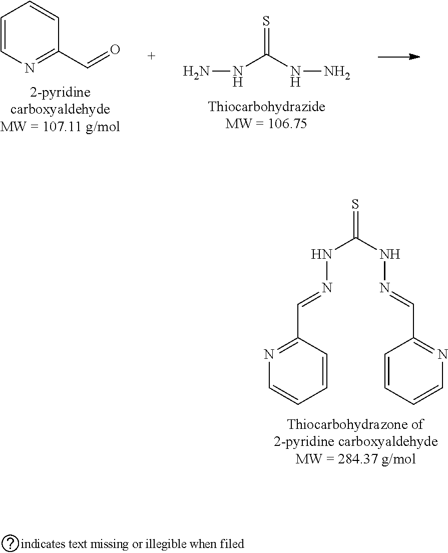 [SMILES: O=Cc1ccccn1 ; NNC(=S)NN ; S=C(N/N=C/c1ccccn1)N/N=C/c1ccccn1]

TABLE 21

| | | | Molecular | | Actual | |
|---|---|---|---|---|---|---|
| | | Supplier | weight | Number | mass or | |
| Chemical | CAS # | (Lot #) | (g/mol) | of moles | volume | |
| Thiocarbohydrazide | 2231-57-4 | Sigma Aldrich | 106.15 | 0.033 | 3.521 | g |
| | | (A0405116) | | | | |
| 2- | 1121-60-4 | Acros Organics | 107.11 | 0.066 | 7.00 | mL |
| pyridinecarboxyaldehyde | | (A0436189) | | | | |
| 35% HCl | 7647-01-0 | Thermofisher | 36.46 | 0.0066 | 0.241 | mL |
| | | Scientific | | | | |
| | | (A4119120) | | | | |

In a 1000 mL flask, thiocarbohydrazide was added to 250 mL of ethanol. Reaction was run under nitrogen. HCl was added to 30 mL of ethanol, and this mixture was added dropwise to the reaction mixture. Aliquots of water was then added in 10 mL increments totaling 50 mL to aid in dissolving the thiocarbohydrazide. After it was completely dissolved, 2-pyridinecarboxyaldehyde was added to 100 mL of ethanol and then added dropwise to the reaction mixture. No precipitation formed even after completing the addition of the 2-pyridinecarboxyaldehyde. The system was refluxed and heated overnight. A fine grey powder (% yield=44.57%) was isolated from the reaction mixture, this was heated in the oven for 3-4 days.

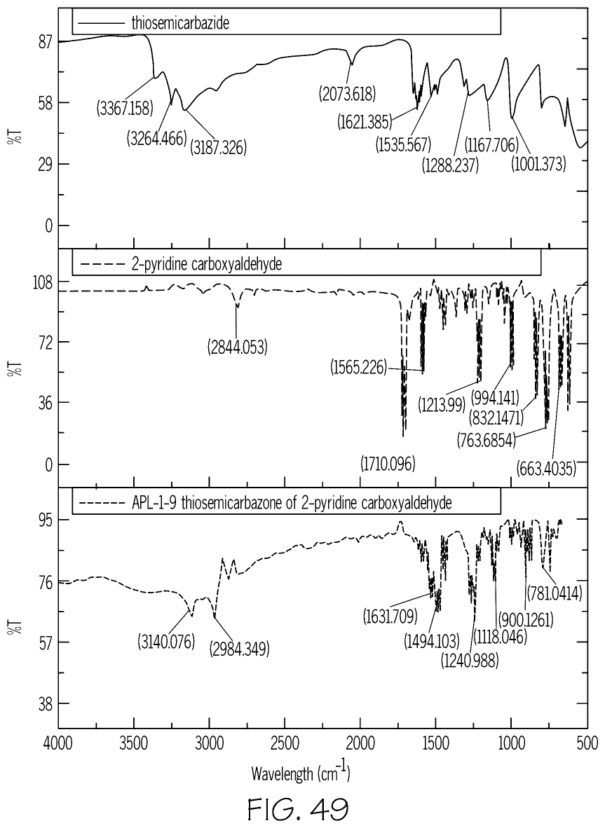

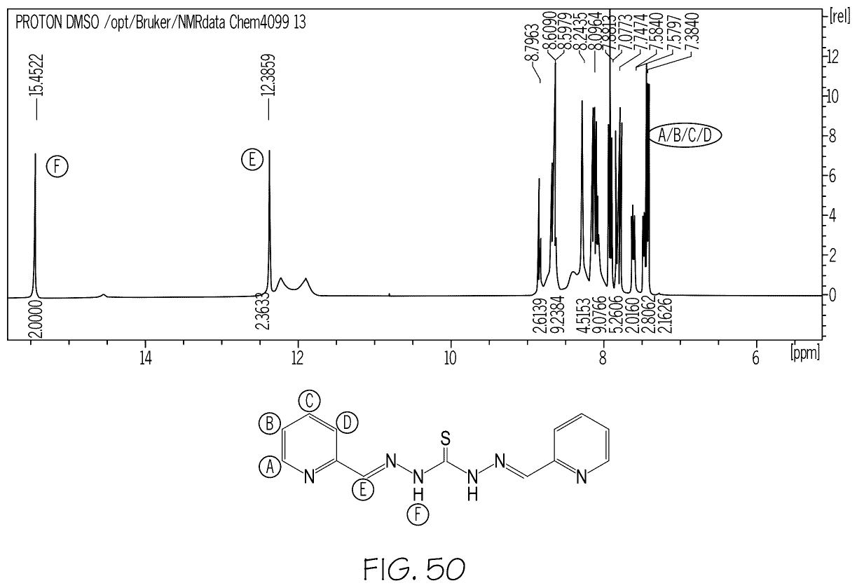

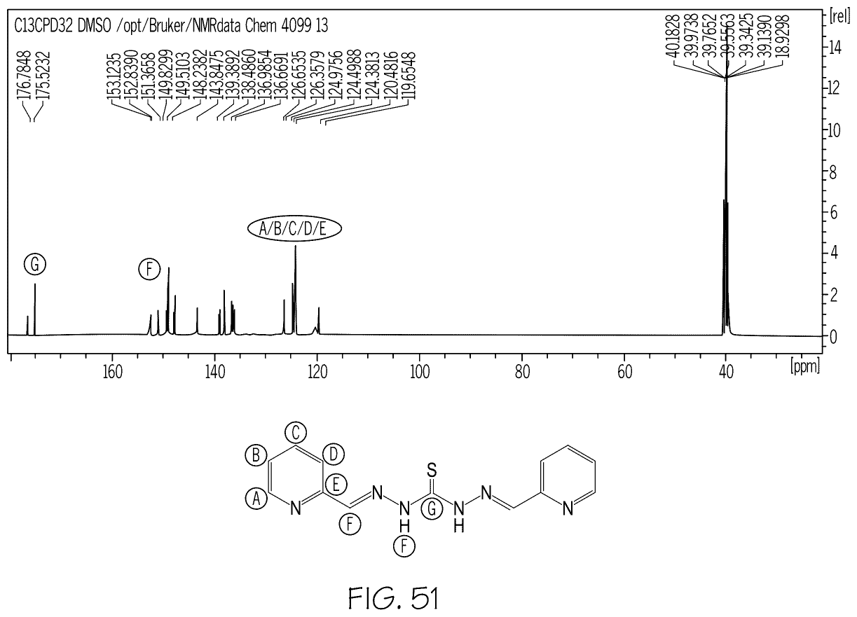

From FIG. 49, the absence of bands characteristic of aldehyde v(C—O) at 1710 cm⁻¹, v(C—H) stretch at 2844 cm−1, v(C—H) bending at between 1390-1380 cm⁻¹ and presence of band v(C═N) at 1531 cm⁻¹ characteristic of imine suggests the formation of the proposed Schiff base framework. The broad bands observed in the ranges of 3450-3100 cm−1 were assigned to the v(NH₂) and v(NH) vibrations. The 1H NMR is shown on FIG. 50 and the 13C NMR on FIG. 51. Both 1H NMR and 13C NMR spectral analysis suggested unreacted reactants and a variety of reaction intermediates in the product. It was suspected that the thiocarbohydrazide starting material might be impure which may have caused the reaction to not complete as efficiently.

### Synthesis of Terephthalaldehyde and 4-phenyl, 3-thiosemicarbazide

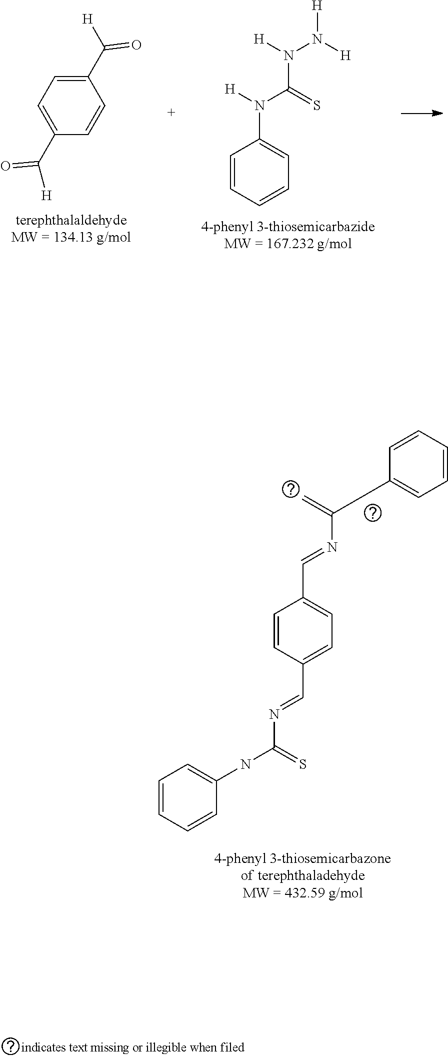 [SMILES: O=Cc1ccc(C=O)cc1 ; NNC(=S)Nc1ccccc1 ; C=C(Cc1ccccc1)/N=C/c1ccc(/C=N/C(=S)Nc2ccccc2)cc1]

TABLE 22

| | | Supplier | Molecular | Number | Actual mass | |
|---|---|---|---|---|---|---|
| Chemical | CAS # | (Lot #) | weight (g/mol) | of moles | or volume | |
| Terephthalaldehyde | 623-27-8 | Alfa Aesar | 134.13 | 0.05 | 6.798 | g |
| | | (10222547) | | | | |
| 4-phenyl | 5351-69-9 | TCI (FCX- | 167.232 | 0.1 | 16.72 | g |
| 3thiosemicarbazide | | 01-NE) | | | | |
| 35% HCl | 7647-01-0 | Thermofisher | 36.46 | 0.01 | 0.860 | mL |
| | | Scientific | | | | |
| | | (A4119120) | | | | |

In a 1000 mL reaction flask, 4-phenyl 3-thiosemicarbazide was added with 250 mL of ethanol and the temperature was set to 170 F. Then, a solution of HCl in 30 mL of ethanol was added dropwise to the reaction flask. The solution became lighter yellow/clear after addition of HCl. Terephthalaldehyde was dissolved in 200 mL of ethanol and added dropwise to the reaction mixture. The mixture turned bright yellow/green and precipitate almost immediately formed upon addition. By the end of the addition, the color was opaque yellow. The mixture was left overnight to mix under reflux and heat. The next day, the mixture was vacuum filtered and a yellow solid (% yield=92.67%) was collected and placed in the oven at 93 C.

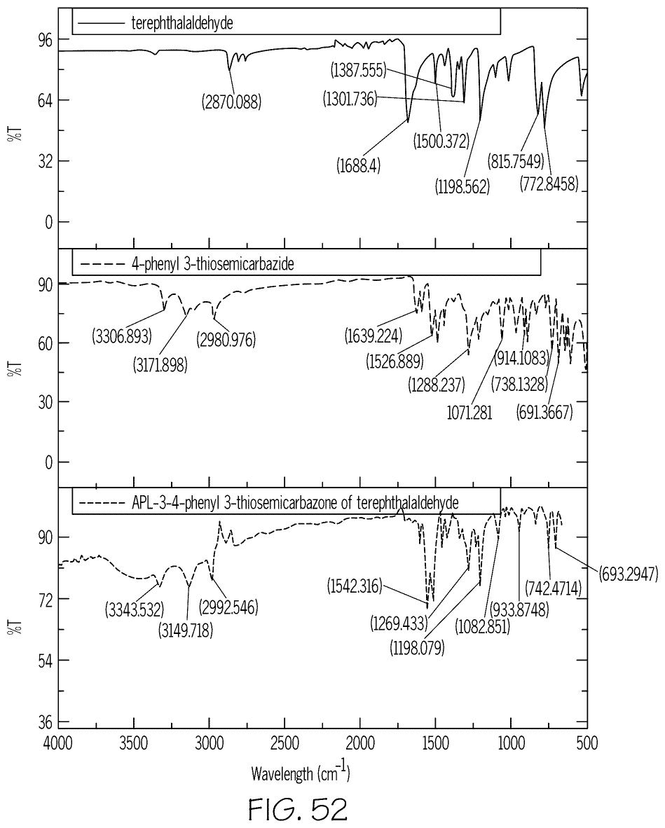

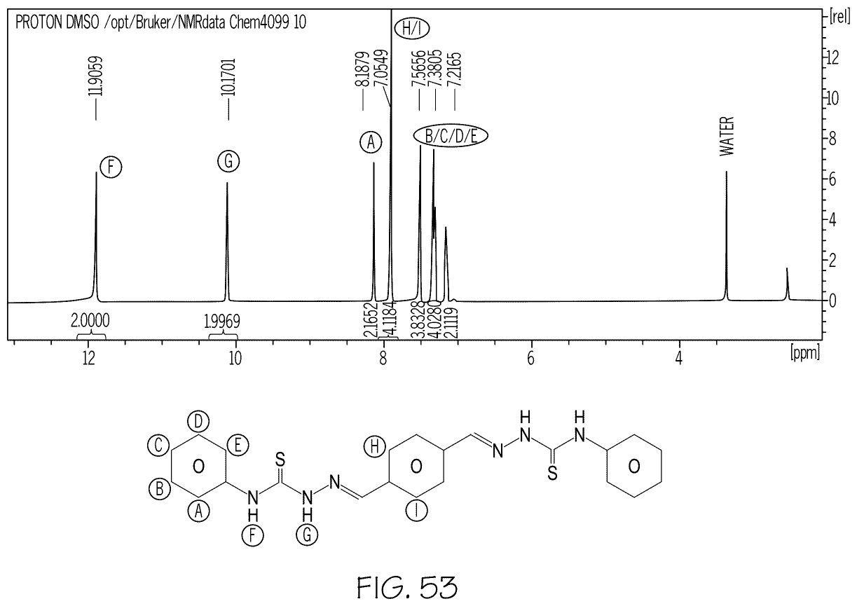

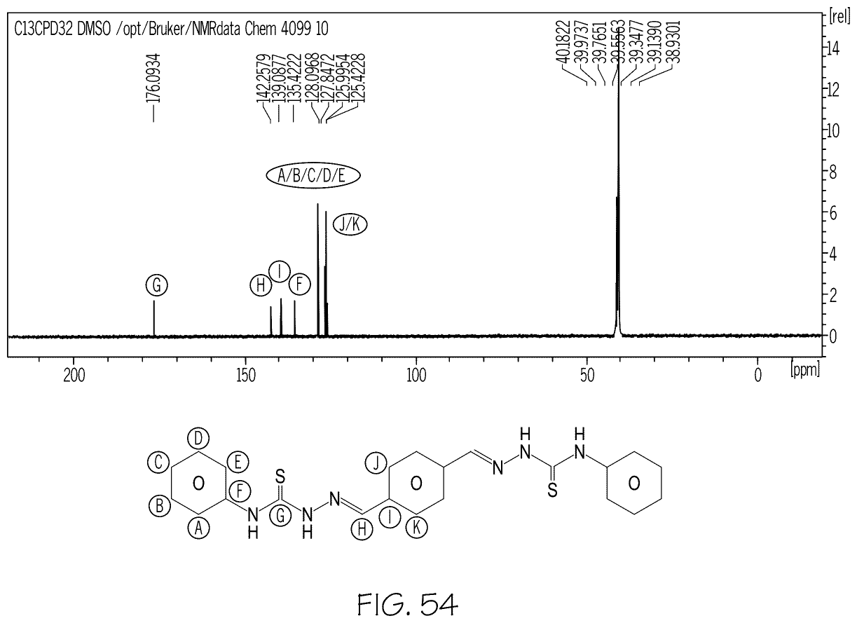

From FIG. 52, the absence of bands characteristic of aromatic bis aldehydes at around 2870 cm⁻¹ (C—H stretching), 1688 cm⁻¹ (C—O stretching), 1387 cm⁻¹ (C—H bending) and presence of band v(C═N) at 1542 cm⁻¹ characteristic of imine suggests the formation of the proposed Schiff base framework. The broad bands observed in the ranges of 3450-3100 cm−1 were assigned to the v(NH₂) and v(NH) vibrations. v(C—H) stretching observed between 2900-3000 cm−1. The medium bands which are in 1050-1080 cm⁻¹ range were ascribed to v(C═S) stretching vibrations, indicating that the studied compounds are present in the thione form. The presence of aromatic rings has been identified by their characteristic ring vibrations at 1500-1400, 1100-1050 and 900-700 cm−1 region. The 1H NMR is shown on FIG. 53 and the 13C NMR on FIG. 54. Both NMR spectra have the expected absorption bands as confirmed by modeling software. Spectra suggested a pure product.

### Synthesis of terephthalaldehyde & 4-methylthiosemicarbazide

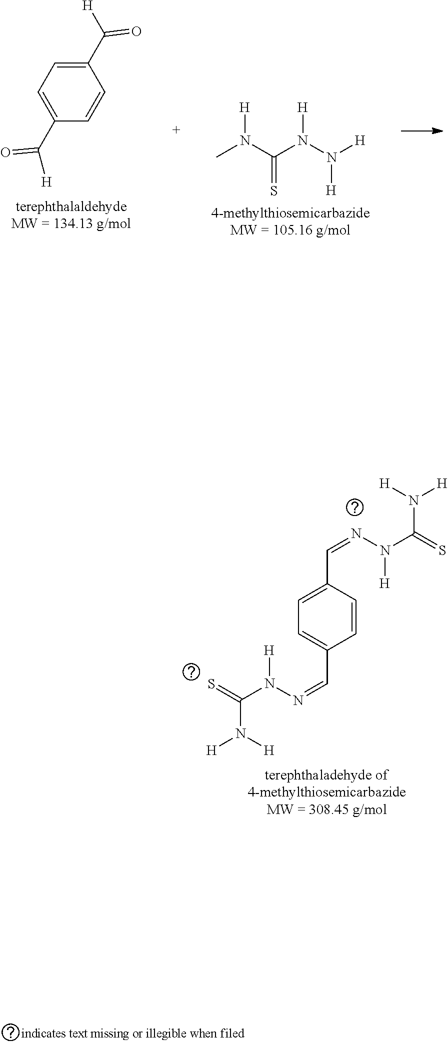

TABLE 23

| | | Supplier | Molecular | Number | Actual mass | |
|---|---|---|---|---|---|---|
| Chemical | CAS # | (Lot #) | weight (g/mol) | of moles | or volume | |
| Terephthalaldehyde | 623-27-8 | Alfa Aesar | 134.13 | 0.05 | 6.708 | g |
| | | (10222547) | | | | |
| 4- | 6610-29-3 | TCI | 105.16 | 0.1 | 10.560 | g |
| methylthiosemicarbazide | | (MSFSFHN) | | | | |
| 35% HCl | 7647-01-0 | Thermofisher | 36.46 | 0.01 | 0.860 | mL |
| | | Scientific | | | | |
| | | (A4119120) | | | | |

In a 1000 mL flask, 4-methylthiosemicarbazone was added to 250 ml of ethanol. The temperature was set to 170F. Then, a solution of HCl in 30 mL of ethanol was then added dropwise to the reaction mixture. The solution remained clear throughout the addition of HCl.

Terephthalaldehyde was added to 200 mL of ethanol and stirred until completely dissolved and clear. This solution was then added to the reaction flask dropwise causing the solution to turn slightly opaque and yellow. By the end of the addition, the solution was a medium yellow/green color and opaque. The reaction was left at temperature to reflux for 3 hours. The next day, the mixture was vacuum filtered and a yellow solid (% yield=90.7%) was collected and placed in the oven at 93 C.

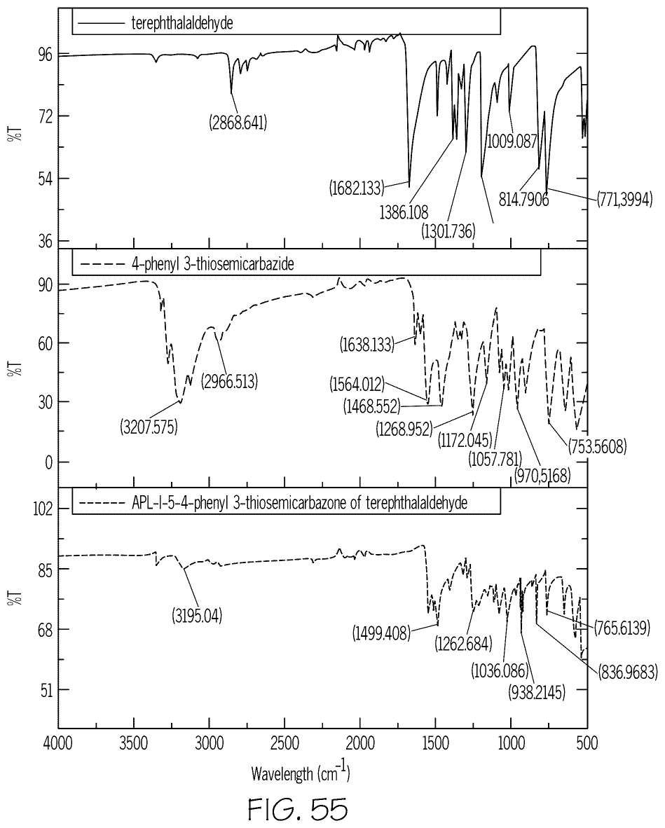

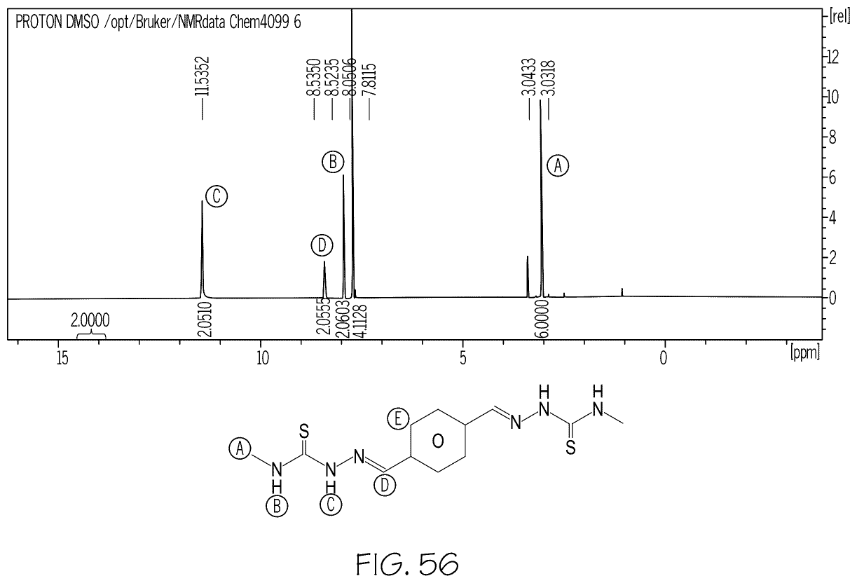

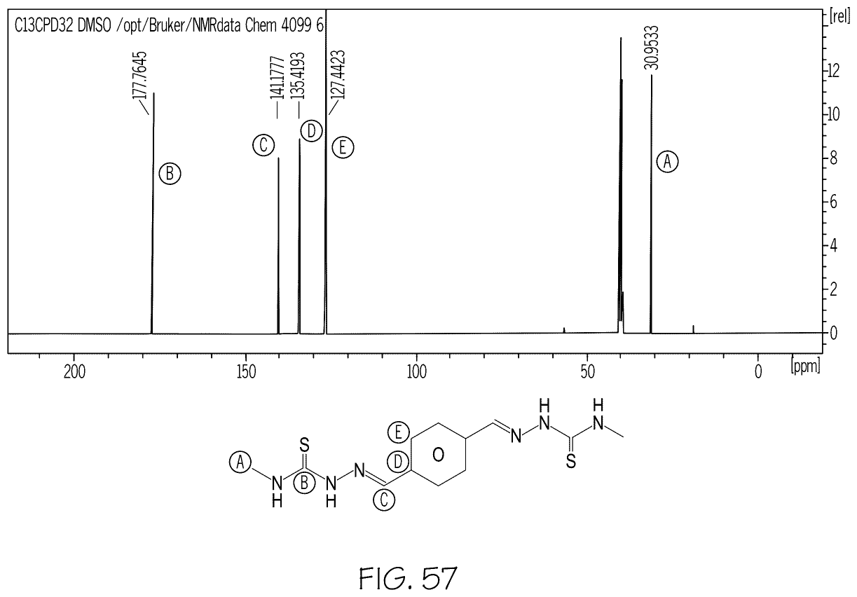

From FIG. 55, the absence of bands characteristic of aromatic dialdehydes at around 2868 cm⁻¹ (C—H stretching), 1682 cm⁻¹ (C═O stretching), 1386 cm⁻¹ (C—H bending) and presence of band v(C═N) between 1580-1610 characteristic of imine suggests the formation of the proposed Schiff base framework. The presence of aromatic rings has been identified by their characteristic ring vibrations at 1500-1400, 1100-1050 and 900-700 cm−1 region. The 1H NMR is shown on FIG. 56 and the 13C NMR on FIG. 57. Both NMR spectra have the expected absorption bands as confirmed by modeling software. Spectra suggested a pure product.

### Synthesis of 2,6-Diacetylpyridine & 4-phenyl 3-thiosemicarbazide

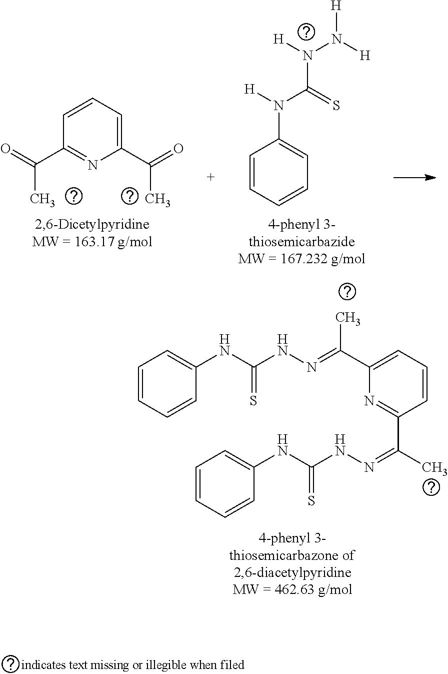 [SMILES: CC(=O)c1cccc(C(C)=O)n1 ; NNC(=S)Nc1ccccc1 ; C/C(=N/NC(=S)Nc1ccccc1)c1cccc(/C(C)=N/NC(=S)Nc2ccccc2)n1]

TABLE 24

| | | | Molecular | Number | Actual mass | |
|---|---|---|---|---|---|---|
| Chemical | CAS # | Supplier (Lot #) | weight (g/mol) | of moles | or volume | |
| 2,6-Diacetylpyridine | 1129-30-2 | Thermo Fisher | 163.17 | 0.05 | 8.180 | g |
| | | Scientific | | | | |
| | | (A0414452) | | | | |
| 4-phenyl | 5351-69-9 | TCI | 167.23 | 0.1 | 16.720 | g |
| 3thiosemicarbazide | | (FCX01PTDT) | | | | |
| 35% HCl | 7647-01-0 | Thermofisher | 36.46 | 0.01 | 0.860 | mL |
| | | Scientific | | | | |
| | | (A4119120) | | | | |

In a 1000 mL flask, the 4-phenyl 3-thiosemicarbazide was added to 250 mL of ethanol. The solution was clear and the solid was dissolved after 5 minutes of mixing. Then, a mixture of 35% HCl and 35 mL of ethanol was added dropwise to the solution. After this, 2,6-diacetylpyridine was dissolved in 35 ml of warm ethanol and added manually dropwise. The color began as a bright yellow/green, but quickly a white, fluffy precipitate began to form. The precipitate created a significant increase in volume and the reaction flask was transferred to a 2 L volume and a total of 3 pints of ethanol was necessary to create a mixture capable of mixing. The final solution was mixed under heat and refluxed for 3 hours. The precipitate (% yield=86.21%) was vacuum filtered dried in an oven at 93 C overnight.

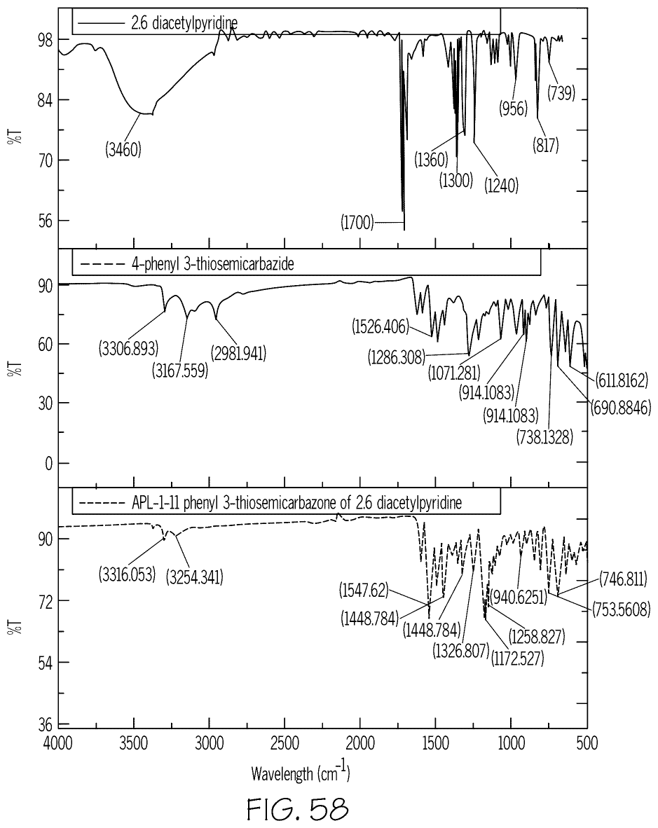

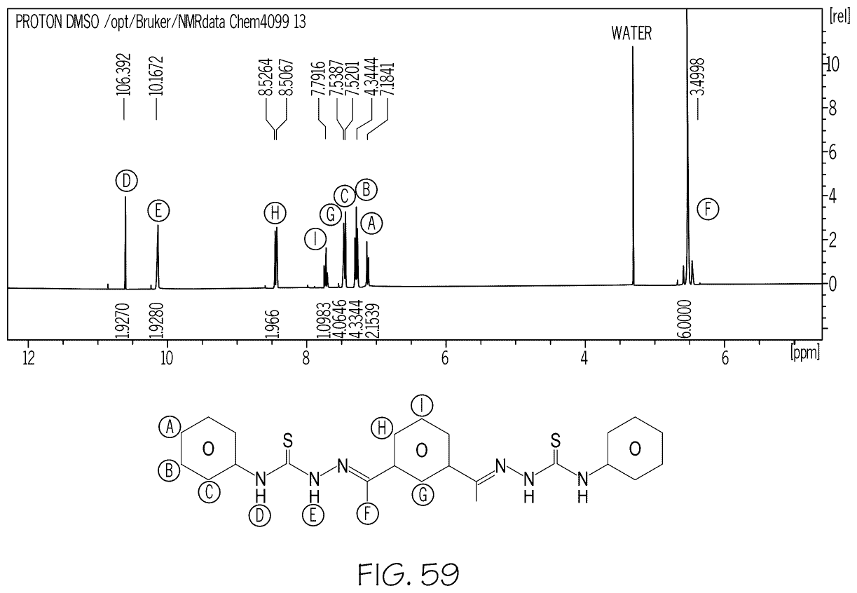

From FIG. 58, the absence of bands characteristic of aromatic aldehydes at 1700 cm⁻¹ (C═O stretching) and presence of band v(C═N) between 1580-1610 characteristic of imine suggests the formation of the proposed Schiff base framework. The broad bands observed in the ranges of 3450-3100 cm⁻¹ were assigned to the v(NH₂) and v(NH) vibrations. The strong absorption band around 1547 cm⁻¹ was assigned to the v(C═N) stretching vibrations of the imine group. It indicates that free —NH₂ group of 4-phenyl-3-thiosemicarbazide was converted to azomethine group. The presence of aromatic rings has been identified by their characteristic ring vibrations at 1500-1400, 1100-1050 and 900-700 cm⁻¹ region. The 1H NMR is shown on FIG. 59 and the 13C NMR on FIG. 60. Both NMR spectra have the expected absorption bands as confirmed by modeling software. Spectra suggested a pure product.

### Synthesis of 4-methylthiosemicarbazide & 2,6-diacetylpyridine

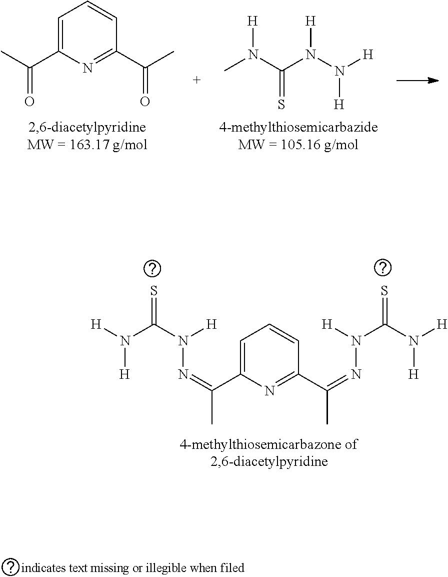

TABLE 25

| | | | Molecular | | Actual | |
|---|---|---|---|---|---|---|
| | | Supplier | weight | Number | mass or | |
| Chemical | CAS # | (Lot #) | (g/mol) | of moles | volume | |
| 4- | 6610-29-3 | TCI | 105.16 g/mol | 0.1 | 10.585 | g |
| methylthiosemicarbazide | | (MSFSFHN) | | | | |
| 2,6-diacetylpyridine | 1129-30-2 | Thermo fisher | 163.17 g/mol | 0.05 | 8.222 | g |
| | | (A0414452) | | | | |
| 35% HCl | 7647-01-0 | Thermofisher | 36.46 | 0.01 | 0.860 | mL |
| | | Scientific | | | | |
| | | (A4119120) | | | | |

In a 2000 mL flask, add 4-methylthiosemicarbazide to 250 mL of ethanol. Solution was clear after 30 minutes of mixing and heating. HCl in 35 mL of ethanol was then added dropwise. Next, 2,6diacetylpyridine was dissolved in 200 mL of warm ethanol and added dropwise. Solution turned yellow with the addition of 2,6-diacetylpyridine. A white precipitate formed halfway through the addition. Reaction was refluxed for 3 hours and the precipitate was then vacuum filtered and rinsed with a pint of ethanol. The product (% yield=88.9%) was opaque, fluffy, white/yellow solid, and dried overnight in the oven at 93C.

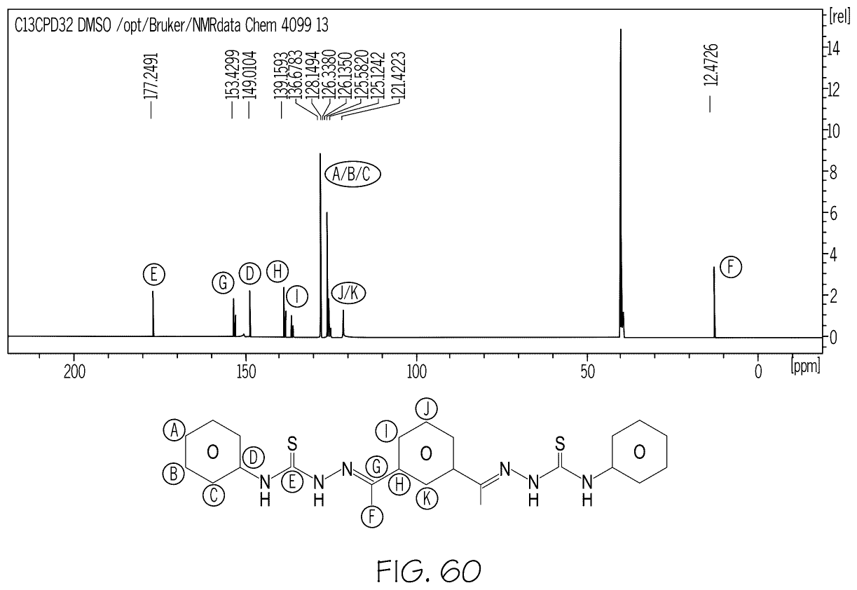

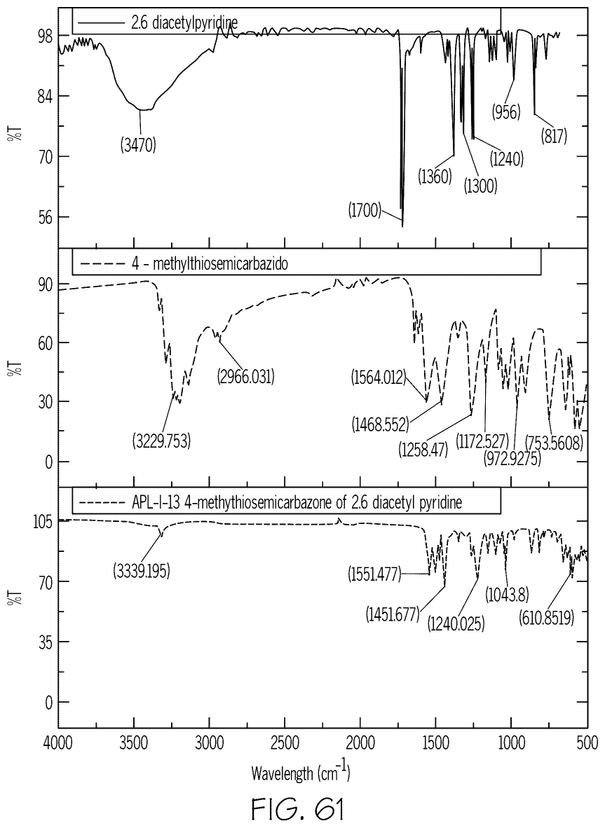

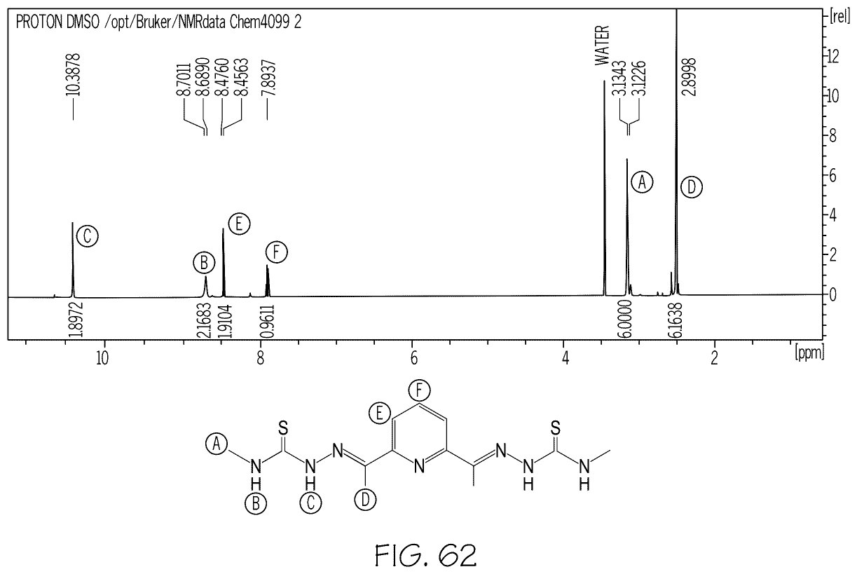

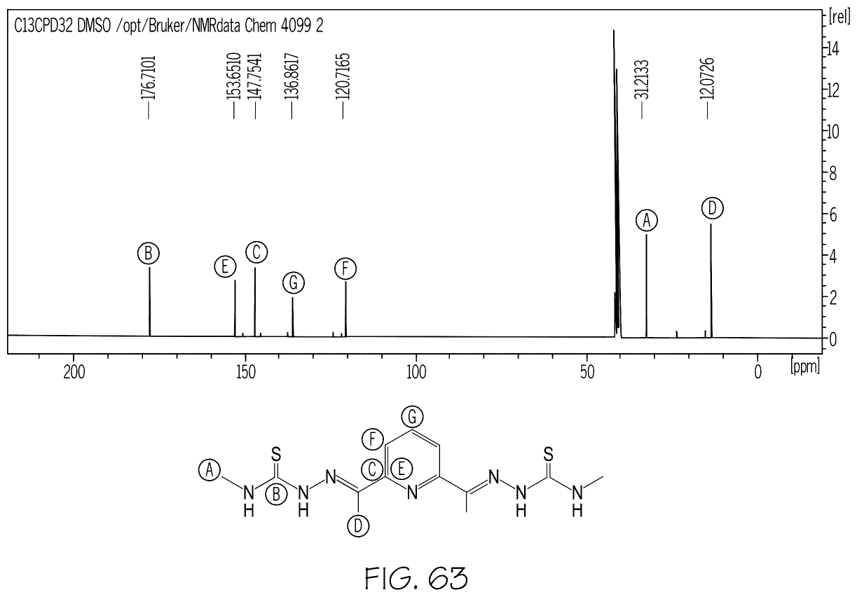

From FIG. 61, the absence of bands characteristic of aromatic aldehydes at 1700 cm⁻¹ (C═O stretching) and presence of band v(C═N) at 1551 cm⁻¹ characteristic of imine suggests the formation of the proposed Schiff base framework. The band observed in the ranges of 3450-3100 cm⁻¹ were assigned to the v(NH) vibrations. The presence of aromatic rings has been identified by their characteristic ring vibrations at 1500-1400, 1100-1050 and 900-700 cm⁻¹ region. The 1H NMR is shown on FIG. 62 and the 13C NMR on FIG. 63. Both NMR spectra have the expected absorption bands as confirmed by modeling software. Spectra suggested a pure product.

### Electrochemical Analysis of the Schiff Bases

The following description relates to a study of the electrochemical analysis of the synthesized Schiff bases. Materials used in this study include aluminum alloy 2024 and carbon steel C1008. In order to study the performance of corrosion inhibitors, the carbon steel specimens were tested in a bare condition and with a low hydrogen embrittlement (LHE) ZnNi coating.

For the selected corrosion inhibitors, Schiff bases of several aldehydes and primary amines were synthesized to make corrosion inhibitors for bare 2024 aluminum alloy, bare C1008, and LHE ZnNI coated C1008 steel. These Schiff bases include thiosemicarbazide derivatives. The Schiff bases derived corrosion inhibitors and their corresponding sample identities used in this study are listed in the following table.

TABLE 26
Sample identities and compound names of Schiff
bases derived corrosion inhibitors used in this study.

| | | Inhibitor |
|---|---|---|
| No. | Compound Name | ID |
| 1 | Bis-thiosemicarbazone of isophthalaldehyde | CI1 |
| 2 | Thiosemicarbazone of Salicylaldehyde | CI2 |
| 3 | Thiosemicarbazone of 8-hydroxyquinoline-2- | CI3 |
| | carboxyaldehyde | |
| 4 | Thiosemicarbazone of 2-pyridine carboxyaldehyde | CI4 |
| 5 | 4-phenyl-3-Thiosemicarbazone of Isophthalaldehyde | CI5 |
| 6 | 4-methyl-3-thiosemicarbazone of isophthalaldehyde | CI6 |
| 7 | 4-methyl-Thiosemicarbazone of salicylaldehyde | CI7 |
| 8 | 8-hydroxyquinoline-2-carboxyaldehyde of phenyl | CI8 |
| | thiosemicarbazone | |
| 9 | terephthalaldehyde & 4-methylthiosemicarbazide | CI9 |
| 10 | 2,6-Diacetylpyridine & 4-phenyl-3-thiosemicarbazide | CI10 |
| 11 | 4-methylthiosemicarbazide & 2,6-diacetylpyridine | CI11 |

The performances of these corrosion inhibitors were electrochemically investigated. In this initial effort, their performances were evaluated based on the open circuit potential (OCP) and corrosion rate. All electrochemical tests consisting of OCP and linear polarization (LP) measurements were performed in a flat cell containing NaCl solution with saturated calomel electrode (SCE) as a reference electrode and platinum mesh as a counter electrode. A stock electrolyte was prepared by adding 52.6 g NaCl into a total of 1 L of deionized water to make 0.9 M NaCl solution. This solution was stirred for 30 minutes until the salt completely dissolved. For each inhibitor tested, the requisite amount of inhibitor was added to 300 mL of stock electrolyte and stirred for 30 minutes. This solution was then filtered through Whatman #1 paper. For studying the performance of various inhibitor types and concentrations, Al 2024 samples were tested in 0.9 M NaCl solution with different inhibitor types and concentrations. Corrosion behaviors of bare C1008 steel in the absence and presence of inhibitors was carried out in 0.9 M NaCl solution saturated with each inhibitor. Impact of coatings on corrosion resistance of bare C1008 steel and LHE ZnNi-coated C1008 steel was evaluated in the 0.9 M NaCl solution.

The OCP measurements of aluminum alloy 2024 with various corrosion inhibitor types and concentrations, LHE ZnNi coated steel with various inhibitor types, and bare and LHE ZnNi coated steel with various corrosion inhibitor-containing epoxy coatings were performed for 3, 4, and 6 hours, respectively.

The corrosion rates of materials were calculated from the LP curves obtained from LP testing. This LP test was carried out by sweeping the potential from −15 mV to +15 mv versus OCP with a scan rate of 0.16667 mV/s.

### Measurement of Open Circuit Potential

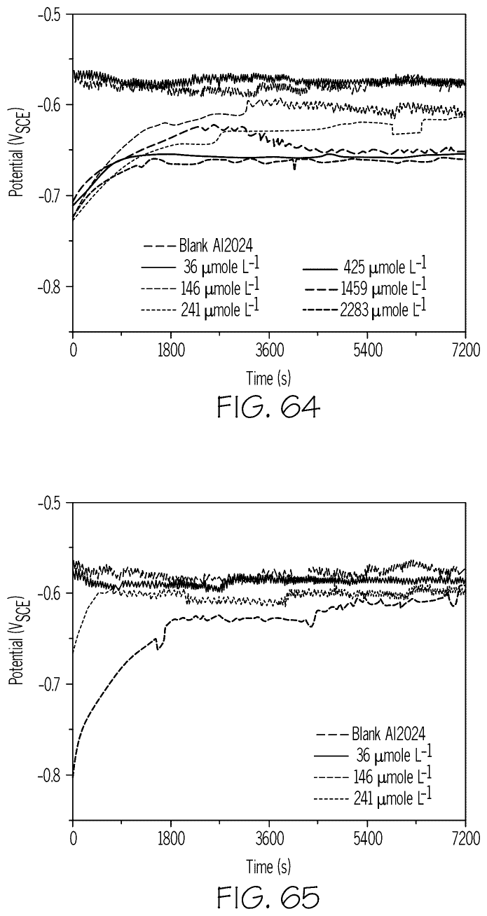

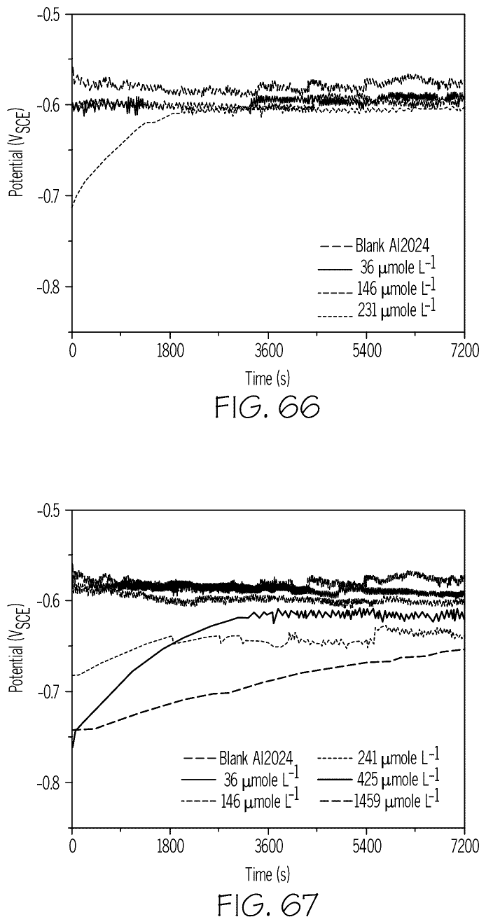

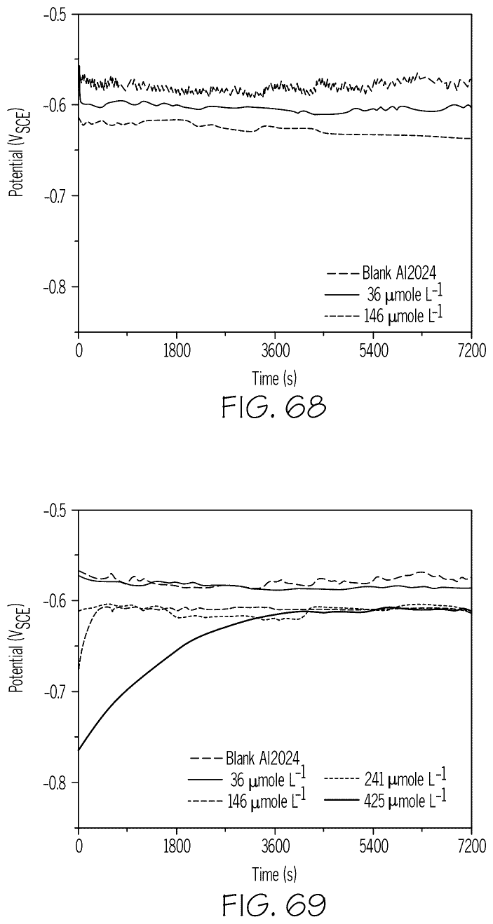

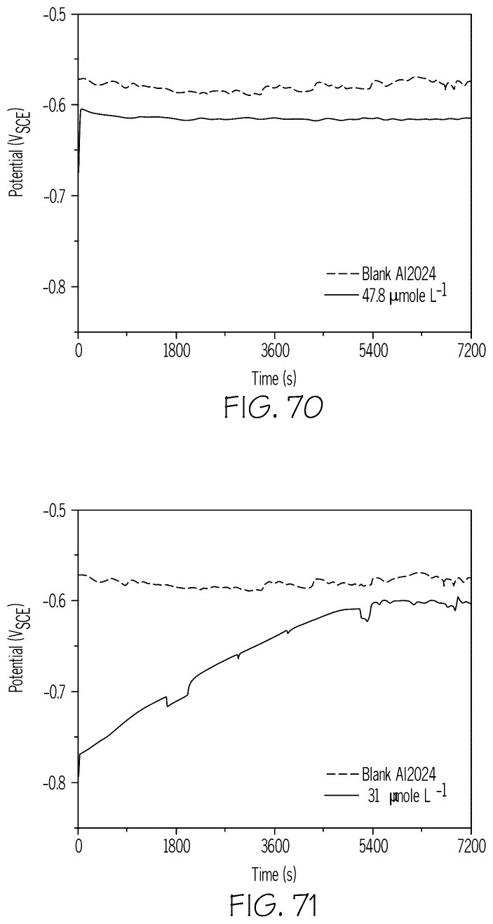

FIG. 64-71 show the OCP values for Al 2024 in 0.9 M NaCl solution mixed with inhibitors CI1-CI8, respectively at various inhibitor concentrations. In general, increasing the inhibitor concentration makes the Al 2024 surface more cathodic as evident by an increase in OCPs in more negative potentials as the inhibitor concentration increases. This also suggests that all corrosion inhibitors used in this study are the cathodic corrosion inhibitors. It was found that the OCP values of Al 2024 with inhibitor concentrations of 0 (blank) and 36 μmole L⁻¹ quickly reached steady state since the beginning of OCP measurements. It was also observed that increasing the inhibitor concentrations higher than 146 μmole L⁻¹ generally caused the OCP stabilization took longer. The highest concentrations used for CI1-CI6 are their saturated concentrations. For CI7 and CI8 that have low solubility, the only concentration tested was their saturated concentration.

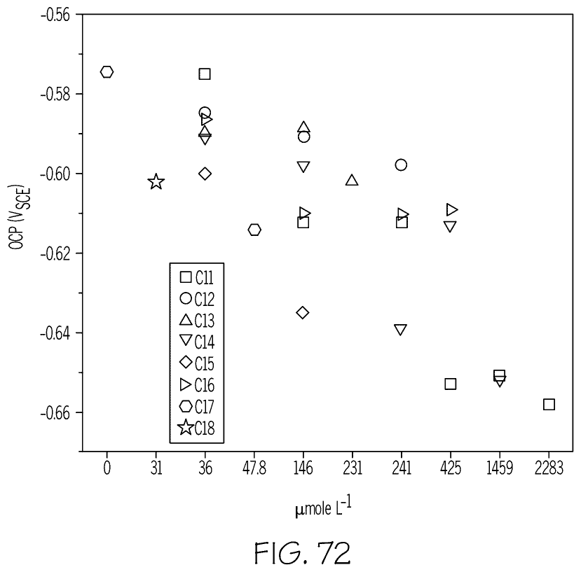

FIG. 72 and Table 27 shows the final OCP values for inhibitors 1-8 from FIGS. 64-71. From the final OCP values shown in FIG. 72, it can be clearly seen that the most negative OCP values of Al 2024 are found in the specimens tested at the highest inhibitor concentration for each inhibitor type whereas the most positive ones are at the lowest inhibitor concentration. The most positive (−0.575 V vs SCE) and negative (−0.658 V vs SCE) OCP values belong to Al 2024 tested with CI1 at concentrations of 36 and 2,283 μmole L⁻¹, respectively.

TABKE 27
Final OCP of Al 2024 in 0.9M NaCl solution with corrosion inhibitors 1-8 at
various concentrations.

| | OCP (V_{SCE}) | | | | | | | | | |
|---|---|---|---|---|---|---|---|---|---|---|
| | | 31 mole | 36 | 47.8 | 146 | 231 | 240 | 425 | 1459 | 2283 |
| Inhibitor | 0 mole | mole | mole | mole | mole | mole | mole | mole | mole | mole |
| code | L⁻¹ | L⁻¹ | L⁻¹ | L⁻¹ | L⁻¹ | L⁻¹ | L⁻¹ | L⁻¹ | L⁻¹ | L⁻¹ |
| CI1 | −0.574 | N/A | −0.575 | N/A | −0.612 | N/A | −0.612 | −0.653 | −0.651 | −0.658* |
| CI2 | | N/A | −0.585 | N/A | −0.591 | N/A | −0.598* | N/A | N/A | N/A |
| CI3 | | N/A | −0.590 | N/A | −0.589 | −0.602* | N/A | N/A | N/A | N/A |
| CI4 | | N/A | −0.591 | N/A | −0.598 | N/A | −0.639 | −0.613 | −0.652* | N/A |
| CI5 | | N/A | −0.600 | N/A | −0.635* | N/A | N/A | N/A | N/A | N/A |
| CI6 | | N/A | −0.587 | N/A | −0.610 | N/A | −0.610 | −0.609* | N/A | N/A |
| CI7 | | N/A | N/A | −0.614* | N/A | N/A | N/A | N/A | N/A | N/A |
| CI8 | | −0.602* | N/A | N/A | N/A | N/A | N/A | N/A | N/A | N/A |

*Saturation
CI7 and CI8 have very low solubility

In order to evaluate the performance of corrosion inhibitors in inhibiting corrosion on LHE ZnNi coated steel, some inhibitor types tested for Al 2024 as shown in FIG. 72 and Table 27 were selected again and tested for LHE ZnNi-coated steel samples. The selected inhibitors include CI1 (bishiosemicarbazone of isophthalaldehyde), CI2 (thiosemicarbazone of Salicylaldehyde), CI4 (thiosemicarbazone of 2-pyridine carboxyaldehyde), and CI6 (4-ethyl-3-thiosemicarbazone of isophthalaldehyde). Besides, other corrosion inhibitors, i.e. CI9 (terephthalaldehyde & 4methylthiosemicarbazide), CI10 (2,6-diacetylpyridine & 4-phenyl 3-thiosemicarbazide), and CI11 (4-methylthiosemicarbazide & 2,6-diacetylpyridine) were also tested. Noting that these three inhibitors (CI9, CI10, and CI11) were not tested for Al 2024.

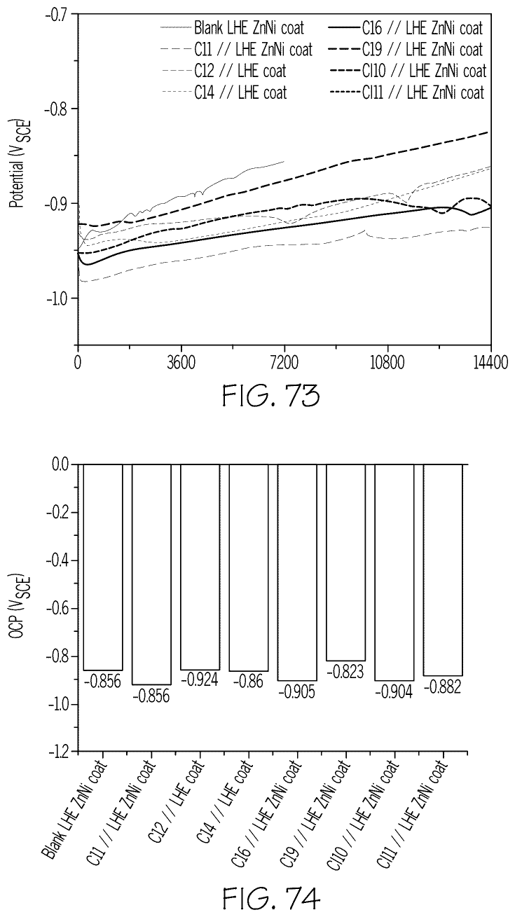

The OCP values of LHE ZnNi coated steel samples in 0.9 M NaCl solution saturated with different inhibitors are presented in FIG. 73, and the final OCP values are presented in FIG. 74. The saturation concentration for each corrosion inhibitor is the concentration with a single asterisk in Table 27. Unlike Al 2024 at various inhibitor types and concentrations (FIG. 72), none of the LHE ZnNi coated steel specimens at different inhibitor types reached steady state after 4 hours of OCP measurements. The OCP keeps increasing with increasing the test duration. The continuous OCP increase of LHE ZnNi-coated steel in the blank solution may indicate that the formation of protective film on the surface. With the OCP of −0.924 V vs SCE (FIG. 74 and Table 28), the LHE ZnNi coating is clearly more active than its C1008 substrate with the OCP of −0.738 V vs SCE. This may suggest that ZnNi coating acts as a sacrificial coating where Zn sacrificially corrodes to provide a cathodic protection to the underlying C1008 steel substrate. The shift in OCPs to more negative OCP values with addition of corrosion inhibitors clearly demonstrates that the LHE ZnNi coating surface becomes electrochemically more active in the presence of inhibitor.

TABLE 28
Final OCPs of Al LHE ZnNi coated C1008
steel in 0.9 M NaCl solution with various
corrosion inhibitors from FIG. 74.

| Inhibitor code | OCP (VSCE) |
|---|---|
| Blank LHE ZnNi coat | −0.856 |
| CI1//LHE ZnNi coat | −0.924 |
| CI2//LHE ZnNi coat | −0.860 |
| CI4//LHE ZnNi coat | −0.862 |
| CI6//LHE ZnNi coat | −0.905 |
| CI9//LHE ZnNi coat | −0.823 |
| CI10//LHE ZnNi coat | −0.904 |
| CI11//LHE ZnNi coat | −0.882 |

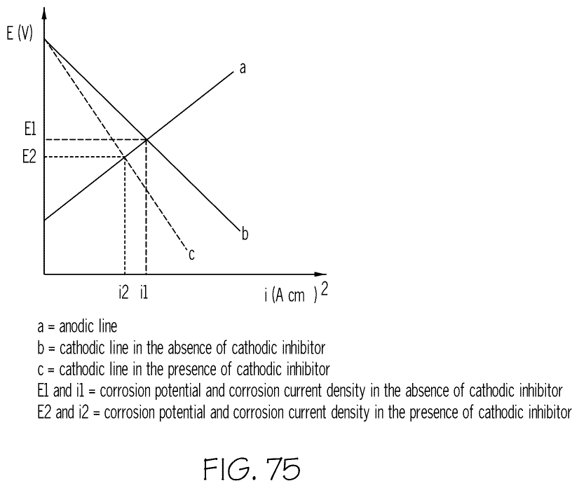

FIG. 75 shows an Evans diagram of a metal with and without cathodic inhibitor. An Evans diagram is a pictorial that depict the graphical representation between an electrode's kinetic data (or current densities) and thermodynamics (or potential) in a corrosive process. This diagram shows that an addition of cathodic corrosion inhibitor shifts the corrosion potential to a more negative potential and lowers corrosion current density. This decrease in corrosion potential with an addition of cathodic corrosion inhibitor reasonable agrees with the decreases in OCP with an addition of corrosion inhibitors presented in FIGS. 72-74.

### Measurement of Corrosion Rate and Inhibitor Efficiencies

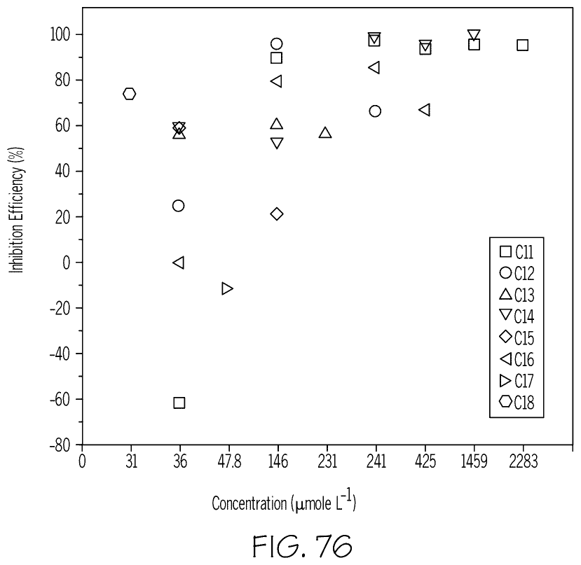

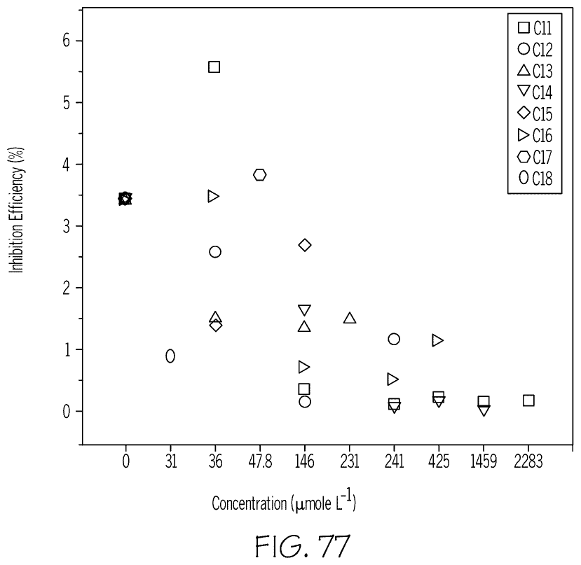

The corrosion rates and corresponding inhibitor efficiencies of Al 2024 in 0.9 M NaCl solution with different corrosion inhibitor types and concentrations are presented in FIGS. 76 and 77, respectively. In general, increasing the inhibitor concentration that makes the surface more active (FIG. 72) tends to slow down the corrosion rate for all types corrosion inhibitors (FIG. 76) and increases the inhibitor efficiency (FIG. 77). This trend is in agreement with the Evans diagram for cathodic inhibitor shown in FIG. 75. Inhibition efficiency higher than 90% was found in corrosion inhibitors CI1 (bis-thiosemicarbazone of isophthalaldehyde) and 4 (Thiosemicarbazone of 2-pyridine carboxyaldehyde) at concentrations higher than 146 μmole L⁻¹, suggesting that these two corrosion inhibitors are good candidates for inhibiting corrosion of Al 2024. The highest inhibitor efficiency of these two corrosion inhibitors are around 95% at concentration of 1459 μmole L⁻¹.

The corrosion rates of Al 2024 and all specimens in this study were calculated from the LPR curves of the corresponding specimens. The polarization resistance (Rp) and corrosion rate values of Al 2024 with various corrosion inhibitor types and concentrations are listed in Tables 29 and 30, respectively. As can be seen in Table 29, the Rp values generally tend to increase with increasing the inhibitor concentration which in turn decreasing the corrosion rates (Table 20) and increasing the inhibitor efficiencies (Table 31).

TABLE 29
Polarization resistance of Al 2024 with corrosion inhibitors 1-8 at various
concentrations:

| | Rp (Ω cm²) | | | | | | | | | |
|---|---|---|---|---|---|---|---|---|---|---|
| | 0 | 31 | 36 | 47.8 | 146 | 231 | 240 | 425 | 1459 | 2283 |
| Inhibitor | μmole | μmole | μmole | μmole | μmole | μmole | μmole | μmole | μmole | μmole |
| code | L₋₁ | L₋₁ | L₋₁ | L₋₁ | L₋₁ | L₋₁ | L₋₁ | L₋₁ | L₋₁ | L₋₁ |
| CI1 | 3,315 | N/A | 2,048 | N/A | 30,736 | N/A | 89,295 | 48,263 | 66,651 | 63,325 |
| CI2 | | N/A | 4,424 | N/A | 67,761 | N/A | 9,750 | N/A | N/A | N/A |
| CI3 | | N/A | 7,508 | N/A | 8,284 | 7,574 | N/A | N/A | N/A | N/A |
| CI4 | | N/A | 8,103 | N/A | 6,919 | N/A | 125,041 | 60,693 | 298,351 | N/A |
| CI5 | | N/A | 8,036 | N/A | 4,216 | N/A | N/A | N/A | N/A | N/A |
| CI6 | | N/A | 3,281 | N/A | 15,767 | N/A | 21,986 | 9,853 | N/A | N/A |
| CI7 | | N/A | N/A | 2,958 | N/A | N/A | N/A | N/A | N/A | N/A |
| CI8 | | 12,566 | N/A | N/A | N/A | N/A | N/A | N/A | N/A | N/A |

TABLE 30
Corrosion rates of Al 2024 with corrosion inhibitors 1-8 at various
concentrations:

| | Corrosion rate (mpy) | | | | | | | | | |
|---|---|---|---|---|---|---|---|---|---|---|
| | 0 | 31 | 36 | 47.8 | 146 | 231 | 240 | 425 | 1459 | 2283 |
| Inhibitor | μmole | μmole | μmole | μmole | μmole | μmole | μmole | μmole | μmole | μmole |
| code | L₋₁ | L₋₁ | L₋₁ | L₋₁ | L₋₁ | L₋₁ | L₋₁ | L₋₁ | L₋₁ | L₋₁ |
| CI1 | 3.45 | N/A | 5.58 | N/A | 0.37 | N/A | 0.12 | 0.23 | 0.17 | 0.18 |
| CI2 | | N/A | 2.58 | N/A | 0.16 | N/A | 1.38 | N/A | N/A | N/A |
| CI3 | | N/A | 1.52 | N/A | 1.38 | 1.51 | N/A | N/A | N/A | N/A |
| CI4 | | N/A | 1.41 | N/A | 1.65 | N/A | 0.09 | 0.18 | 0.04 | N/A |
| CI5 | | N/A | 1.42 | N/A | 2.71 | N/A | N/A | N/A | N/A | N/A |
| CI6 | | N/A | 3.48 | N/A | 0.72 | N/A | 0.52 | 1.16 | N/A | N/A |
| CI7 | | N/A | N/A | 3.86 | N/A | N/A | N/A | N/A | N/A | N/A |
| CI8 | | 0.91 | N/A | N/A | N/A | N/A | N/A | N/A | N/A | N/A |

TABLE 31
Inhibitor efficiency of Al 2024 with corrosion inhibitors 1-8 at various concentrations:

| | Inhibition Efficiency (%) | | | | | | | | |
|---|---|---|---|---|---|---|---|---|---|
| | 31 | 39 | 47.8 | 146 | 231 | 240 | 425 | 1459 | 2283 |
| Inhibitor | μmole | μmole | μmole | μmole | μmole | μmole | μmole | μmole | μmole |
| code | L₋₁ | L₋₁ | L₋₁ | L₋₁ | L₋₁ | L₋₁ | L₋₁ | L₋₁ | L₋₁ |
| CI1 | N/A | -61.89 | N/A | 89.21 | N/A | 96.29 | 93.13 | 95.03 | 94.76 |
| CI2 | N/A | 25.06 | N/A | 95.11 | N/A | 65.99 | N/A | N/A | N/A |
| CI3 | N/A | 55.84 | N/A | 59.97 | 56.22 | N/A | N/A | N/A | N/A |
| CI4 | N/A | 59.08 | N/A | 52.08 | N/A | 97.35 | 94.53 | 98.89 | N/A |
| CI5 | N/A | 58.74 | N/A | 21.35 | N/A | N/A | N/A | N/A | N/A |
| CI6 | N/A | −1.05 | N/A | 78.97 | N/A | 84.92 | 66.35 | N/A | N/A |
| CI7 | N/A | N/A | −12.08 | N/A | N/A | N/A | N/A | N/A | N/A |
| CI8 | 73.61 | N/A | N/A | N/A | N/A | N/A | N/A | N/A | N/A |

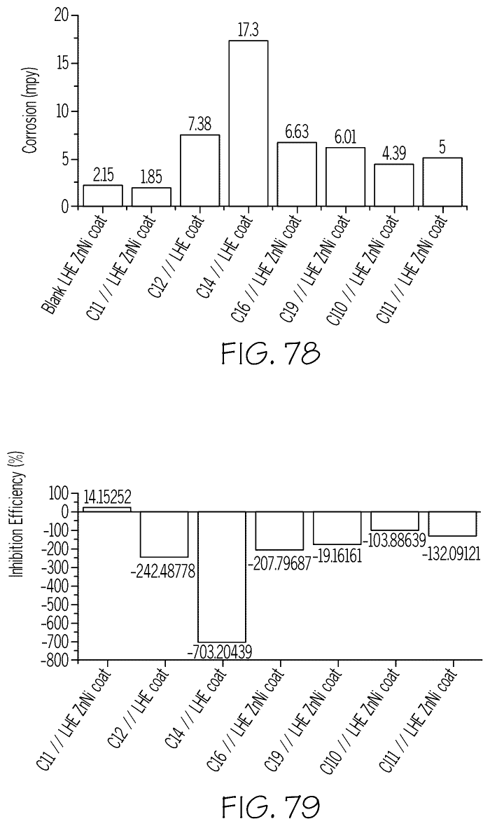

Due to CI1 and CI4 lowest corrosion rate and highest inhibitor efficiency at their highest concentrations (their saturated concentrations), these two saturated inhibitors along with saturated CI2 (Thiosemicarbazone of Salicylaldehyde), CI6 (4-ethyl-3-thiosemicarbazone of isophthalaldehyde), CI9 (terephthalaldehyde & 4-methylthiosemicarbazide), CI10 (2,6Diacetylpyridine & 4-phenyl 3-thiosemicarbazide), and CI11 (4-methylthiosemicarbazide & 2,6diacetylpyridine) were tested for LHE ZnNi coated steel samples. As can be seen in FIG. 78, the lowest corrosion rate is found in the LHE ZnNI coated steel in a solution containing saturated CI1 which is 1.85 mpy whereas the highest one is in saturated CI4 which is 17.3 mpy. From the inhibitor efficiency calculation (FIGS. 78 and 79), only CI1 gives positive inhibitor efficiency. The other corrosion inhibitors produce negative efficiency, meaning an addition of those saturated corrosion inhibitors makes the corrosion rate of LHE ZnNI coated steel high compared to the one in blank solution. Based on the findings in FIGS. 76-79, only corrosion inhibitor CI1 (bis-hiosemicarbazone of isophthalaldehyde) would be mixed with various epoxies to produce the corrosion inhibitor-containing coatings. The results of such coatings are presented in the next sub-section below.

TABLE 32
Polarization resistance and corrosion rates of
Al 2024 with corrosion inhibitors CI1-CI8:

| | Rp | Corrosion | Inhibition |
|---|---|---|---|
| Inhibitor code | (Ω cm²) | rate (mpy) | Efficiency (%) |
| Blank LHE ZnNi coat | 5525.52 | 2.15 | N/A |
| CI1//LHE ZnNi coat | 6436.44 | 1.85 | 14.15 |
| CI2//LHE ZnNi coat | 1613.35 | 7.38 | −242.49 |
| CI4//LHE ZnNi coat | 687.93 | 17.30 | −703.20 |
| CI6//LHE ZnNi coat | 1795.18 | 6.63 | −207.80 |
| CI9//LHE ZnNi coat | 1979.33 | 6.01 | −179.16 |
| CI10//LHE ZnNi coat | 2710.10 | 4.39 | −103.89 |
| CI11//LHE ZnNi coat | 2380.75 | 5.00 | −132.09 |

In summary, the role of inhibitor concentrations, epoxy coatings, and epoxy plus bis-hiosemicarbazone of isophthalaldehyde corrosion inhibitor on the corrosion protection of bare Al 2024, bare C1008 steel, and LHE ZnNi-coated C1008 steel was investigated in this study. Based on our findings, it was found that:
A. Increasing the corrosion inhibitor concentrations generally shifted the OCPs of Al 2024 to more negative potentials, decreased the corrosion rates, and increased the inhibitor efficiencies.
B. In general, the higher the corrosion inhibitor concentration, the lower (more negative) the OCP and corrosion rate.
C. An addition of CI1 (bis-hiosemicarbazone of isophthalaldehyde), CI2 (thiosemicarbazone of Salicylaldehyde), CI4 (thiosemicarbazone of 2-pyridine carboxyaldehyde), and CI6 (4ethyl-3-thiosemicarbazone of isophthalaldehyde). CI9 (terephthalaldehyde & 4methylthiosemicarbazide), CI10 (2,6-diacetylpyridine & 4-phenyl 3-thiosemicarbazide), and CI11 (4-methylthiosemicarbazide & 2,6-diacetylpyridine) to 0.9 M NaCl solution made the surface of LHE ZnNI-coated steel electrochemically more active. This may suggest that these inhibitors are cathodic inhibitors.

### Statistical Analysis Electrochemistry of Inhibitors

The responses of interest analyzed from the experiments were (1) the polarization resistance (Rp), (2) Initial resistance to polarization as determine from electrochemical impedance (Initial EIS Rp), (3) Final resistance to polarization as determine from electrochemical impedance (Final EIS Rp), (4) Corrosion Rate and (5) Corrosion Rate MPY (mils per year). The goal was to maximize responses (1)-(3) and minimize responses (4)-(5). Currently 66 experiments have been completed, 33 conducted in the United States and 33 conducted in India. Of these experiments, there is currently information on the inhibitor concentrations at which the experiments were conducted for 47 experiments. Additionally, 48 of the 66 experiments were run at saturation. Note that 37 of the experiments run at saturation have only the Rp response measured. The experiments consist of 8 aldehyde levels in combination with 5 different thiosemicarbazide level. The 8 aldehyde levels include (1) Isophthalaldehyde (base), (2) Diacetyl pyridine (dp), (3) Hexanedione (hex), (4) Hydroxyquinoline carboxyaldehyde (hc), (5) Pentandione (p), (6) Pyridine carboxyaldehyde (pc), (7) Salicylaldehyde(s), and (8) Terephthalaldehyde (t). The 5 thiosemicarbazide levels include: (1) Thiosemicarbazide (base), (2) Phenyl Thiosemicarbazide (phenyl), (3) Ethyl Thiosemicarbazide (ethyl), (4) Methyl Thiosemicarbazide (methyl), and (5) Thiocarbohydrazide (thioc).

In the following analyses, the baseline combination consists of the isophthalaldehyde with the thiosemicarbazide combination. Table 33 consists of the total number of experiments currently available for each combination.

TABLE 33
Total number of experiments conducted for each combination of the aldehydes with
the thiosemicarbazide, from experiments conducted in the US and in India.

| | | Ethyl | Methyl | Phenyl | |
|---|---|---|---|---|---|
| | Thiosemi- | Thiosemi- | Thiosemi- | Thiosemi- | Thiocarbo- |
| | carbazide | carbazide | carbazide | carbazide | hydrazide |
| | (base) | (ethyl) | (methyl) | (phenyl) | (thioc) |
| Isophthalaldehyde (base) | 9 | 6 | 0 | 4 | 0 |
| Diacetyl Pyridine (dp) | 5 | 0 | 0 | 2 | 0 |
| Hexanedione (hex) | 2 | 0 | 0 | 2 | 0 |
| Hydroxyquinoline | 4 | 0 | 0 | 1 | 0 |
| Carboxyaldehyde (hc) | | | | | |
| Pentandione (p) | 4 | 0 | 0 | 1 | 0 |
| Pyridine | 6 | 0 | 0 | 0 | 0 |
| Carboxyaldehyde (pc) | | | | | |
| Salicylaldehyde (s) | 6 | 2 | 1 | 2 | 2 |
| Terephthalaldehyde (t) | 2 | 2 | 0 | 3 | 0 |

Since some of the experiments were run at saturation and some of the experiments do not contain inhibitor concentration information, the data is subset as (1) experiments for which the inhibitor concentration are known and (2) experiments that were run at saturation. In the following subsections, Table 33 will be subset and analyzed with three different analyses, two of which are focused on experiments that have inhibitor concentration information available and the last analysis focused on experiments run with combinations at saturation.

Analyses with Inhibitor Concentration Information

Table 34 provides the number of experiments for each experiment that contain inhibitor concentration information.

TABLE 34
Total number of experiments conducted with inhibitor concentration
information available for each combination of the aldehydes with the
thiosemicarbazide, from experiments conducted in the US and in India.

| | | Ethyl | Methyl | Phenyl |
|---|---|---|---|---|
| | Thiosemi- | Thiosemi- | Thiosemi- | Thiosemi- |
| | carbazide | carbazide | carbazide | carbazide |
| | (base) | (ethyl) | (methyl) | (phenyl) |
| Isophthalaldehyde (base) | 9 | 6 | 0 | 4 |
| Diacetyl Pyridine (dp) | 5 | 0 | 0 | 0 |
| Hydroxyquinoline | 4 | 0 | 0 | 1 |
| Carboxyaldehyde (hc) | | | | |
| Pyridine | 6 | 0 | 0 | 0 |
| Carboxyaldehyde (pc) | | | | |
| Salicylaldehyde (s) | 6 | 0 | 1 | 0 |
| Terephthalaldehyde (t) | 2 | 0 | 0 | 3 |

Since there are some combinations for which experiments have not yet been run, a subset of Table 34 will be used for analysis. For Analysis 1, only the first column of the table will be used in which the different aldehyde levels in combination with the thiosemicarbazide base level will be compared to the baseline (isophthalaldehyde with thiosemicarbazide). For Analysis 2, the first and last columns of the table will be used with the first, third, and last row to compare the combinations of isophthalaldehyde with phenyl thiosemicarbazide, hydroxyquinoline carboxyaldehyde with thiosemicarbazide and with phenyl thiosemicarbazide, and terephthalaldehyde with thiosemicarbazide and with phenyl thiosemicarbazide to the baseline combination.

Lastly, the experiments conducted in India only had the Rp response measured. For Analysis 1 and Analysis 2 since all the responses will be modeled, the data is subset to experiments conducted in the US only for consistency. The experiments conducted in India are included in the model in Analysis 3, in which focus is on the experiments at saturation with the Rp response modeled.

### Analysis 1-Effect of Aldehyde/Ketone

Table 35 provides more details on the experiments in column 1 in Table 34, including the inhibitor concentrations at which the experiments were completed. Note that there were multiple experiments conducted for some of the inhibitor concentrations, indicated in parenthesis. Also indicated in the parenthesis are the number of experiments for which only the Rp response is available (meaning the experiment was conducted at saturation).

TABLE 35
Experiments used in Analysis 1 in which thiosemicarbazide
with different levels of the aldehydes are modeled and include
inhibitor concentration information for US experiments only.

| | Thiosemi- | |
|---|---|---|
| | carbazide | Inhibitor |
| | (base) | Concentrations |
| Isophthalaldehyde | 8 | 36, 146 (2), 241, 425, |
| (base) | | 1459, 2283 |
| Diacetyl Pyridine (dp) | 1 | 32 |
| Hydroxyquinoline | 4 | 36, 146, 231 (2, 1 has |
| carboxyaldehyde (hc) | | Rp only) |
| Pyridine | 6 | 36, 146, 241, 425, 1459 |
| carboxyaldehyde (pc) | | (2, 1 has Rp only) |
| Salicylaldehyde (s) | 4 | 36, 146, 241 (2, 1 has |
| | | Rp only) |
| Terephthalaldehyde (t) | 1 | 36 |

To analyze the data, a model of the following form was fit using multiple linear regression model fitting techniques:

$${log}_{10} {Y}_{i} = {β}_{0} + {β}_{dp} Aldehyde + {β}_{hc} Aldehyde + {β}_{pc} Aldehyde + {β}_{s} Aldehyde + {β}_{t} Aldehyde + {β}_{IC} {log}_{10} IC + {β}_{IC X dc} {log}_{10} IC X Aldehyde + {β}_{IC X hc} {log}_{10} IC X Aldehyde + {β}_{IC X pc} {log}_{10} IC X Aldehyde + {β}_{IC X s} {log}_{10} IC X Aldehyde + {β}_{IC X t} {log}_{10} IC X Aldehyde$$

In this model, the logarithm base 10 of the responses, Yᵢ, and the inhibitor concentrations, IC, were used. The model estimates coefficients for the effect of inhibitor concentration, for the main effect of each aldehyde as well as the interaction effect between each aldehyde and the inhibitor concentration. This provides information on both the effect of each aldehyde on the response compared to the baseline combination, as well as the effect of each aldehyde on the response as inhibitor concentration increases. In what follows, the graph and explanation of the results are provided for each response as well as the multiple R² for each model. The multiple R², which takes values between 0% and 100%, is a measure of how well the regression model fits the data, with a multiple R² of 100% indicating a perfect fit of the model.

In the graphs, the different aldehydes are the baseline, pyridine carboxyaldehyde (pc), hydroxyquinoline carboxyaldehyde (hc), salicylaldehyde(s), terephthalaldehyde (t), and diacetyl pyridine (dp). The points represent the predicted mean value using the regression fit for the aldehyde at a given inhibitor concentration, with the solid lines providing the regression model fit. The dashed lines above and below are 95% confidence bounds around the regression curve. In the case where there are observations at only one inhibitor concentration, an “x” is plotted above and below the mean value to represent upper and lower confidence bounds. Note that the confidence bounds indicate that the mean value of the response at a given inhibitor concentration would take value between the lower and upper bounds with 95% confidence. Overlaps in the confidence bounds for an aldehyde with the baseline confidence bounds indicate that there is no significant difference between in the mean value of the response for the aldehyde compared to the baseline at a given inhibitor concentration level. Lastly, any conclusions about significant differences are based on the range of inhibitor concentration tested for a particular aldehyde; conclusions are not being extrapolated to untested inhibitor concentration levels.

### Rp Results

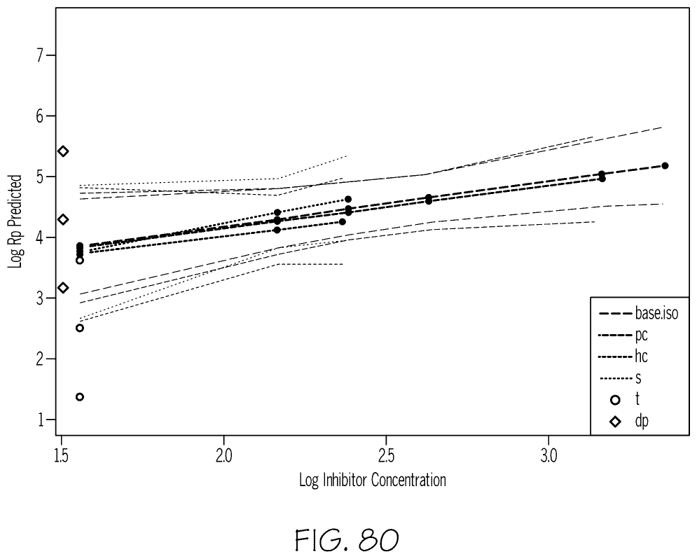

Referring to FIG. 80, the multiple R² of the Rp model is 67%, which indicates a reasonable fit of the model to the data. Based on the results in FIG. 80, the conclusions are as follow:
1. As inhibitor concentration increases, the Rp increases for all aldehydes, except terephthalaldehyde (t) and diacetyl pyridine (dp) for which there is not enough information to draw conclusions on the slope.
2. For a given inhibitor concentration, the Rp response is (A) Significantly higher for diacetyl pyridine (dp) compared to the baseline at inhibitor concentration 32 (based on one observation), (B) Not significantly different for the remaining aldehydes compared to the baseline.

### Initial EIS Rp Results

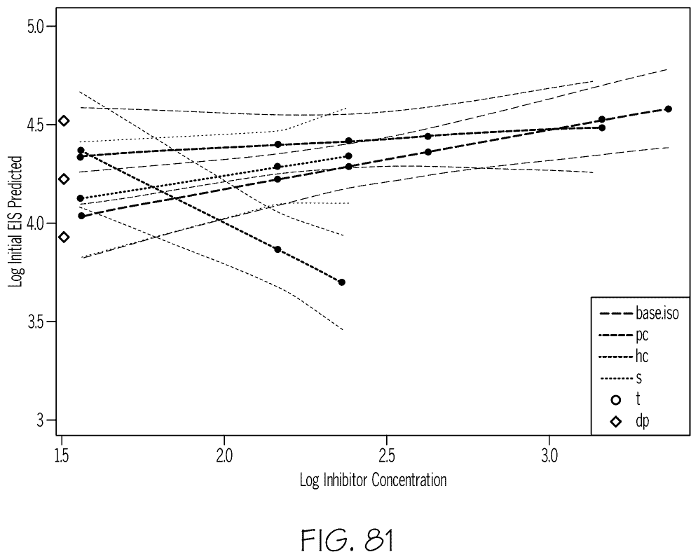

Referring to FIG. 81, the multiple R² for the Initial EIS Rp model is 83%, indicating a good fit of the model to the data. Based on the results in FIG. 81, the conclusions are as follows:
1. As inhibitor concentration increases, the Initial EIS Rp increases for all aldehydes except (A) Hydroxyquinoline carboxyaldehyde (hc) for which the Initial EIS Rp decreases, (B) Diacetyl pyridine (dp) for which there is not enough information to draw conclusions on the slope.
2. For a given inhibitor concentration, the Initial EIS Rp is (A) Significantly lower for the hydroxyquinoline carboxyaldehyde (hc) compared to the baseline for inhibitor concentrations greater than 146. (B) Not significantly different for the remaining aldehydes compared to the baseline
3. No Initial EIS Rp values were recorded for terephthalaldehyde (t), so conclusions do not apply for this aldehyde.

### Final EIS Rp Results

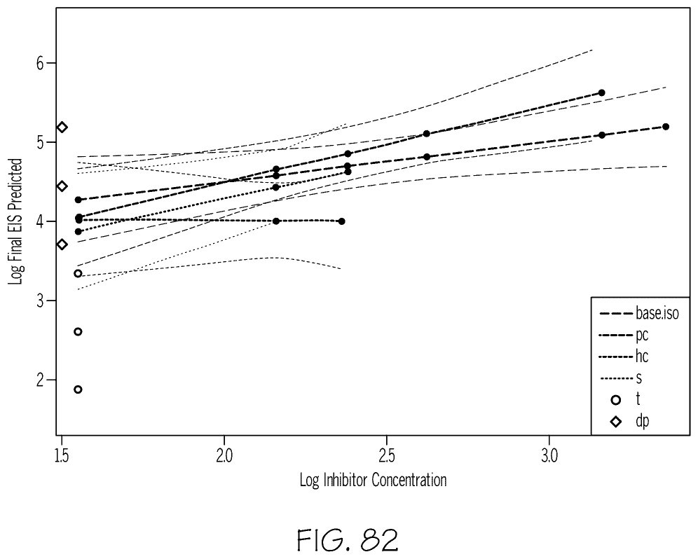

Referring to FIG. 82, the multiple R₂ for the Final EIS Rp response is 88%, indicating a good fit of the model to the data. Based on the results in FIG. 82, the conclusions are as follows:
1. As inhibitor concentration increases, the Final EIS Rp o Increases for the baseline, pyridine carboxyaldehyde (pc), and salicylaldehyde(s). (A) Not enough evidence to conclude that the slope for hydroxyquinoline carboxyaldehyde (hc) is different than the baseline. (B) Not enough information to draw conclusions on the slopes for terephthalaldehyde (t) and diacetyl pyridine (dp).
2. For a given inhibitor concentration, the Final EIS Rp is (A) Significantly lower for terephthalaldehyde (t) compared to the baseline (based on one observation) at inhibitor concentration 36, (B) Not significantly different for the remaining aldehydes compared to the baseline.

### Corrosion Rate Results

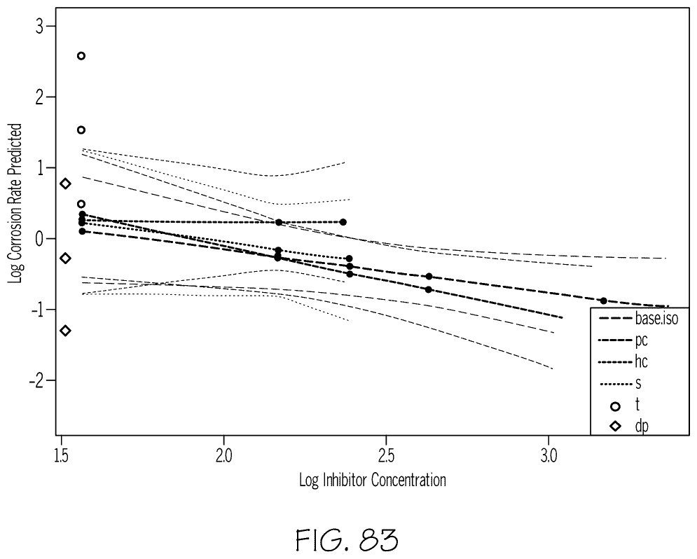

Referring to FIG. 83, The multiple R² for the Corrosion Rate model is 76% which indicates a reasonable fit of the model to the data. Based on the results in FIG. 83, the conclusions are as follows:
1. As inhibitor concentration increases, the Corrosion Rate (A) Decreases for the baseline, pyridine carboxyaldehyde (pc), and salicylaldehyde, (B) Not enough evidence to conclude that the slope for hydroxyquinoline carboxyaldehyde (hc) is different than the baseline. (C) Not enough information to draw conclusions on the slopes for terephthalaldehyde (t) and diacetyl pyridine (dp).
2. For a given inhibitor concentration, the Corrosion Rate is (A) Significantly higher for terephthalaldehyde (t) as compared to the baseline (based on one observation) at inhibitor concentration 36. (B) Not significantly different for the remaining aldehydes compared to the baseline.

### Corrosion Rate MPY Results

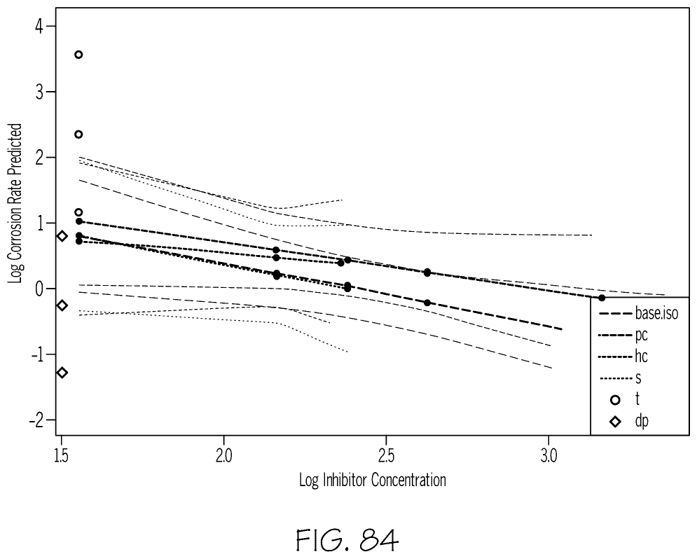

Referring to FIG. 84, the multiple R² of the Corrosion Rate MPY model is 76% which indicates a reasonable fit of the model to the data. Based on the results in FIG. 84, the conclusions are as follows:
1. As inhibitor concentration increases, the Corrosion Rate MPY (A) Decreases for all aldehydes except terephthalaldehyde (t) and diacetyl pyridine (dp), for which there is not enough information to draw conclusions on the slope.
2. For a given inhibitor concentration, the Corrosion Rate MPY is (A) Significantly higher for terephthalaldehyde (t) as compared to the baseline (based on one observation) at inhibitor concentration 36, (B) Not significantly different for the remaining aldehydes compared to the baseline.

### Effect of Addition of Phenyl Ring to Thiosemicarbazide

Analysis 2 was completed using the data the following Table 36. The setup of this analysis is an extension of Analysis 1, with the addition of phenyl thiosemicarbazide and fewer aldehyde levels. Note that the baseline in this analysis is thiosemicarbazide with isophthalaldehyde combination.

TABLE 36
Experiments used in analysis 2 in which thiosemicarbazide
and phenyl thiosemicarbazide with different
levels of the aldehydes are modeled and include inhibitor
concentration information for the US experiments only.

| | | Phenyl |
|---|---|---|
| | Thiosemi- | Thiosemi- |
| | carbazide | carbazide |
| | (base) | (phenyl) |
| Isophthalaldehyde | 8 inhibitor | 2 inhibitor |
| (base) | concentrations: | concentrations: |
| | 36, 146 (2), 241, | 36, 146 |
| | 425, 1459, 2283 | |
| | (2, 1 has Rp only) | |
| Hydroxyquinoline | 4 inhibitor | 1 Inhibitor |
| carboxyaldehyde | concentrations: | concentration: |
| (hc) | 36, 146, 231 | 31 |
| | (2, 1 has Rp only) | |
| Terephthalaldehyde | 1 Inhibitor | 1 inhibitor |
| (t) | concentration: 36 | concentrations: |
| | | 23 |

To analyze the data, a model of the following form was fit using multiple linear regression model fitting techniques:

$${log}_{10} {Y}_{i} = {β}_{0} + {β}_{hc X base} Combination 2 + {β}_{t X base} Combination 3 + {β}_{base X phenyl} Combination 4 + {β}_{hc X phenyl} Combination 5 + {β}_{t X phenyl} Combination 6 + {β}_{IC} {log}_{10} IC + {β}_{IC X hc X base} {log}_{10} IC X Combination 2 + {β}_{IC X t X base} {log}_{10} IC X Combination 3 + {β}_{IC X base X phenyl} {log}_{10} IC X Combination 4 + {β}_{IC X hc X phenyl} {log}_{10} IC X Combination 5 + {β}_{IC X t X phenyl} {log}_{10} IC X Combination 6$$

The interpretation of the model is similar to that in Analysis 1 but now different combinations of the aldehydes and the thiosemicarbazides are considered along with the interaction between these combinations and the inhibitor concentration. In this model, there are 6 different combinations analyzed (as listed in the table above). In what follows, the graphs and results will be presented for each response. Note that the interpretation using the graph is similar to that of Analysis 1.

However, the colors and combinations are now the following: Combination 1: Baseline (isophthalaldehyde with thiosemicarbazide); Combination 2: Isophthalaldehyde with phenyl thiosemicarbazide; Combination 3: Hydroxyquinoline carboxyaldehyde (hc) with thiosemicarbazide; Combination 4: Hydroxyquinoline carboxyaldehyde (hc) with phenyl thiosemicarbazide; Combination 5: Terephthalaldehyde (t) with thiosemicarbazide; Combination 6: Terephthalaldehyde (t) with phenyl thiosemicarbazide.

### Rp Results

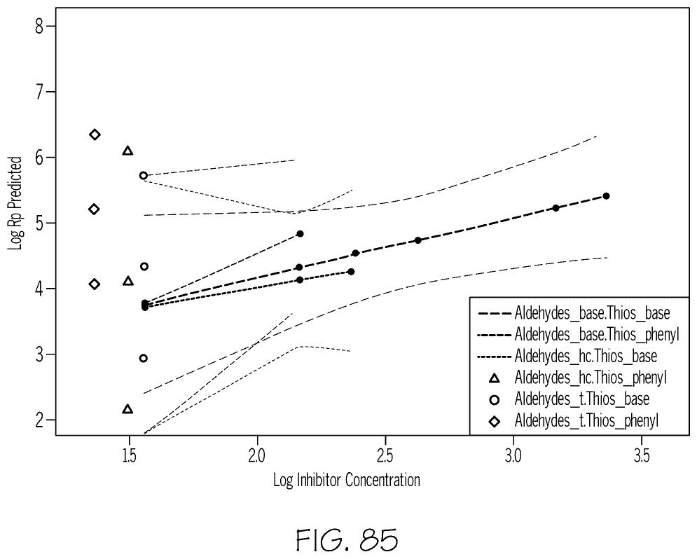

Referring to FIG. 85, the multiple R² of the Rp model is 82% which indicates a good fit of the model to the data. Based on the results in FIG. 85, the conclusions are as follow:
1. As inhibitor concentration level increases, the Rp response (A) Increases for the baseline, hydroxyquinoline carboxyaldehyde (hc) with thiosemicarbazide, and isophthalaldehyde with phenyl thiosemicarbazide, (B) Not enough info to draw conclusions on the slope for the remaining combinations.
2. At a specific inhibitor concentration, the Rp is (A) The terephthalaldehyde (t) with phenyl thiosemicarbazide combination, which results in significantly higher Rp than the baseline combination at inhibitor concentration 23 (based on one observation), (B) Not significantly different for any of the combinations as compared to the baseline.

### Initial EIS Rp Results

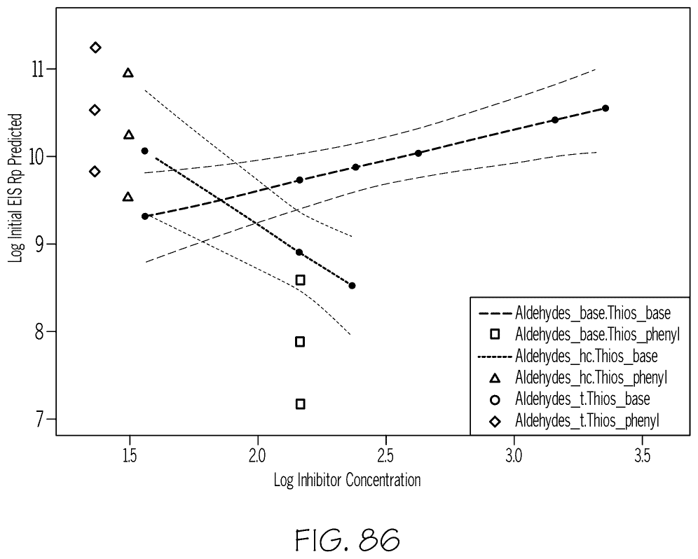

Referring to FIG. 86, the multiple R² of the Initial EIS Rp model is 94%, indicating a good fit of the model to the data. Based on the results in FIG. 86, the conclusions are as follow:
1. As inhibitor concentration level increases, the Initial EIS Rp response (A) Increases for the baseline, (B) Decreases for hydroxyquinoline carboxyaldehyde (hc) with thiosemicarbazide, (C) Not enough information to draw conclusions on the slopes for the remaining combinations.
2. At a specific inhibitor concentration, the Initial EIS Rp response is (A) Significantly lower for isophthalaldehyde with phenyl thiosemicarbazide than the baseline at inhibitor concentration 146 (based on one observation). (B) Significantly lower for hydroxyquinoline carboxyaldehyde (hc) with thiosemicarbazide than the baseline for inhibitor concentrations greater than 146. (C) Significantly higher for hydroxyquinoline carboxyaldehyde (hc) with phenyl thiosemicarbazide and terephthalaldehyde (t) with phenyl thiosemicarbazide than the baseline at inhibitor concentrations 31 and 23, respectively (each based on one observation).

### Final EIS Rp Results

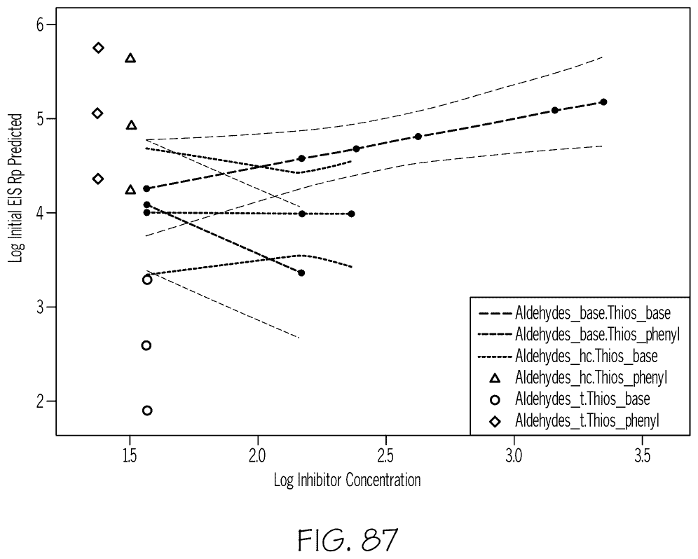

Referring to FIG. 87, the multiple R² of the Final EIS Rp model is 94%, indicating a good fit of the model to the data. Based on the results in FIG. 87, the conclusions are as follow:
1. As inhibitor concentration level increases, the Final EIS Rp response (A) Increases for the baseline. (B) Decreases for isophthalaldehyde with phenyl thiosemicarbazide. (C) There is not enough evidence to conclude that the slope of hydroxyquinoline carboxyaldehyde (hc) with thiosemicarbazide is significantly different than the baseline slope. (D) Not enough information to draw conclusions on the slope for the remaining combinations.
2. At a specific inhibitor concentration, the Final EIS Rp response is (A) Significantly lower for isophthalaldehyde with phenyl thiosemicarbazide for inhibitor concentrations greater than 146. (B) Significantly higher for hydroxyquinoline carboxyaldehyde (hc) with phenyl thiosemicarbazide and terephthalaldehyde (t) with phenyl thiosemicarbazide than the baseline at inhibitor concentrations 31 and 23, respectively (each based on one observation), (C) Significantly lower for terephthalaldehyde (t) with thiosemicarbazide than the baseline at inhibitor concentration 36 (based on one observation).

### Corrosion Rate Results

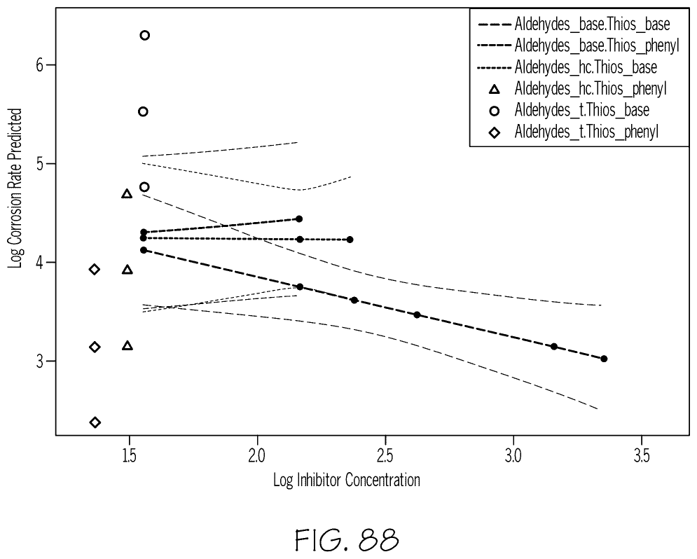

Referring to FIG. 88, the multiple R² of the Corrosion Rate model is 90%, indicating a good fit of the model to the data. Based on the results in FIG. 88, the conclusions are as follow:
1. As inhibitor concentration level increases, the Corrosion Rate (A) Decreases for the baseline. (B) Note enough evidence to conclude that isophthalaldehyde with phenyl thiosemicarbazide and hydroxyquinoline carboxyaldehyde (hc) with phenyl thiosemicarbazide have different slopes than the baseline. (C) Not enough information to draw conclusions on the slope for the remaining combinations.
2. At a specific inhibitor concentration, the Corrosion Rate is (A) Significantly higher for terephthalaldehyde (t) with thiosemicarbazide than the baseline at inhibitor concentration 36 (based on one observation). (B) Significantly lower for the terephthalaldehyde (t) with phenyl thiosemicarbazide than the baseline at inhibitor concentration 23 (based on one observation), (C) Not significantly different for the other combinations compared with the baseline.

### Corrosion Rate MPY Results

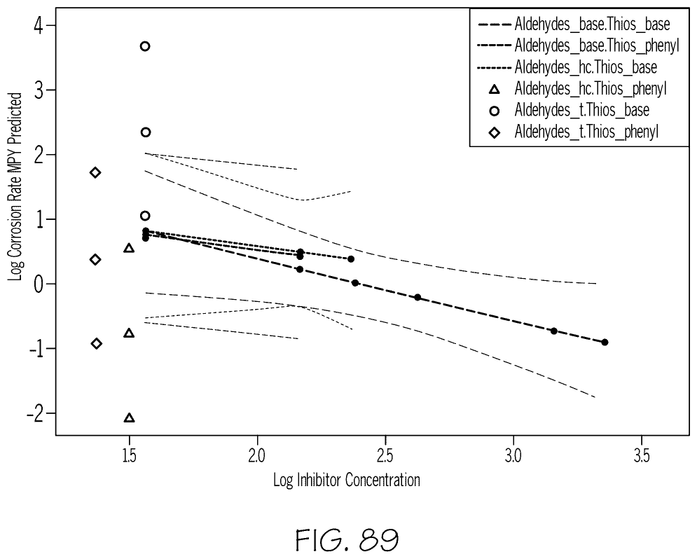

Referring to FIG. 89, the multiple R² of the Corrosion Rate MPY model is 84%, indicating a reasonable fit of the model to the data. Based on the results in FIG. 89, the conclusions are as follow:
1. As inhibitor concentration level increases, the Corrosion Rate MPY decreases for all combinations except hydroxyquinoline carboxyaldehyde (hc) with phenyl thiosemicarbazide, terephthalaldehyde (t) with thiosemicarbazide, terephthalaldehyde (t) with phenyl thiosemicarbazide for which there is not enough information to draw conclusions about the slope.
2. At a specific inhibitor concentration, the Corrosion Rate MPY is (A) Not significantly different for isophthalaldehyde with phenyl thiosemicarbazide or hydroxyquinoline carboxyaldehyde (hc) with thiosemicarbazide compared to the baseline, (B) Lower for hydroxyquinoline carboxyaldehyde (hc) with phenyl thiosemicarbazide than the baseline at inhibitor concentration 31 (based on one observation), (C) Higher for terephthalaldehyde (t) with thiosemicarbazide than the baseline at inhibitor concentration 36 (based on one observation).

### Summary of Analysis 1 and Analysis 2

In general for both Analysis 1 and Analysis 2, as inhibitor concentration increases, the Rp, Initial EIS Rp, and Final EIS Rp increase while Corrosion Rates decrease. This indicates that in the majority of the combinations, the results improve with increasing inhibitor concentration. Since the maximum inhibitor concentration at which the experiment can be conducted is the saturation value, this indicates that the optimal responses occur at saturation for several of the combinations. However, the hydroxyquinoline carboxyaldehyde with thiosemicarbazide resulted in decreasing Initial EIS Rp with increasing inhibitor concentrations. Similarly, the isophthalaldehyde with phenyl thiosemicarbazide resulted in decreasing Final EIS Rp with increasing inhibitor concentrations. Therefore, these two combinations may not result in optimal Initial EIS Rp and Final EIS Rp at certain combinations and perhaps should not be considered.

There is some evidence that some of the remaining combinations result in significantly different responses at specific inhibitor concentrations than the baseline. However, these conclusions are based on the results of one experiment. For example, there is evidence that diacetyl pyridine with thiosemicarbazide and the terephthalaldehyde with phenyl thiosemicarbazide result in significantly higher Rp response than the baseline. Additionally, there is some evidence that the terephthalaldehyde with thiosemicarbazide results in significantly lower Final EIS Rp and significantly higher Corrosion Rates than the baseline combination. There is also evidence that the terephthalaldehyde with phenyl thiosemicarbazide results in significantly higher Initial EIS Rp and Final EIS Rp and significantly lower corrosion rate compared to the baseline. There is also some evidence that the hydroxyquinoline carboxyaldehyde with phenyl thiosemicarbazide results in significantly higher Initial EIS Rp and Final EIS Rp than the baseline. Lastly, there is some evidence that isophthalaldehyde with phenyl thiosemicarbazide results in significantly lower Initial EIS Rp compared to the baseline. For more conclusive statements on the significance of the differences between these combinations and the baseline, more experimental results would be needed. If possible, additional experiments can be conducted at higher inhibitor concentrations to obtain more information on the slopes. However, if the experiments are conducted at the maximum inhibitor concentration values in which case inhibitor concentration cannot be increased, it may be of interest to conduct experiments at lower inhibitor concentrations to draw conclusions on the slope.

### Analysis of Experiments Conducted at Saturation

Table 37 provides the number of experiments for each combination that were run at saturation. To analyze the data, columns 1 and 4 will be considered, the thiosemicarbazide and the phenyl thiosemicarbazide in combination with the different aldehyde levels since these two columns have the greatest number of experiment observations.

TABLE 37
Total number of experiments with combinations at saturation for the aldehydes with
the thiosemicarbazide, from experiments conducted in the US and in India:

| | | Ethyl | Methyl | Phenyl | |
|---|---|---|---|---|---|
| | Thiosemi- | Thiosemi- | Thiosemi- | Thiosemi- | Thiocarbo- |
| | carbazide | carbazide | carbazide | carbazide | hydrazide |
| | (base) | (ethyl) | (methyl) | (phenyl) | (thioc) |
| Isophthalaldehyde (base) | 3 | 3 | 0 | 3 | 0 |
| Diacetyl Pyridine (dp) | 5 | 0 | 0 | 2 | 0 |
| Hexanedione (hex) | 2 | 0 | 0 | 2 | 0 |
| Hydroxyquinoline | 2 | 0 | 0 | 1 | 0 |
| Carboxyaldehyde (hc) | | | | | |
| Pentandione (p) | 4 | 0 | 0 | 1 | 0 |
| Pyridine Carboxyaldehyde (pc) | 2 | 0 | 0 | 0 | 0 |
| Salicylaldehyde (s) | 4 | 2 | 1 | 2 | 2 |
| Terephthalaldehyde (t) | 2 | 2 | 0 | 3 | 0 |

The following Table 38 provides the subset of the data in Table 37 to the analyzed observations.

TABLE 38
Experiments used in Analysis 3a in which the thiosemicarbazide and
phenyl thiosemicarbazide with different levels of the aldehydes are
modeled, for experiments run at saturation in the US and India

| | | Phenyl |
|---|---|---|
| | Thiosemicarbazide | Thiosemicarbazide |
| | (base) | (phenyl) |
| Isophthalaldehyde (base) | 3 (Combination1) | 3 (Combination2) |
| Diacetyl Pyridine (dp) | 5 (Combination3) | 2 (Combination4) |
| Hexanedione (hex) | 2 (Combination5) | 2 (Combination6) |
| Hydroxyquinoline | 2 (Combination7) | 1 (Combination8) |
| Carboxyaldehyde (hc) | | |
| Pentandione (p) | 4 (Combination9) | 1 (Combination10) |
| Pyridine | 2 (Combination11) | 0 |
| Carboxyaldehyde (pc) | | |
| Salicylaldehyde (s) | 4 (Combination12) | 2 (Combination13) |
| Terephthalaldehyde (t) | 2 (Combination14) | 3 (Combination15) |

To analyze the data, a model of the following form was fit using multiple linear regression model fitting techniques:

$${log}_{10} {Y}_{i} = {β}_{0} + {β}_{Aldehyde base X phenyl} Combination 2 + {β}_{dp X thios} Combination 3 + {β}_{dp X phenyl} Combination 4 + {β}_{hex X thios} Combination 5 + {β}_{hex X phenyl} Combination 6 + {β}_{hc X thios} Combination 7 + {β}_{hc X phenyl} Combination 8 + {β}_{p X thios} Combination 9 + {β}_{p X phenyl} Combination 10 + {β}_{pc X phenyl} Combination 11 + {β}_{s X thios} Combination 12 + {β}_{s X phenyl} Combination 13 + {β}_{t X thios} Combination 14 + {β}_{t X phenyl} Combination 15 + {β}_{US} Location$$

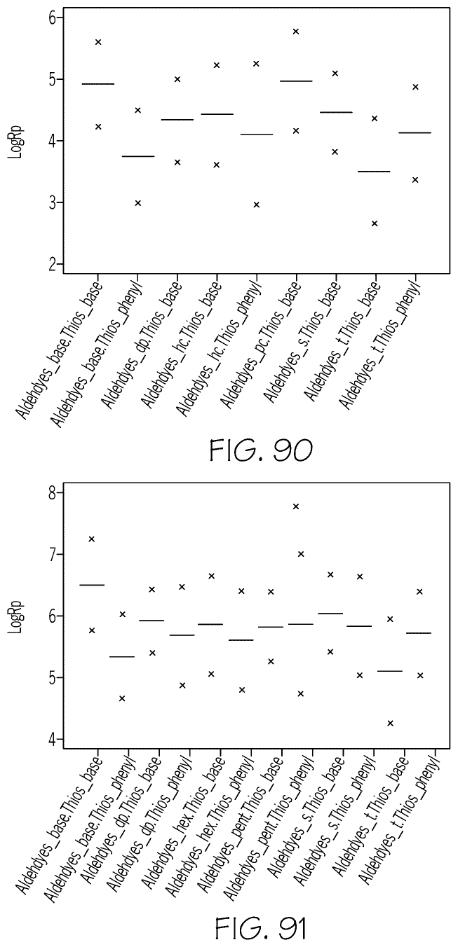

This model provides conclusions on the relationship between each combination and the response compared to the baseline combination and accounts for an intercept difference due to location. The coefficient for the US location adjusts the coefficient for the baseline compared to the baseline India coefficient (represented as the intercept in the model, Bo). Since most experiments only measured the Rp response, the only model fit is for this response. The results of the model are provided in FIGS. 90 and 91, which display results for the Rp response for Analysis 3 using the thiosemicarbazide and phenyl thiosemicarbazide with the different aldehyde levels for combinations conducted at saturation. The plots are presented for each location, with the US results on the top and the India results on the bottom. The x-axis provides the different combinations and the y-axis provides the logarithm of the Rp response. The bars corresponding to each combination are the predicted mean values from the regression model with the 95% upper and lower confidence bounds provided with the “x” above and below the bars, respectively, representing a confidence interval. In this setup, overlaps of a confidence interval for a combination with that of the baseline confidence interval, the far-left combination, implies that the mean Rp response is not significantly different for the combination as compared to the baseline.

The multiple R² of the Rp model at saturation is 76%, indicating a good fit of the model to the data. From the results, the isophthalaldehyde with phenyl thiosemicarbazide (Combination2) and terephthalaldehyde with thiosemicarbazide (Combination14) result in significantly lower Rp response than the baseline combination. There is weak significant (pvalue=0.096) that terephthalaldehyde with phenyl thiosemicarbazide (Combination15) results in significantly lower Rp response than the baseline combination.

### Conclusions from Analysis 3

The Rp response is significantly lower for a few combinations as compared to the baseline. Specifically, isophthalaldehyde with phenyl thiosemicarbazide (Combination2) and terephthalaldehyde with thiosemicarbazide (Combination14) result in significantly lower Rp response than the baseline combination. There is weak significant (p-value=0.096) that terephthalaldehyde with phenyl thiosemicarbazide (Combination15) results in significantly lower Rp response than the baseline combination.

1. A corrosion inhibition composition comprising:
a carrier; and
a Schiff base in admixture with the carrier, the carrier comprising at least one of water, a hydrocarbon solvent, and a binder.

2. The corrosion inhibition composition of claim 1, wherein the Schiff base is selected from the group consisting of thiosemicarbazone of isophthalaldehyde, thiosemicarbazone of terephthalaldehyde, thiosemicarbazone of salicylaldehyde, thiosemicarbazone of pyridine carboxyaldehyde, thiosemicarbazone of 2,6-diacetylpyridine, thiosemicarbazone of 5-hydroxymethyl-2-furaldehyde, thiosemicarbazone of 8-hydroxyquinoline-2-carboxyaldehyde, thiosemicarbazone of pentanedione, thiosemicarbazone of acetonylacetone, thiosemicarbazone of pyruvic aldehyde dimethyl acetal, thiosemicarbazone of mesityl oxide, and mixtures thereof.

3. The corrosion inhibition composition of claim 1, wherein the Schiff base comprises an ethyl thiosemicarbazone.

4. The corrosion inhibition composition of claim 1, wherein the Schiff base is selected from the group consisting of ethyl thiosemicarbazone of isophthalaldehyde, ethyl thiosemicarbazone of terephthalaldehyde, ethyl thiosemicarbazone of salicylaldehyde, ethyl thiosemicarbazone of pyridine carboxyaldehyde, ethyl thiosemicarbazone of 2,6-diacetylpyridine, ethyl thiosemicarbazone of 5-hydroxymethyl-2-furaldehyde, ethyl thiosemicarbazone of 8-hydroxyquinoline-2-carboxyaldehyde, ethyl thiosemicarbazone of pentanedione, ethyl thiosemicarbazone of acetonylacetone, ethyl thiosemicarbazone of pyruvic aldehyde dimethyl acetal, ethyl thiosemicarbazone of mesityl oxide, and mixtures thereof.

5. The corrosion inhibition composition of claim 1, wherein the Schiff base comprises a methyl thiosemicarbazone.

6. The corrosion inhibition composition of claim 1, wherein the Schiff base is selected from the group consisting of methyl thiosemicarbazone of isophthalaldehyde, methyl thiosemicarbazone of terephthalaldehyde, methyl thiosemicarbazone of salicylaldehyde, methyl thiosemicarbazone of pyridine carboxyaldehyde, methyl thiosemicarbazone of 2,6-diacetylpyridine, methyl thiosemicarbazone of 5-hydroxymethyl-2-furaldehyde, methyl thiosemicarbazone of 8-hydroxyquinoline-2-carboxyaldehyde, methyl thiosemicarbazone of pentanedione, methyl thiosemicarbazone of acetonylacetone, methyl thiosemicarbazone of pyruvic aldehyde dimethyl acetal, methyl thiosemicarbazone of mesityl oxide, and mixtures thereof.

7. The corrosion inhibition composition of claim 1, wherein the Schiff base comprises a phenyl thiosemicarbazone.

8. The corrosion inhibition composition of claim 1, wherein the Schiff base is selected from the group consisting of phenyl thiosemicarbazone of isophthalaldehyde, phenyl thiosemicarbazone of terephthalaldehyde, phenyl thiosemicarbazone of salicylaldehyde, phenyl thiosemicarbazone of pyridine carboxyaldehyde, phenyl thiosemicarbazone of 2,6-diacetylpyridine, phenyl thiosemicarbazone of 5-hydroxymethyl-2-furaldehyde, phenyl thiosemicarbazone of 8-hydroxyquinoline-2-carboxyaldehyde, phenyl thiosemicarbazone of pentanedione, phenyl thiosemicarbazone of acetonylacetone, phenyl thiosemicarbazone of pyruvic aldehyde dimethyl acetal, phenyl thiosemicarbazone of mesityl oxide, and mixtures thereof.

9. The corrosion inhibition composition of claim 1, wherein the Schiff base comprises a thiocarbohydrazone.

10. The corrosion inhibition composition of claim 1, wherein the Schiff base is selected from the group consisting of thiocarbohydrazone of isophthalaldehyde, thiocarbohydrazone of terephthalaldehyde, thiocarbohydrazone of salicylaldehyde, thiocarbohydrazone of pyridine carboxyaldehyde, thiocarbohydrazone of 2,6-diacetylpyridine, thiocarbohydrazone of 5-hydroxymethyl-2-furaldehyde, thiocarbohydrazone of 8-hydroxyquinoline-2-carboxyaldehyde, thiocarbohydrazone of pentanedione, thiocarbohydrazone of acetonylacetone, thiocarbohydrazone of pyruvic aldehyde dimethyl acetal, thiocarbohydrazone of mesityl oxide, and mixtures thereof.

11. A method for inhibiting corrosion on a metallic substrate, the method comprising:
applying to the metallic substrate a corrosion inhibition composition comprising a Schiff base.

12. The method of claim 11, wherein the Schiff base is selected from the group consisting of thiosemicarbazone of isophthalaldehyde, thiosemicarbazone of terephthalaldehyde, thiosemicarbazone of salicylaldehyde, thiosemicarbazone of pyridine carboxyaldehyde, thiosemicarbazone of 2,6-diacetylpyridine, thiosemicarbazone of 5-hydroxymethyl-2-furaldehyde, thiosemicarbazone of 8-hydroxyquinoline-2-carboxyaldehyde, thiosemicarbazone of pentanedione, thiosemicarbazone of acetonylacetone, thiosemicarbazone of pyruvic aldehyde dimethyl acetal, thiosemicarbazone of mesityl oxide, and mixtures thereof.

13. The method of claim 11, wherein the Schiff base comprises an ethyl thiosemicarbazone.

14. The method of claim 11, wherein the Schiff base comprises a methyl thiosemicarbazone.

15. The method of claim 11, wherein the Schiff base comprises a phenyl thiosemicarbazone.

16. The method of claim 11, wherein the Schiff base comprises a thiocarbohydrazone.

17. A coated metallic substrate, comprising:
a metallic substrate; and
a coating comprising a Schiff base.

18. The coated metallic substrate of claim 17, wherein the Schiff base is selected from the group consisting of thiosemicarbazone of isophthalaldehyde, thiosemicarbazone of terephthalaldehyde, thiosemicarbazone of salicylaldehyde, thiosemicarbazone of pyridine carboxyaldehyde, thiosemicarbazone of 2,6-diacetylpyridine, thiosemicarbazone of 5-hydroxymethyl-2-furaldehyde, thiosemicarbazone of 8-hydroxyquinoline-2-carboxyaldehyde, thiosemicarbazone of pentanedione, thiosemicarbazone of acetonylacetone, thiosemicarbazone of pyruvic aldehyde dimethyl acetal, thiosemicarbazone of mesityl oxide, and mixtures thereof.

19. The coated metallic substrate of claim 17, wherein the Schiff base comprises at least one of an ethyl thiosemicarbazone, a methyl thiosemicarbazone, and a phenyl thiosemicarbazone.

20. (canceled)

21. The coated metallic substrate of claim 17, wherein the metallic substrate comprises aluminum.
